(19) United States
(12) Patent Application Publication
(10) Pub. No.: US 2026/0310848 A1
(43) Pub. Date: Oct. 8, 2026

(54) CALCULATING METHOD AND CALCULATING PROGRAM FOR MACRO DIRECT-CURRENT MOBILITY OF SEMICONDUCTOR, AND DEVICE SIMULATION METHOD USING SAME

(71) Applicant: IDEMITSU KOSAN CO.,LTD., Chiyoda-ku, Tokyo (JP)

(72) Inventors: Emi KAWASHIMA, Chiyoda-ku, Tokyo (JP); Koji YAMAGUCHI, Chiyoda-ku, Tokyo (JP); Yuki TSURUMA, Chiyoda-ku, Tokyo (JP); Toshio KAMIYA, Midori-ku, Yokohama-shi (JP); Takayoshi KATASE, Midori-ku, Yokohama-shi (JP); Keisuke IDE, Midori-ku, Yokohama-shi (JP)

(73) Assignee: IDEMITSU KOSAN CO.,LTD., Chiyoda-ku, Tokyo (JP)

(21) Appl. No.: 19/479,274

(22) PCT Filed: Apr. 26, 2024
(86) PCT No.: PCT/JP2024/016604

§ 371 Date: Oct. 27, 2025

(30) Foreign Application Priority Data
Apr. 28, 2023 (JP) 2023-075244

(51) Int. Cl. G06F 30/20; G06F 111/10

(52) U.S. Cl. CPC G06F 30/20; G06F 2111/10

(57) ABSTRACT

Provided is a method of calculating a macro DC mobility μ(T) of a semiconductor, in which, in regard to an in-grain mobility μ_{in-grain}(T) calculated in that process, assuming that a temperature T [K] is a fluctuation factor, a reciprocal of the in-grain mobility μ_{in-grain}(T) is expressed as a linear combination of two or more terms selected from the group consisting of 1/(exp(β/T)−1), T⁰, T^{-3/2}, T^{1/2}, T^{3/2}, T¹, and T², [where β[K] is a coefficient].

### TECHNICAL FIELD

The present invention relates to a calculation method and calculation program for a macro DC mobility of a semiconductor, and a device simulation method using the same.

### BACKGROUND ART

Hitherto, thin-film transistors using amorphous silicon (a-Si) and low-temperature polysilicon (LTPS) have been used in, for example, display manufacturing. There has already been established a device simulation technology for calculating a mobility of an a-Si semiconductor and designing a device based on an obtained result.

In recent years, thin-film transistors using an amorphous oxide semiconductor (IGZO) have come to be used in, for example, display manufacturing. However, when the above-mentioned mobility calculation method (a-Si model) is used for an amorphous oxide semiconductor (IGZO), the calculated mobility sometimes deviates from an actually measured value, and it has become clearer that the a-Si model cannot be applied.

In view of the foregoing, a method capable of accurately calculating the mobility of an amorphous oxide semiconductor (IGZO) has been developed, and an amorphous oxide semiconductor (IGZO) device simulation technology (Tokyo Model) has been established (see Non Patent Literature 1).

Meanwhile, in recent years, progress has been made in development of polycrystalline oxide semiconductors containing ln as a main component and having a higher mobility than that of the amorphous oxide semiconductor (see Non Patent Literature 2).

### CITATION LIST

### Non Patent Literature

[NPL 1] “Temperature Properties of Amorphous In—Ga—Zn—O Thin-Film Transistors with a new Mobility Model,” The Simulation Standard, Oct. 1, 2017 (https://silvaco.com/dynamicweb/jsp/downloads/DownloadDocStepsAction.do?req=download&nm=simstd_Q4_20 17_a3.pdf)
[NPL 2] Kazuaki Ebata, “High-Mobility Thin-Film Transistors with Polycrystalline In—Ga—O Channel Fabricated by DC Magnetron Sputtering,” The Japan Society of Applied Physics Applied Physics Express, 6 Jan. 2012, Volume 5, Number 1, page. 011102
[NPL 3] John Y. W. Seto, J. Appl. Phys. 46 5247 (1975)
[NPL 4] C. H. Seager, T. G. Castner J Appl Phys 49, 3879 (1978)
[NPL 5] H. Fröhlich, Advances in Physics 3 325 (1954)
[NPL 6] J. J. Wang et. al., Phys. Lett. A 374 2286 (2010)
[NPL 7] M. Stokey. et. al., J. Appl. Phys. 129 225102 (2021)
[NPL 8] J. Ederth et. al., Phys. Rev. B 68 155410 (2003)
[NPL 9] A. Bikowski, K. Ellmer, J. Appl. Phys. 116 143704 (2014)
[NPL 10] E. Conwell, V. F. Weisskopf, Phys. Rev. 69 258 (1946)
[NPL 11] E. Conwell, V. F. Weisskopf, Phys. Rev. 77 388 (1946)
[NPL 12] H. Brooks, Phys. Rev. 83 879 (1951)
[NPL 13] H. Brooks, Adv. Electron. Phys. 7 85 (1955)
[NPL 14] D. Chattopadhyay, H. Queisser J. Rev. Mod. Phys. 53 745 (1981)
[NPL 15] T. Pisarkiewicz, et. al., Thin Solid Films 174 217 (1989)
[NPL 16] C. Erginsoy, Phys. Rev. 79 1013 (1950)
[NPL 17] T. Quisse, Physica B 270 262 (1999)
[NPL 18] C. Kittel, H. Kroemer, “Thermal Physics” Freeman, New York, 2nd ed. (1980) Chap. 13 pp. 367
[NPL 19] R. B. Dingle, Philos. Mag. 46 831 (1955)

### SUMMARY OF INVENTION

However, it has become clearer that an accurate result cannot be obtained even when the above-mentioned mobility calculation method (Tokyo Model) that has been used for the amorphous oxide semiconductor is applied to calculate a mobility of a polycrystalline oxide semiconductor having a higher mobility.

In view of the foregoing, the inventors of the present invention have investigated various physical property parameters in order to develop a method capable of accurately calculating mobilities for various oxide semiconductor materials such as polycrystalline oxide semiconductors and amorphous oxide semiconductors. As a result, the inventors have found that it is possible to calculate accurate mobilities for various oxide semiconductor materials by first calculating an in-grain mobility μ_{in-grain}(T) of a semiconductor through use of various physical property parameters and then calculating a macro DC mobility μ(T) of the semiconductor through use of a calculation result thereof, and thus have completed the present invention.

The inventors of the present invention have further proceeded with investigations, have performed physical modeling of the respective physical property parameters that are scattering factors of polycrystalline oxide semiconductors, and have created a mobility model. Then, when this mobility model has been applied to a simulator, an actually measured mobility-carrier concentration line has been reproduced with accuracy, thereby confirming that this mobility model functions correctly.

Further, it has now become possible to quantify contribution rates of the scattering factors to a carrier concentration, thereby having advanced understanding of the phenomenon. Still further, it has been confirmed that reverse extraction of scattering parameters for polycrystalline oxide semiconductors (thin films) is also possible.

An object of the present invention is to provide a mobility calculation method, a mobility calculation program, and a device simulation method that are capable of accurately calculating mobilities of various oxide semiconductor materials.

According to the present invention, the following semiconductor mobility calculation methods, programs using the same, and the like are provided.

1. A calculation method for an in-grain mobility μ_{in-grain}(T) of a semiconductor,
wherein, assuming that a temperature T [K] is a fluctuation factor, a reciprocal of the in-grain mobility μ_{in-grain}(T) is expressed as a linear combination of two or more terms selected from the group consisting of 1/(exp(β/T)−1), T⁰, T^{-3/2}, T^{1/2}, T^{3/2}, T¹, and T²,
[where β [K] is a coefficient].

2. The calculation method for an in-grain mobility μ_{in-grain}(T) of a semiconductor according to Item 1, wherein the reciprocal of the in-grain mobility μ_{in-grain}(T) of the semiconductor is expressed as the linear combination of two or more terms selected from the group consisting of 1/(exp(β/T)−1), T⁰, T^{-3/2}, T^{1/2}, T^{3/2}, T¹, and T², and further, a 1/μ_{NI}(T, n) term, of which a temperature dependence is a function of a carrier concentration “n”, is linearly combined,
[where β [K] is a coefficient].

3. A calculation method for a macro DC mobility μ(T) of a semiconductor,
wherein, assuming that a temperature T [K] is a fluctuation factor, the macro DC mobility μ(T) is expressed by the following Expression (10):

$$μ ( T ) = exp ( - γ / T ) exp ( - θ / {T}^{2} ) {μ}_{in - grain} ( T ) , \qquad ( 10 )$$

[in Expression (10),
μ is a mobility [cm²/Vs] of the semiconductor,
T is the temperature [K],
γ [K] and θ [K²] are coefficients and positive numbers including 0, and
μ_{in-grain}(T) is an in-grain mobility [cm²/Vs] of the semiconductor obtained by the calculation method for an in-grain mobility μ_{in-grain}(T) of a semiconductor of Item 1.]

4. The calculation method for a macro DC mobility μ(T) of a semiconductor according to Item 3, wherein the macro DC mobility μ(T) is expressed by the following Expression (A10):

$$μ ( T ) = [ exp ( - \frac{{qV}_{B}}{{k}_{B} T} ) ] {μ}_{in - grain} ( T ) , \qquad ( A10 )$$

[in Expression (A10),
“q” is an elementary charge [C],
V_{B} is a grain boundary barrier height [eV],
k_{B} is a Boltzmann constant [eV/K],
T is the temperature [K], and
μ_{in-grain}(T) is the in-grain mobility [cm²/Vs] of the semiconductor obtained by the calculation method for an in-grain mobility μ_{in-grain}(T) of a semiconductor of Item 1.]

5. A device simulation method of obtaining a macro DC mobility μ(T) of a semiconductor,
the device simulation method including a step of using the calculation method for a macro DC mobility μ(T) of a semiconductor of Item 3.

6. A manufacturing method for a thin film transistor, including the steps of:
calculating a macro DC mobility μ(T) of a semiconductor through use of the calculation method for a macro DC mobility μ(T) of a semiconductor of Item 3; and
manufacturing the thin film transistor based on the calculated macro DC mobility μ(T) of the semiconductor.

7. An electronic apparatus, including a thin film transistor manufactured through use of the manufacturing method for a thin film transistor of Item 6.

8. A program for calculating a macro DC mobility μ(T) of a semiconductor through use of the following Expressions (1) and (10):

$$\frac{1}{{μ}_{in - grain} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} , \qquad ( 1 )$$

[in Expression (1),
μ_{in-grain} represents an in-grain mobility [cm²/Vs] of the semiconductor, T represents a temperature [K], and
β [K], a₁ [cm⁻²Vs], a₂ [cm⁻²Vs], as [cm⁻²Vs·K³²], a₄ [cm⁻²Vs·K^{-1/2}], and as [cm⁻²Vs·K^{3/2}] each represent a coefficient,
provided that, in Expression (1), two or more terms selected from the group consisting of 1/(exp(β/T)−1), T⁰, T^{-3/2}, T^{1/2}, and T^{3/2} are used, and the coefficients a₁ to a₅ of unselected terms are set to 0]; and

$$μ ( T ) = exp ( - γ / T ) exp ( - θ / {T}^{2} ) {μ}_{in - grain} ( T ) , \qquad ( 10 )$$

[in Expression (10),
μ is a mobility [cm²/Vs] of the semiconductor,
T is the temperature [K],
γ [K] and θ [K²] are coefficients and positive numbers including 0, and
μ_{in-grain}(T) is the in-grain mobility [cm²/Vs] of the semiconductor obtained by the calculation method for an in-grain mobility μ_{in-grain}(T) of a semiconductor of Item 1],
the program being for causing a computer to function as:
   means for receiving input of the temperature T [K] and a carrier concentration “n” [cm^{-3];}
   means for receiving input of a type of a material of the semiconductor,
   means for selecting values of the coefficients a₁ to a₅, β, γ, and θ; and
   means for calculating the macro DC mobility μ(T) of the semiconductor by Expressions (1) and (10).

9. A program for deriving a macro DC mobility μ(T, n) [cm²/Vs] of a semiconductor dependent on a temperature T [K] and a carrier concentration “n” [cm⁻³],
the program being for causing a computer to function as:
   means for receiving data input of the μ(T, n) for the T and “n” actually measured from a semiconductor film;
   means for receiving input of a type of a semiconductor material from which initial values of respective coefficients in the following Expression (1) are to be acquired; and
   means for deriving the macro DC mobility μ(T, n) by performing regression through use of the program of Item 8:

$$\frac{1}{{μ}_{in - grain} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} , \qquad ( 1 )$$

[in Expression (1),
μ_{in-grain} represents an in-grain mobility [cm²/Vs] of the semiconductor,
T represents the temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and as [cm⁻²Vs·K^{3/2}] each represent a coefficient,
provided that, in Expression (1), two or more terms selected from the group consisting of 1/(exp(β/T)−1), T⁰, T^{-3/2}, T^{1/2}, and T^{3/2} are used, and the coefficients a₁ to a₅ of unselected terms are set to 0.]

According to the present invention, it is possible to provide a mobility calculation method, a mobility calculation program, and a device simulation method that are capable of accurately calculating mobilities of various oxide semiconductor materials.

### BRIEF DESCRIPTION OF DRAWINGS

FIG. 1a is a graph in which a relationship between an actually measured value Mobs. of a mobility of a specimen 1 and a calculated value μ_{calc} of a macro DC mobility obtained in Example 1 is plotted against a carrier concentration “n”.

FIG. 1b is a graph in which the actually measured value Jobs. of the mobility of the specimen 1 is plotted on the horizontal axis and the calculated value μ_{calc} of the macro DC mobility obtained in Example 1 is plotted on the vertical axis.

FIG. 2a is a graph in which a relationship between an actually measured value Jobs. of a mobility of a specimen 2 and a calculated value calc of a macro DC mobility obtained in Example 2 is plotted against the carrier concentration “n”.

FIG. 2b is a graph in which the actually measured value Jobs. of the mobility of the specimen 2 is plotted on the horizontal axis and the calculated value μ_{calc} of the macro DC mobility obtained in Example 2 is plotted on the vertical axis.

FIG. 3a is a graph in which a relationship between the actually measured value Jobs. of the mobility of the specimen 1 and a calculated value μ_{calc} of a macro DC mobility obtained in Comparative Example 1 is plotted against the carrier concentration “n”.

FIG. 3b is a graph in which the actually measured value Jobs. of the mobility of the specimen 1 is plotted on the horizontal axis and the calculated value μ_{calc} of the macro DC mobility obtained in Comparative Example 1 is plotted on the vertical axis.

FIG. 4a is a graph in which a relationship between the actually measured value Jobs. of the mobility of the specimen 2 and a calculated value μ_{calc} of a macro DC mobility obtained in Comparative Example 2 is plotted against the carrier concentration “n”.

FIG. 4b is a graph in which the actually measured value Jobs. of the mobility of the specimen 2 is plotted on the horizontal axis and the calculated value μ_{calc} of the macro DC mobility obtained in Comparative Example 2 is plotted on the vertical axis.

FIG. 5 is a flow chart for illustrating an outline of a program for calculating a macro DC mobility μ(T) [cm²/Vs] of a semiconductor according to one aspect of the present invention.

FIG. 6 is a flow chart for illustrating an outline of a program for deriving a macro DC mobility μ(T, n) [cm²/Vs] of a semiconductor according to one aspect of the present invention.

FIG. 7 is a flow chart for illustrating an outline of a machine learning program for the program for calculating a macro DC mobility μ(T) [cm²/Vs] of a semiconductor according to one aspect of the present invention.

FIG. 8 is Expression (1) for calculating an in-grain mobility μ_{in-grain}(T) of a semiconductor that is used in the present invention.

FIG. 9 is a graph for showing mobility-carrier concentration characteristics of respective samples for actual measurement at room temperature.

FIG. 10 is an electron back scattering diffraction (EBSD) image for showing information regarding crystal orientations and grain sizes of the respective samples for actual measurement.

FIG. 11 are graphs in which respective scattering parameters extracted by parameter fitting for the respective samples for actual measurement are plotted.

FIG. 12 are graphs for showing carrier concentration dependences of the respective scattering parameters common to the respective samples for actual measurement.

FIG. 13 is a conceptual graph in a Quisse model in which, in the log-log graph of Q/πa₀² versus ka₀, a Q/πa₀²-ka₀ curve at each qₛa₀ is regarded as an upper base and a hypotenuse of a right trapezoid for approximating Q/πa₀² in the Quisse model.

FIG. 14 is a graph in which a value (Q₀@k′=0) of Q/πa₀² at ka₀=0 for each qₛa₀ shown in FIG. 13 was acquired from the Quisse model to approximate a value of the upper base at each qₛa₀ of FIG. 13.

FIG. 15 is a graph for showing results of inputting an approximate analytical expression of a neutral impurity scattering Quisse model and ionized impurity scattering (degenerate; a sigmoid function introduced into a Dingle model in addition to self-formed donors) parameters, which are described later.

FIG. 16 are graphs in which mobility-carrier concentration lines (μ-n lines) obtained by a calculation method for a macro DC mobility μ(T) based on a physical model in the present invention are shown together with plots of actually measured values.

FIG. 17 is a graph in which a relationship between an actually measured value Jobs. of a mobility of a sample for actual measurement with respect to the carrier concentration “n” and a calculated value of the mobility is plotted.

FIG. 18 is a graph in which carrier concentrations of respective samples for actual measurement are plotted in the horizontal axis and scattering rates of the respective scattering parameters are plotted in the vertical axis.

### DESCRIPTION OF EMBODIMENTS

1. Calculation Method for in-Grain Mobility μ_{in-Grain}(T) of Semiconductor

A calculation method for an in-grain mobility Un-grain (T) of a semiconductor (hereinafter sometimes abbreviated as “calculation method for an in-grain mobility”) according to one aspect of the present invention is characterized in that,
assuming that a temperature T [K] is a fluctuation factor,
a reciprocal of the in-grain mobility μ_{in-grain}(T) is expressed as a linear combination of two or more terms selected from the group consisting of 1/(exp(β/T)−1), T⁰, T^{-3/2}, T^{1/2}, T^{3/2}, T¹, and T²,
[where β [K] is a coefficient].

The mobility of a semiconductor is a physical quantity that is influenced by an effective mass, a crystal structure, a crystal phase transition, crystal grains, and an amount of defects, which are intrinsic to a semiconductor material, and is a physical quantity that varies depending on a temperature, a carrier concentration, scattering parameters, and potential barriers.

The term “in-grain mobility in-grain (T) of a semiconductor” refers to a mobility inside a single crystal grain. When this mobility is obtained, it is possible to know a macro DC mobility in a case in which the semiconductor is in a single-crystal state, or a macro DC mobility in a case in which potential barriers of grain boundaries are extremely small.

In one embodiment, in the calculation method for an in-grain mobility,
as the reciprocal of the in-grain mobility μ_{in-grain}(T) in the following Expression (1), two or more terms selected from the group consisting of 1/(exp(β/T)−1), T⁰, T^{-3/2}, T^{1/2}, and T^{3/2} are used:

$$\frac{1}{{μ}_{in - grain} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} , \qquad ( 1 )$$

[in Expression (1),
Min-grain represents the in-grain mobility [cm²/Vs] of the semiconductor,
T represents the temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and as [cm⁻²Vs·K^{-3/2}] each represent a coefficient,
provided that, in Expression (1), the coefficients a₁ to a₅ of unselected terms among the 1/(exp(β/T)−1), the T⁰, the T^{-3/2}, the T^{1/2}, and the T^{3/2} are set to 0.]

In one embodiment,
the β [K] is expressed by the following Expression (2):

$$β = h {{ω}_{op} ( 2 π \cdot {k}_{B} )}^{- 1} , \qquad ( 2 )$$

[in Expression (2),
hωₒₚ/2π represents energy [eV] of an optical phonon that varies depending on a carrier concentration,
k_{B} is a Boltzmann constant (8.617×10⁵ [eV/K]),
“h” represents a Planck constant (4.1357×10⁻¹⁵ [eVs]).]

In one embodiment,
the a₁ [cm⁻²Vs] is a coefficient a₁(n) that varies depending on a carrier concentration “n” [cm⁻³], and the a₁(n) is expressed by the following Expression (3):

$${a}_{1} ( n ) = {A}_{1} * \frac{1}{1 + exp ( - {B}_{1} * ( log ( n ) - log ( {N}_{01} ) ) )} + {C}_{1} , \qquad ( 3 )$$

[in Expression (3),
“n” is a free carrier concentration [cm⁻³] (equal to a free electron density [cm⁻³] in the oxide semiconductor treated herein),
A₁ [cm⁻²Vs], B₁, and C₁ [cm⁻²Vs] each represent a coefficient, and
N₀₁ is a carrier concentration corresponding to an inflection point in Expression (3) represented by a₁(n).]

In one embodiment, the A₁ is equal to or greater than 0 cm⁻²Vs and equal to or less than 0.1 cm⁻²Vs (preferably equal to or greater than 0.0005 cm⁻²Vs and equal to or less than 0.09 cm⁻²Vs, more preferably equal to or greater than 0.001 cm⁻²Vs and equal to or less than 0.08 cm⁻²Vs), the B₁ is equal to or greater than 0 (an upper limit and a lower limit of B₁ are not particularly limited), the C₁ is equal to or less than 1 cm⁻²Vs (preferably equal to or less than 1×10⁻¹ cm⁻²Vs, more preferably equal to or less than 8×10⁻² cm⁻²Vs, still more preferably equal to or less than 5×10⁻² cm⁻²Vs, and a lower limit thereof is not particularly limited and is 0 cm⁻²Vs), and the Noi is equal to or greater than 1×10¹⁸ cm⁻³ and equal to or less than 1×10²³ cm⁻³ (preferably equal to or greater than 3×10¹⁸ cm⁻³ and equal to or less than 5×10²² cm⁻³, more preferably equal to or greater than 5×10¹⁸ cm⁻³ and equal to or less than 1×10²² cm⁻³)

When A₁, B₁, C₁, and N₀₁ fall within the above-mentioned ranges, the in-grain mobility is calculated more accurately.

In one embodiment, the A₁ may be 0 cm⁻²Vs, and the C₁ may be equal to or less than 1 cm⁻²Vs.

In one embodiment,
the a₂ [cm⁻²Vs] is a coefficient a₂ (n) that varies depending on the carrier concentration “n” [cm⁻³], and the a₂(n) is expressed by the following Expression (4):

$${a}_{2} ( n ) = {A}_{2} * \frac{1}{1 + exp ( {B}_{2} * ( log ( n ) - log ( {N}_{02} ) ) )} + {C}_{2} , \qquad ( 4 )$$

[in Expression (4),
“n” is the free carrier concentration [cm⁻³] (equal to the free electron density [cm⁻³] in the oxide semiconductor treated herein),
A₂ [cm⁻²Vs], B₂, and C₂ [cm⁻²Vs] are each a coefficient, and

N₀₂ is a carrier concentration corresponding to an inflection point in Expression (4) represented by a₂ (n).]

In one embodiment,
the A₂ is equal to or greater than 0.005 cm⁻²Vs and equal to or less than 0.5 cm⁻²Vs (preferably equal to or greater than 0.006 cm⁻²Vs and equal to or less than 0.08 cm⁻²Vs, more preferably equal to or greater than 0.008 cm 2Vs and equal to or less than 0.06 cm⁻²Vs), the B₂ is equal to or less than 1,000 (a lower limit thereof is not particularly limited and may be a negative value, and an upper limit thereof is preferably equal to or less than 800, more preferably equal to or less than 500, still more preferably equal to or less than 100), the C₂ is less than 1×10−1 cm⁻²Vs (preferably equal to or less than 8×10⁻² cm⁻²Vs, more preferably equal to or less than 15×10⁻³ cm⁻²Vs, and a lower limit thereof is not particularly limited and is 0 cm⁻²Vs), and the N₀₂ is equal to or greater than 1×10¹⁷ cm⁻³ and equal to or less than 1×10²² cm⁻³ (preferably equal to or greater than 1×10¹⁸ cm⁻³ and equal to or less than 5×10²¹ cm⁻³).

When A₂, B₂, C₂, and N₀₂ fall within the above-mentioned ranges, the in-grain mobility is calculated more accurately.

In one embodiment,
the a₃ [cm⁻²Vs·K³²] is a coefficient as (n) that varies depending on the carrier concentration “n” [cm⁻³], and the a₃(n) is expressed by the following Expression (5):

$${a}_{3} ( n ) = \frac{{A}_{3} {n}^{2}}{1 + exp ( - {B}_{3} ( log ( n ) - log ( {N}_{03} ) ) )} + \frac{{C}_{3}}{1 + exp ( {B}_{3} ( log ( n ) - log ( {N}_{03} ) ) )} \frac{1}{1 + {D}_{3} n} + {F}_{3} , \qquad ( 5 )$$

[in Expression (5),
“n” is the free carrier concentration [cm⁻³] (equal to the free electron density [cm⁻³] in the oxide semiconductor treated herein),
A₃ [cm⁻³Vs·K^{3/2}], B₃, C₃ [cm⁻²Vs·K³²], D₃ [cm⁻³], and F₃ [cm⁻²Vs·K³²] are each a coefficient, and
N₀₃ is a carrier concentration [cm⁻³] at a maximum value in Expression (5) represented by a₃ (n).]

In one embodiment,
the A₃ is equal to or greater than 10-39 cm⁻³Vs·K³² and equal to or less than 10³³ cm⁻³Vs·K³² (preferably equal to or greater than 10³⁸ cm⁻²Vs and equal to or less than 10-33 cm⁻²Vs, more preferably equal to or greater than 10⁻³⁷ cm⁻²Vs and equal to or less than 10³⁴ cm⁻²Vs), the B₃ is equal to or greater than 1 and equal to or less than 5,000 (preferably equal to or greater than 5, more preferably equal to or greater than 6, and an upper limit thereof is preferably equal to or less than 4,000, more preferably equal to or less than 3,000, still more preferably equal to or less than 2,000), the C₃ is less than 108 cm⁻²Vs·K^{3/2} (preferably equal to or less than 107 cm⁻²Vs·K³², more preferably equal to or less than 106 cm⁻²Vs·K^{3/2}, and a lower limit thereof is not limited and may be a negative value), the D₃ is equal to or greater than 10⁻²⁰ cm⁻³, the F₃ is less than 500 cm⁻²Vs·K³², and the Nos is equal to or greater than 1×10¹⁶ cm⁻³ and equal to or less than 1×10²⁰ cm⁻³ (preferably equal to or greater than 5×10¹⁶ cm⁻³ and equal to or less than 5×10¹⁹ cm⁻³, more preferably equal to or greater than 1×10¹⁷ cm⁻³ and equal to or less than 1×10¹⁹ cm⁻³).

When A₃, B₃, C₃, and Nos fall within the above-mentioned ranges, the in-grain mobility is calculated more accurately.

In one embodiment,
the a₃ is a coefficient a₃ (n) that varies depending on the carrier concentration “n” [cm⁻³], and assuming that N₀₃ [cm⁻³] and N₁₃ [cm⁻³] are freely-selected carrier concentrations, the a₃(n) is expressed by the following Expression (5-1) when n<N₀₃ is satisfied, expressed by the following Expression (5-2) when N₀₃≤n≤N₁₃ is satisfied, and expressed by the following Expression (5-3) when n>N₁₃ is satisfied:

$${a}_{3} ( n ) = {A}_{3}^{′} {n}^{2} \qquad ( 5 - 1 )$$

$${a}_{3} ( n ) = {B}_{3}^{′} \qquad ( 5 - 2 )$$

$${a}_{3} ( n ) = \frac{{C}_{3}^{′}}{1 + {D}_{3}^{′} n} , \qquad ( 5 - 3 )$$

[in Expression (5-1), Expression (5-2), and Expression (5-3),
“n” is the free carrier concentration [cm⁻³] (equal to the free electron density [cm⁻³] in the oxide semiconductor treated herein),
A′₃ [cm⁻³Vs·K^{3/2}], C′₃ [cm⁻²Vs·K^{3/2}], and D′₃ [cm⁻³] are each a coefficient, and
B′₃ [cm⁻²Vs·K^{3/2}] is a constant.]

In one embodiment, the A'₃ is equal to or greater than 10⁻³⁹ cm⁻³Vs·K^{3/2} and equal to or less than 10⁻³³ cm⁻³Vs·K³¹² (preferably equal to or greater than 10⁻³⁸ cm⁻²Vs·K³² and equal to or less than 10³³ cm⁻²Vs·K^{3/2}, more preferably equal to or greater than 10⁻³⁷ cm⁻²Vs·K^{3/2} and equal to or less than 10⁻³⁴ cm⁻²Vs·K^{3/2}), the C's is equal to or less than 5,000 cm⁻²Vs·K^{3/2} (preferably equal to or less than 4,000 cm⁻²Vs·K³², more preferably equal to or less than 3,000 cm⁻²Vs·K^{3/2}, and a lower limit thereof is not particularly limited), and the D'₃ is equal to or greater than 10⁻²⁰ cm⁻³.

When A'₃, C′₂, and D′₃ fall within the above-mentioned ranges, the in-grain mobility is calculated more accurately.

In one embodiment, the a₄ [cm⁻²Vs·K^{-1/2}] is a coefficient that varies depending on a carrier concentration.

In one embodiment,
the a₅ [cm⁻²Vs·K^{-3/2}] is a coefficient that varies depending on a carrier concentration.

In one embodiment,
the semiconductor is a non-degenerate semiconductor, the a₁ in Expression (1) is an optical phonon scattering constant Aₒₚ [cm⁻²Vs], the a₂ is a neutral impurity scattering coefficient Aₙₑᵤₜᵣₐₗ [cm⁻²Vs·K³²], the a₃ is an ionized impurity scattering coefficient Aᵢₒₙ [cm⁻²Vs·K^{-1/2}], the a₄ is a weak localization constant [cm⁻²Vs·K^{-1/2}], and the a₅ is an acoustic phonon scattering constant [cm⁻²Vs·K^{3/2]}.

The above-mentioned optical phonon scattering constant Aₒₚ [cm⁻²Vs] is a constant representing a degree of scattering that occurs when a carrier responsible for electrical conduction collides with an optical phonon (one type of lattice vibration, which causes electric polarization due to vibration of ions, and which has been quantized), and when a value thereof increases, the mobility decreases.

The above-mentioned neutral impurity scattering coefficient Aₙₑᵤₜᵣₐₗ [cm⁻²Vs·K^{3/2}] is a constant representing the degree of scattering that occurs when the carrier responsible for electrical conduction collides with an electrically neutral impurity, and when a value thereof increases, the mobility decreases.

The above-mentioned ionized impurity scattering coefficient Aᵢₒₙ [cm⁻²Vs·K^{-1/2}] is a constant representing the degree of scattering that occurs when the carrier responsible for electrical conduction collides with an ionized impurity that is not electrically neutral, and when a value thereof increases, the mobility decreases.

The above-mentioned weak localization constant [cm⁻²Vs·K^{-1/2}] represents a degree of an effect in which the carrier responsible for electrical conduction forms a standing wave and slightly localizes due to an influence of impurities or lattice defects, and when a value thereof increases, the mobility decreases.

The above-mentioned acoustic phonon scattering constant [cm⁻²Vs·K^{-3/2}] is a constant representing the degree of scattering that occurs when the carrier responsible for electrical conduction collides with an acoustic phonon (one type of lattice vibration, in which atoms vibrate in the same phase, and which has been quantized), and when a value thereof increases, the mobility decreases.

In this case, the “non-degenerate semiconductor” is a semiconductor in which the carrier concentration is low and Fermi energy is not present in a conduction band or a valence band, and is a semiconductor in which the statistical average number of electrons occupying an energy level E cannot be expressed by a Boltzmann approximation but is expressed by a Fermi-Dirac distribution.

### (Type of Semiconductor Material)

The calculation method for an in-grain mobility according to this aspect can be applied to various semiconductor materials such as a crystalline oxide semiconductor and an amorphous oxide semiconductor.

In one embodiment, the semiconductor is a polycrystalline semiconductor.

In one embodiment, the polycrystalline semiconductor is an oxide semiconductor containing ln as a main component.

The term “containing ln as a main component” means that a content ratio ([ln]/([ln]+[all metal elements other than ln])×100) (atomic %) of ln to all metal elements in the crystalline oxide semiconductor is higher than a content ratio of each of metal elements other than ln.

In one embodiment, the content ratio of ln in all metal elements of the polycrystalline semiconductor is equal to or higher than 33 atomic %, preferably equal to or higher than 50 atomic %, more preferably equal to or higher than 70 atomic %.

With a higher content ratio of ln, a more accurate calculation result is more likely to be obtained.

In one embodiment, the polycrystalline semiconductor is in a form of an oxide thin film.

In semiconductor devices, for example, thin film transistors, the semiconductor is used in a form of a thin film, and the calculation method for an in-grain mobility according to this aspect is suitable for a case in which the semiconductor is a thin film.

In one embodiment, the polycrystalline semiconductor thin film includes a bixbyite structure.

The polycrystalline semiconductor thin film having a bixbyite structure is likely to produce a more accurate calculation result.

The fact that the polycrystalline semiconductor thin film has a bixbyite structure can be confirmed by the following method.

### (Method of Evaluating Whether or not Bixbyite Structure is Included)

Whether or not the semiconductor film has a bixbyite structure can be determined by acquiring a diffraction pattern by electron diffraction and comparing this diffraction pattern to an electron diffraction pattern that can be calculated from the crystal structure data on the bixbyite structure in the Inorganic Crystal Structure Database (ICSD; Japan Association for International Chemical Information).

### 2. Calculation Method for Macro DC Mobility μ(T) of Semiconductor

A method of calculating a macro DC mobility μ(T) of a semiconductor (hereinafter sometimes abbreviated as “calculation method for a macro DC mobility”) according to one aspect of the present invention is characterized in that, assuming that the temperature T [K] is a fluctuation factor, the macro DC mobility μ(T) is expressed by the following Expression (10):

$$μ ( T ) = exp ( - γ / T ) exp ( - θ / {T}^{2} ) {μ}_{i n - g r a i n} ( T ) , \qquad ( 10 )$$

[in Expression (10),
μ is a mobility [cm²/Vs] of the semiconductor,
T is the temperature [K],
γ [K] and θ [K²] are coefficients and positive numbers including 0, and
μ_{in-grain}(T) is the in-grain mobility [cm²/Vs] of the semiconductor obtained by the above-mentioned calculation method for an in-grain mobility μ_{in-grain}(T) of a semiconductor according to one aspect of the present invention.]

The macro DC mobility μ(T) of the semiconductor obtained by the calculation method according to this aspect is a calculated value of the mobility to be used in an actual device simulation.

In this case, the term “macro DC mobility of a semiconductor” refers to the mobility of carriers responsible for electrical conduction, the mobility being calculated from a resistance value that is a real part of a complex impedance obtained when a current is measured by applying a voltage across the entire semiconductor material formed as a thin film.

First, the in-grain mobility [cm²/Vs] of the semiconductor is calculated, and is then used to calculate the macro DC mobility. Thus, it is possible to separately calculate the mobility influenced by scattering inside crystal grains and the mobility influenced by scattering due to potential barriers.

In one embodiment, γ [K] or θ [K²] in Expression (10) is 0.

A difference between the macro DC mobility calculated through use of γ [K] and θ [K²] in Expression (10) and the macro DC mobility calculated by Expression (10) with θ [K²] set to 0 is presence or absence of contribution of a percolation conduction mechanism, which is a characteristic conduction mechanism in a case in which the semiconductor exhibits poorly ordered atomic arrangement (has high potential barriers). Expression (10) indicates a calculation method for the mobility in a case in which percolation conduction is dominant with high potential barriers, while Expression (10) with θ [K²] set to 0 indicates a calculation method for the mobility in a case in which the atomic arrangement is highly ordered and contribution of the percolation conduction is extremely low.

In one embodiment,
the γ is expressed by the following Expression (12):

$$γ = q {V}_{B} / {k}_{B} , \qquad ( 12 )$$

[in Expression (12),
“q” is an elementary charge of 1.602×10⁻¹⁹ [C],
V_{B} represents a potential barrier value [eV], and
k_{B} represents the Boltzmann constant (8.617×10⁻⁵ [eV/K]).]

In one embodiment,
the potential barrier value V_{B} [eV] is a potential barrier value V_{B}(n) that varies depending on the carrier concentration “n” [cm⁻³], and the V_{B}(n) is expressed by the following Expression (13):

$${V}_{B} ( n ) = {A}_{6} * \frac{1 - {D}_{6} log n}{1 + exp ( {B}_{6} ( log ( n ) - log ( {N}_{06} ) ) )} + {C}_{6} , \qquad ( 13 )$$

[in Expression (13),
“n” is the free carrier concentration [cm⁻³] (equal to the free electron density [cm⁻³] in the oxide semiconductor treated herein),
A₆ [eV], B₆, C₆ [eV], and Do are each a coefficient, and
N₀₆ [eV] is a carrier concentration corresponding to an inflection point in Expression (13) represented by
V_{B}(n).]

In one embodiment,
the A₆ is equal to or greater than 0 eV and equal to or less than 1.0 eV (preferably equal to or greater than 0 eV and equal to or less than 0.8 eV, more preferably equal to or greater than 0 eV and equal to or less than 0.2 eV), the B₆ is equal to or greater than 0.1 (preferably equal to or greater than 0.7, more preferably equal to or greater than 1, and an upper limit thereof is not particularly limited), the C₆ is less than 2×10⁻¹ (preferably equal to or less than 5×10⁻², more preferably equal to or less than 1×10⁻³, and a lower limit thereof is not particularly limited and may be a negative value), the D₆ is equal to or less than 0.1 eV (preferably equal to or less than 0.08 eV, more preferably equal to or less than 0.05 eV, and a lower limit thereof is not particularly limited), and the Nos is equal to or greater than 1×10¹⁷ cm⁻³ and equal to or less than 1×10²¹ cm⁻³ (preferably equal to or greater than 5×10¹⁷ cm⁻³ and equal to or less than 5×10²⁰ cm⁻³, more preferably equal to or greater than 1×10¹⁸ cm⁻³ and equal to or less than 1×10²⁰ cm⁻³).

When A₆, B₆, C₆, D₆, and Nos fall within the above-mentioned ranges, the macro DC mobility is calculated more accurately.

### (Type of Semiconductor Material)

The calculation method for a macro DC mobility according to this aspect can be applied to various semiconductor materials such as a crystalline oxide semiconductor and an amorphous oxide semiconductor.

In one embodiment, the semiconductor is a polycrystalline semiconductor.

In one embodiment, the polycrystalline semiconductor is an oxide semiconductor containing ln as a main component.

In one embodiment, the content ratio of ln in all metal elements of the polycrystalline semiconductor is equal to or greater than 50 atomic %.

In one embodiment,
the polycrystalline semiconductor is in a form of an oxide thin film.

The polycrystalline semiconductor thin film includes a bixbyite structure.

In the calculation method for a macro DC mobility according to this aspect, in the same manner as in the calculation method for an in-grain mobility according to one aspect of the present invention, when the semiconductor material of a subject is one of those described above, it is possible to more accurately calculate the mobility.

An effect obtained by the fact that the polycrystalline semiconductor thin film has a bixbyite structure and the confirmation of the fact that the polycrystalline semiconductor thin film has a bixbyite structure are as described above in relation to the calculation method for an in-grain mobility.

### 3. Physical Modeling of Various Scattering Parameters

For physical modeling of various scattering parameters, the following investigations were performed.

In the following, the term “scattering factor” means a scattering capability of conduction electrons or holes causing mobility degradation in a semiconductor, and the term “scattering parameter” means a numerical value representing an index of the mobility degradation attributable to each “scattering factor.”

### (1) Actually Measured Data and Acquisition Method Therefor

There were used scattering parameters of a grain boundary scattering barrier height V_{B}, optical phonon scattering a_{OP}, ionized impurity scattering in a non-degenerate region (hereinafter referred to as “ionized impurity scattering (non-degenerate)”) a_{II_nonDeg}, ionized impurity scattering in a degenerate region (hereinafter referred to as “ionized impurity scattering (degenerate)”) a_{II_Deg}, and neutral impurity scattering a_{NI}. The scattering parameters can be acquired by performing temperature-dependent Hall effect measurement for each carrier concentration on samples formed under the same deposition conditions.

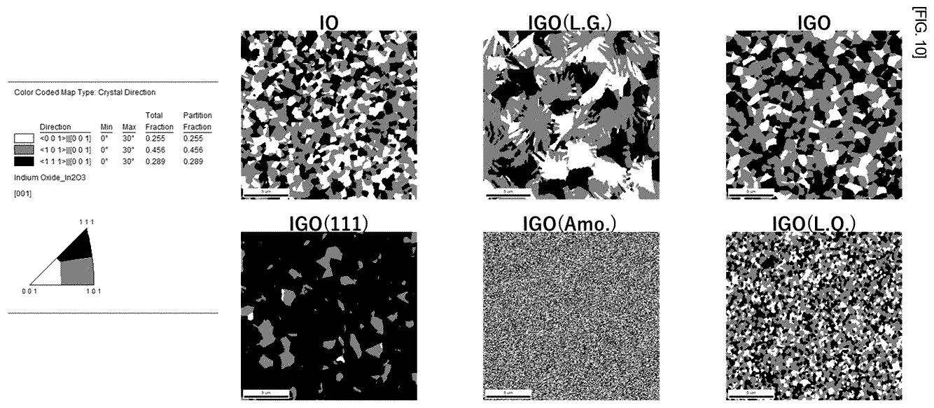

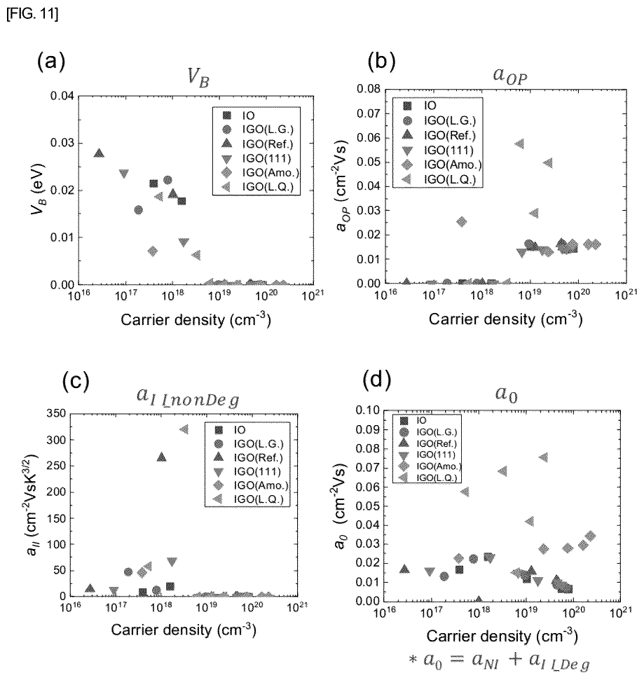

The analysis target samples (hereinafter sometimes referred to as “specimens”) are six types of oxide semiconductor thin films (30 nm thick; annealed at 400° C. for 1 hour in air) shown in Table 4 of Examples. FIG. 9 shows mobility-carrier concentration characteristics (hereinafter sometimes referred to as “μ-n characteristics” or “μ-n lines”) of the respective samples at room temperature, and FIG. 10 shows information regarding crystal orientations and grain sizes. IO, IGO(L. G.), IGO(Ref), and IGO(111) (specimens 3 to 6 shown in Table 4) have mutually different crystal orientations and grain sizes, but it is understood that the difference is not so significant in terms of the μ-n lines compared to IGO(Amo.) and IGO(L. Q.) (specimens 7 and 8 shown in Table 4). In view of the foregoing, IO, IGO(L. G.), IGO(Ref), and IGO(111) were adopted as model samples to be used at a time of creating a mobility model of a polycrystalline oxide semiconductor.

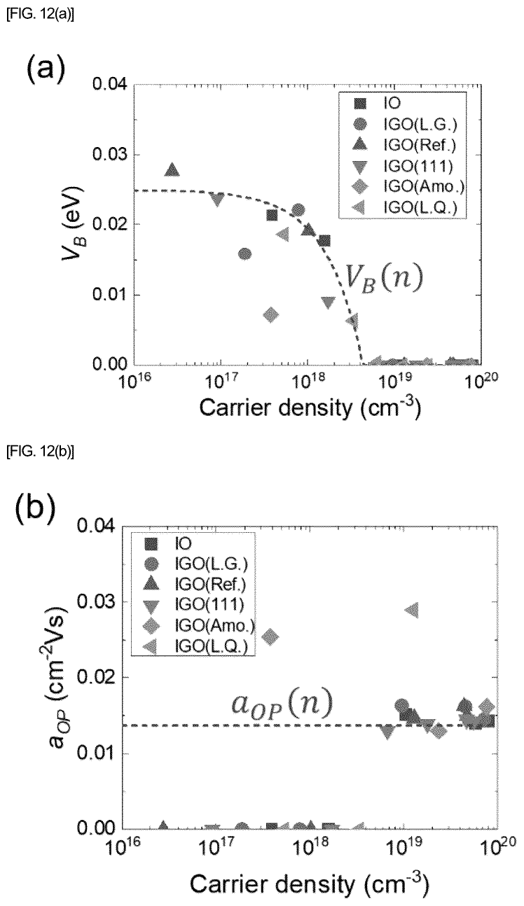

Next, the scattering parameters extracted by parameter fitting are summarized in FIG. 11. At an initial stage of analysis, the coefficient of T^{-3/2} was assumed to be due to the ionized impurity scattering and was set to all. However, in conclusion, it was required, for a discussion, to distinguish between the ionized impurity scattering (non-degenerate) a_{II_nonDeg} and the ionized impurity scattering (degenerate) a_{II_Deg}, and hence the coefficient of T^{-3/2} was set to a_{II_nonDeg}. Further, in the same manner, the coefficient of T⁰ was assumed to be due to neutral impurities and was set to a_{NI}. However, in conclusion, it became clearer that the coefficient of T⁰ is significantly influenced by the neutral impurity scattering and the ionized impurity scattering (degenerate), and hence the coefficient of T⁰ was expressed as a₀ in order to avoid confusion.

(2) Investigation Regarding Carrier Concentration Dependences of Scattering Parameters in Polycrystalline Oxide Semiconductor

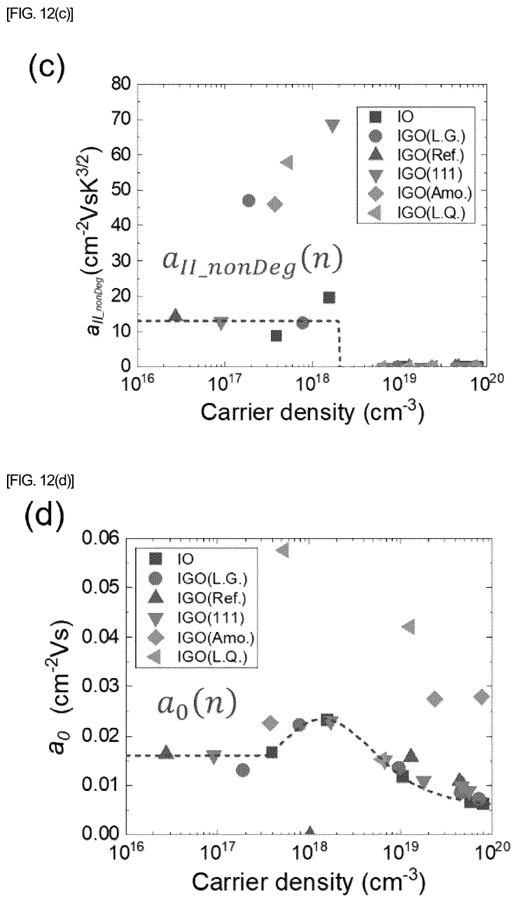

In order to physically model the μ-n line of a polycrystalline oxide semiconductor, first, scattering parameter-carrier concentration dependences (hereinafter sometimes referred to as “a-n line”) of the respective scattering parameters were selected. FIG. 12 show the carrier concentration dependences of the respective scattering parameters that are common to the model samples. The broken line in each graph corresponds to a V_{B}-n line or the a-n line.

(3) Investigation of Grain Boundary Scattering Model

In order to describe the grain boundary barrier-carrier concentration dependence (V_{B}-n line) of FIG. 12(a), first, verification of a Seto model [John Y. W. Seto, J. Appl. Phys. 46 5247 (1975)], which is used in general in discussions of grain boundary barriers in polycrystalline semiconductors, was performed. However, through use of the Seto model, it was found that the carrier concentration dependence of V_{B} has a “V_{B}-n graph exhibiting a concave-up” behavior, which significantly deviates from the V_{B}-n line of FIG. 12(a). Then, as a result of an extensive literature survey, it was found that a “concave-down V_{B}-n graph” curve that closely reflects the behavior of the V_{B}-n line is obtained through use of a Seager model [C. H. Seager, T. G. Castner J Appl Phys 49, 3879 (1978)]. The Seto model has a drawback that there is no concept of an energy level for traps (the energy level automatically varies), but the Seager model overcomes this drawback by deriving the V_{B}(n) expression with a trap energy level and a trap amount used as independent variables, and hence it is considered that there was a match with the experimental behavior. The V_{B}-n line of FIG. 12(a) is a result of using the Seager model with a Fermi level difference between a grain boundary and a grain interior set to 25 meV and a trap density at the grain boundary set to 7.5×10¹³ cm² eV-1. As described above, the Seager model, which accurately represents the behavior of V_{B}(n), was adopted to obtain the following Expression (A11).

$${V}_{B} = {δ}_{{E}_{F}} [ 1 + \frac{α}{2 {δ}_{{E}_{F}}} - {( \frac{α}{{δ}_{{E}_{F}}} + \frac{{α}^{2}}{4 {δ}_{{E}_{F}}^{2}} )}^{1 / 2} ] \qquad ( A11 )$$

[In Expression (A11),
V_{B} is a grain boundary barrer height [eV],
α is expressed by:

$$α = \frac{8 {ε}_{0} {ε}_{r} n}{{e}^{2} {N}_{T}^{2}}$$

(in the expression,
ε is a vacuum permittivity [F/cm],
εᵣ is a relative permittivity (static),
“n” is the free carrier concentration [cm⁻³] (equal to the free electron density [cm⁻³] in the oxide semiconductor treated herein),
“e” is an elementary charge [C], and
N_{T} is a grain boundary trap density [cm² eV⁻¹]), and
δ_{EF} is a Fermi energy difference (E_{F}^{GB}-E_{F}^{B}) [eV] between the grain boundary and the grain interior,
where V_{B}≥0 is satisfied.]

In this case, the grain boundary barrier height V_{B} expressed by Expression (A11) corresponds to Expression (13).

### (4) Investigation of Optical Phonon Scattering Model

A plurality of models based on temperature dependences have been proposed with respect to optical phonon scattering, but a_{OP} extracted from the parameter fitting exhibited a temperature dependence of the following.

$$exp ( {ℏω}_{opt} / {k}_{B} T ) - 1$$

Therefore, a model having this temperature dependence term was explored. As a result, in regard to the optical phonon scattering, the following Expression (A2-2) [J. J. Wang et. al., Phys. Lett. A 374 2286 (2010)] based on a Fröhlich model [H. Fröhlich, Advances in Physics 3 325 (1954)] was adopted.

$${μ}_{o P} = \frac{4 π {ε}_{0} {ℏ}^{2} [ exp ( \frac{{ℏω}_{opt}}{{k}_{B} T} ) - 1 ]}{em * {( 2 m * {ℏω}_{opt} )}^{1 / 2}} / ( \frac{1}{{ε}_{o p t}} - \frac{1}{{ε}_{r}} ) \qquad ( A2 - 2 )$$

[In Expression (A2-2),
μ_{OP} is an optical phonon scattering mobility [cm²/Vs],
ε₀ is the vacuum permittivity [F/cm],
[symbol] is a Dirac constant [eVs],
[symbol] ωₒₚₜ is optical phonon energy [eV] (ωₒₚₜ is a vibrational frequency [s⁻¹] of an optical phonon),
k_{B} is the Boltzmann constant [eV/K],
T is the temperature [K],
“e” is the elementary charge [C],
m* is an effective mass [eV/c²] (“c” is the speed [cm/s] of light) normalized by the speed of light,
εₒₚₜ is a relative permittivity (optical), and
εᵣ is the relative permittivity (static).]

Values of ωₒₚₜ=360 cm⁻¹, εₒₚₜ=4, and εᵣ=14 were actually substituted into Expression (A2-2) to acquire the a_{OP}(n) line shown in FIG. 12(b). The substitution values showed a satisfactory match with a vibrational frequency of 363.4 cm⁻¹ of a TO phonon, which is the most dominant vibrational mode of indium oxide [M. Stokey. et. al., J. Appl. Phys. 129 225102 (2021)], an optical permittivity of 4 of an ITO thin film [J. Ederth et. al., Phys. Rev. B 68 155410 (2003)], and a relative permittivity value of 11.85 extracted from impedance measurement. From the fact that those substitution values matched past reports and from reproducibility of a_{OP}, it was determined that the Fröhlich model selected in this case is appropriate.

Further, in a low carrier concentration region (<5×10¹⁸ cm⁻³) of FIG. 12(b), no experimental points were observed. This is considered to be attributable to similarity between the temperature dependence term for a_{OP}:

$$< exp ( {ℏω}_{opt} / {k}_{B} T ) - 1 >$$

and a temperature dependence term <exp(−qV_{B}/k_{B}T)>of grain boundary scattering. This is because, in the low carrier concentration region, contribution of the grain boundary scattering is high, and it is difficult to extract the temperature dependence term of the a_{OP}. In fact, it has been reported that a mobility expression for the optical phonon scattering is almost maintained even when the carrier concentration changes from the degenerate region to the non-degenerate region [A. Bikowski, K. Ellmer, J. Appl. Phys. 116 143704 (2014)]. From the above description, Expression (A2-2) based on the Frohlich model was assumed to be valid over the entire carrier concentration region as an optical phonon scattering model.

Now, in one embodiment, the coefficient of the 1/(exp(β/T)−1) term is a₁ [cm⁻²Vs], and can be expressed by the mobility μ_{OP} determined by the optical phonon scattering model, and a reciprocal of the mobility μ_{OP} [cm²/Vs] determined by the optical phonon scattering model is expressed by the following Expression (A2):

$$\frac{1}{{μ}_{O P}} = {a}_{1} \frac{1}{exp ( \frac{β}{T} ) - 1} , \qquad ( A2 )$$

[in Expression (A2),
T is the temperature [K], and
β [K] is the coefficient.]

That is, 1/μ_{OP} expressed by Expression (A2) corresponds to the term:

$${a}_{1} \frac{1}{exp ( \frac{β}{T} ) - 1}$$

in Expression (1).

In one embodiment, the coefficient β [K] can be expressed by the following expression:

β= [symbol] ωₒₚ(k_{B})⁻¹,
[in the expression,
[symbol] ωₒₚ is energy [eV] of an optical phonon that varies depending on the carrier concentration,
k_{B} is the Boltzmann constant (8.617×10⁻⁵ [eV/K]), and
[symbol] is the Dirac constant (6.58212×10⁻¹⁶ [eVs]).]

In one embodiment, the coefficient a₁ [cm⁻²Vs] can be expressed by the following Expression (A2-1):

$${a}_{1} = {[ \frac{4 π {ε}_{0} {ℏ}^{2}}{em * {( 2 m * {ℏω}_{opt} )}^{1 / 2}} / ( \frac{1}{{ε}_{opt}} - \frac{1}{{ε}_{r}} ) ]}^{- 1} , \qquad ( A2 - 1 )$$

[in Expression (A2-1),
ε₀ is the vacuum permittivity [F/cm],
[symbol] is the Dirac constant (6.58212×10⁻¹⁶ [eVs]),
“e” is the elementary charge [C],
m* is the effective mass [eV/c²] (“c” is the speed [cm/s] of light) normalized by the speed of light, [symbol] ωₒₚ is the energy [eV] of the optical phonon that varies depending on the carrier concentration,
εₒₚₜ is the relative permittivity (optical), and
εᵣ is the relative permittivity (static).]

In one embodiment, the mobility μ_{OP} [cm²/Vs] determined by the optical phonon scattering model can be expressed by the following Expression (A2-2):

$${μ}_{OP} = \frac{4 π {ε}_{0} {ℏ}^{2} [ e x p ( \frac{{ℏω}_{opt}}{{k}_{B} T} ) - 1 ]}{em * {( 2 m * {ℏω}_{opt} )}^{1 / 2}} / ( \frac{1}{{ε}_{opt}} - \frac{1}{{ε}_{r}} ) , \qquad ( A2 - 2 )$$

[in Expression (A2-2),
μ_{OP} is an optical phonon scattering mobility [cm²/Vs],
ε₀ is the vacuum permittivity [F/cm],
[symbol] is the Dirac constant [eVs],
[symbol] ωₒₚₜ is optical phonon energy [eV] (ωₒₚₜ is a vibrational frequency [s⁻¹] of an optical phonon),
k_{B} is the Boltzmann constant [eV/K],
T is the temperature [K],
“e” is the elementary charge [C],
m* is the effective mass [eV/c²] (“c” is the speed [cm/s] of light) normalized by the speed of light,
εₒₚₜ is the relative permittivity (optical), and
εᵣ is the relative permittivity (static).]

### (5) Ionized Impurity Scattering (Non-Degenerate) Model

As ionized impurity scattering (non-degenerate) mobility models, a Conwell-Weisskopf model (commonly known as “CW model”) [E. Conwell, V. F. Weisskopf, Phys. Rev. 69 258 (1946), and E. Conwell, V. F. Weisskopf, Phys. Rev. 77 388 (1946)], and a Brooks-Herring model (commonly known as “BH model”) [H. Brooks, Phys. Rev. 83 879 (1951), and H. Brooks, Adv. Electron. Phys. 7 85 (1955)] are well known. When the CW model and the BH model are compared to each other, a difference arises in a long-range component term (corresponding to a screening function F_{II} in the ionized impurity scattering in Expression (A3-2), which is described later) of the Coulomb potential in terms of whether the term is truncated or screened by approximation, but otherwise, both models have the same expression. Further, the truncated term in the CW model serves as a function of an ionized impurity concentration Nu because of using a distance between ionized impurities as an index [D. Chattopadhyay, H. Queisser J. Rev. Mod. Phys. 53 745 (1981)]. Meanwhile, in the BH model, ionized impurities are screened under an influence of a surrounding electron concentration, and hence F_{II} serves as a function not of N_{II} but of the free carrier concentration “n” [D. Chattopadhyay, H. Queisser J. Rev. Mod. Phys. 53 745 (1981)]. In general single-crystal semiconductors, the ionized impurity concentration N_{II} and the free carrier concentration “n” are approximately equal to each other, that is, a relationship between N_{II} and “n” often holds, and many literatures do not strictly distinguish therebetween, thereby requiring attention to be paid at a time of selecting an expression.

The broken line in FIG. 12(c) is an a_{II_nonDeg}-n line, and the broken line in a low carrier concentration portion of FIG. 12(c) is a result of applying the following Expression (A5-CW), which is the CW model. As is clear from the definition expression of the CW model, the scattering parameter a_{II_nonDeg} does not indicate a carrier concentration dependence. Meanwhile, when the BH model was applied, an influence of the free carrier concentration “n” in the F_{II} term was large, the scattering parameter monotonically increased toward a low carrier concentration range, and an actual measurement result was not reproduced. In view of the foregoing, in consideration of continuity with an ionized impurity scattering (degenerate) model described later, a screening parameter of a Pisarkiewicz type [T. Pisarkiewicz, et. al., Thin Solid Films 174 217 (1989)] was applied for F_{II} in the CW model. As a result, it was found that, in the following Expressions (A5-BH) and (F), scattering parameter a_{II_nonDeg} characteristics similar to those of a truncated type (the following Expression (A5-CW)) are obtained. In this case, the non-degenerate region and the degenerate region can be divided with an effective density Nc of states used as a boundary, but a mobility function becomes discontinuous, and hence a continuous change using a sigmoid function was selected.

In one embodiment, a mobility μ_{II}^{(nonDeg)} [cm²/Vs] determined by the ionized impurity scattering (non-degenerate) model can be expressed by Mobility Expression (A5-BH) of a Conwell-Weisskopf model type or a Brooks-Hering model type.

In one embodiment, the mobility μ_{II}^{(nonDeg)} [cm²/Vs] determined by the ionized impurity scattering (non-degenerate) model can be expressed by the following Mobility Expression (A5-CW) of the Conwell-Weisskopf model type.

$${μ}_{II}^{( nonDeg )} = \frac{128 \sqrt{2 π} {( {ε}_{0} {ε}_{r} )}^{2} {( {k}_{B} T )}^{3 / 2}}{\sqrt{{m}^{*}} {e}^{3}} \times \frac{1}{{Z}^{2} {N}_{II \_ nonDeg}} \times {\{ ln [ 1 + {( \frac{12 π {ε}_{0} {ε}_{r} {k}_{B} T}{{e}^{3} Z {N}_{II \_ nonDeg}^{1 / 3}} )}^{2} ] \}}^{- 1} \qquad ( A5 ‐ CW )$$

[In Expression (A5-CW),
ε₀ is the vacuum permittivity [F/cm],
εᵣ is the relative permittivity (static),
k_{B} is the Boltzmann constant [eV/K],
T is the temperature [K],
m* is the effective mass [eV/c²] (“c” is the speed [cm/s] of light) normalized by the speed of light,
“e” is the elementary charge [C],
Z is an ionic valence of an ionized impurity, and
N_{II_nonDeg} is an ionized impurity concentration [cm⁻³].]

In one embodiment, the mobility u_{II}^{(nonDeg)} [cm²/Vs] determined by the ionized impurity scattering (non-degenerate) model can be expressed by the following Mobility Expression (A5-BH) of the Brooks-Heming model type:

$${μ}_{II}^{( nonDeg )} = \frac{128 \sqrt{2 π} {( {ε}_{0} {ε}_{r} )}^{2} {( {k}_{B} T )}^{3 / 2}}{\sqrt{{m}^{*}} {e}^{3}} \times \frac{1}{{Z}^{2} {N}_{{II}_{n o n} D e g}} \times \frac{1}{{F}_{II}} , \qquad ( A5 ‐ BH )$$

[in Expression (A5-BH),
F_{II} is the screening function in the ionized impurity scattering,
ε₀ is the vacuum permittivity [F/cm],
εᵣ is the relative permittivity (static),
k_{B} is the Boltzmann constant [eV/K],
T is the temperature [K],
m* is the effective mass [eV/c²] (“c” is the speed [cm/s] of light) normalized by the speed of light,
“e” is the elementary charge [C],
Z is the ionic valence of the ionized impurity, and
N_{II_nonDeg} is the ionized impurity concentration [cm^{-3].]}

The screening function F_{II} in the mobility expression of the Brooks-Herring model type is a screening function F_{II} in the ionized impurity scattering of the Pisarkiewicz type, which is expressed by the following Expression (F):

$${F}_{II} = [ 1 + \frac{4 {ξ}_{n p}}{{ξ}_{d}} ( 1 - \frac{{ξ}_{n p}}{8} ) ] ln ( 1 + {ξ}_{d} ) - \frac{{ξ}_{d}}{1 + {ξ}_{d}} - 2 {ξ}_{n p} ( 1 - \frac{5 {ξ}_{n p}}{16} ) , \qquad ( F )$$

[in Expression (F),
ξ_{d} is a reduced screening parameter in F_{II}, and is expressed by the following expression:

$${ξ}_{d} = {( 3 {π}^{2} n )}^{1 / 3} \frac{4 {π}^{2} {ℏ}^{2} {ε}_{0} {ε}_{r}}{{m}^{*} {e}^{2}} ,$$

(in the expression,
“n” is the free carrier concentration [cm⁻³] (equal to the free electron density [cm⁻³] in the oxide semiconductor treated herein),
[symbol] is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]), and
ξₙₚ is an additional screening parameter in F_{II} for accommodating an effective mass change, and is expressed by the following expression:

$${ξ}_{np} = 1 - \frac{{m}_{0}^{*}}{{m}^{*}} ,$$

(in the expression,
m₀* is a minimum value of the effective mass at a bottom of the conduction band or a top of the valence band, and
m* is the effective mass [eV/c²] (“c” is the speed [cm/s] of light) normalized by the speed of light).]

In one embodiment, assuming that a mobility determined by an ionized impurity scattering (non-degenerate) model that can be expressed by a mobility expression of the Conwell-Weisskopf model type or the Brooks-Herring model type is μ_{II_CW-BH}^{(nonDeg)} [cm²/V/s], the mobility μ_{II}^{(nonDeg)} [cm²/s] determined by the ionized impurity scattering (non-degenerate) model can be expressed by the following Expression (A5-S) of a sigmoid function type with respect to the carrier concentration “n”.

$${μ}_{II}^{( nonDeg )} = \frac{{μ}_{{II}_{CW - BH}}^{( non D e g )}}{1 + {( \frac{{N}_{C}}{n} )}^{- α}} \qquad ( A5 ‐ S )$$

[In Expression (A5-S),
N_{C} is an effective density [cm⁻³] of states,
“n” is the free carrier concentration [cm⁻³] (equal to the free electron density [cm⁻³] in the oxide semiconductor treated herein), and
“a” is a parameter representing a rate of change of the sigmoid function.]

In this case, the coefficient of the T^{-3/2} term is a₃ [cm⁻²VsK^{3/2}], and a product of the coefficient as and T^{-3/2} can be expressed by a reciprocal 1/μ_{II}^{(nonDeg)} of the mobility μ_{II}^{(nonDeg)} [cm⁻²Vs] determined by the ionized impurity scattering (non-degenerate) model.

### (6) Discussion and Modeling of Scattering Parameter a₀

Of scattering parameter behaviors to be elucidated in FIG. 12(a) to FIG. 12(d), a₀(n) shown in FIG. 12(d) means a scattering parameter in which the mobility exhibits no temperature dependence (μ(T)∝T⁰). In this case, a₀(n) serves as a dominant factor (that is, the most important scattering parameter) for mobility characteristics during TFT operation, two kinds of scattering (neutral impurity scattering and ionized impurity scattering (degenerate) are mixed as scattering factors, and related-art models cannot be applied to the neutral impurity scattering. Therefore, due to complexity involved therein, the discussion is divided as follows.

### (6-1) Neutral Impurity Scattering Erginsoy Model

The neutral impurity scattering, in the narrow sense, is a mechanism by which conduction carriers are scattered, when hydrogen-like atoms are assumed as neutral impurity scatterers, in which a cross section of the hydrogen-like atoms (on the order of the square of a Bohr radius a₀) corresponds to the total scattering cross section. Further, in this scattering, elastic scattering and quantum scattering due to potential of the hydrogen-like atoms are assumed, and it is common practice to treat the total scattering cross section as a phase shift amount in a wave number space. Further, as a model of the neutral impurity scattering, an Erginsoy model [C. Erginsoy, Phys. Rev. 79 1013 (1950)] has been widely adopted. This is considered to be attributable to the fact that a bold approximation is used in calculating the total scattering cross section, thereby resulting in a simple mathematical expression. Meanwhile, a linear approximation is used for the scattering cross section, and hence scattering in a high-energy region tends to be overestimated, thereby resulting in a problem in that a significant mobility reduction is caused even at a low scatterer concentration. In fact, when the Erginsoy model is used for FIG. 12(d), the model corresponds to a plateau component in the low carrier concentration region (<3×10¹⁷ cm⁻³), but cannot be applied to a change in a₀(n) exhibiting a non-linear behavior in a high carrier concentration region. Apart from the ionized impurity scattering (degenerate) described later, there was no factor other than the neutral impurity scattering exhibiting a T⁰ dependence, and hence further investigations were performed on known neutral impurity scattering models and ionized impurity scattering (degenerate).

In one embodiment, the coefficient of the T⁰ term is a₂ [cm⁻²Vs], and can be expressed by any one or both of a reciprocal 1/UNI of a mobility μ_{NI} [cm²/Vs] determined by the neutral impurity scattering model and a reciprocal 1/μ_{II}^{(Deg)} of a mobility μ_{II}^{(Deg)} [cm²/s] determined by the ionized impurity scattering (degenerate) model.

In one embodiment, the mobility μ_{NI} [cm²/Vs] determined by the neutral impurity scattering model can be expressed by a mobility model of an Erginsoy type or a mobility approximate expression of a Quisse type.

In one embodiment, the mobility μ_{NI} [cm²/Vs] determined by the mobility model of the Erginsoy type is expressed by the following Expression (A3E).

$${μ}_{NI} = \frac{{m}^{*} {e}^{2}}{80 π {ε}_{0} {ε}_{r} {ℏ}^{3}} \times \frac{1}{{N}_{NI}} \qquad ( A3E )$$

[In Expression (A3E),
m* is the effective mass [eV/c²] (“c” is the speed [cm/s] of light) normalized by the speed of light,
“e” is the elementary charge [C],
ε₀ is the vacuum permittivity [F/cm],
εᵣ is the relative permittivity (static),
[symbol] is the Dirac constant [eVs], and
N_{NI} is a neutral impurity scattering concentration [cm^{-3].]}

### (6-2) Neutral Impurity Scattering Quisse Model

As a result of a literature survey on neutral impurity scattering models, a Quisse model [T. Quisse, Physica B 270 262 (1999)], which indicates that a total scattering cross section Q exhibits the carrier concentration dependence, namely, which is potentially capable of describing a change in carrier concentration of a₀(n), was found out. In the Quisse model, it is possible to calculate the total scattering cross section and the mobility for hydrogen-like atoms without the approximation, by incorporating a concept of an effective Bohr radius, which takes into account a Debye screening length due to the change in the carrier concentration, and combining a large number of analytical expressions in a trial wave function.

First, in order to determine whether or not the Quisse model can be applied to this system, reproduction of the results reported in the Quisse paper [T. Quisse, Physica B 270 262 (1999)] was carried out. As a result of the reproduction, a Q/πa₀²-ka₀ graph similar to that in the Quisse paper was able to be plotted, and the change in the scattering parameter a_{NI} was also confirmed to be consistent with the behavior of a₀(n) of FIG. 12(d). Further, through comparison of the Erginsoy model and the Quisse model, it became clearer that the former lacks the temperature dependence or carrier concentration dependence of the mobility, while the latter reflects influences of both the temperature and the carrier concentration on the mobility.

In one embodiment, the mobility μ_{NI} [cm²/V/s] determined by a mobility model of the Quisse type is expressed by the following Expressions (Q-1) to (Q-26).

$${μ}_{NI} = \frac{q}{3 ℏ {N}_{NI}} \sqrt{\frac{2}{π}} {( \frac{{ℏ}^{2}}{{m}^{*} {k}_{B} T} )}^{\frac{5}{2}} {\int }_{0}^{∞} \frac{{k}^{2}}{Q} exp ( - \frac{{ℏ}^{2} {k}^{2}}{2 {m}^{*} {k}_{B} T} ) dk \qquad ( Q ‐ 1 )$$

$$Q = \frac{4 π}{{k}^{2}} \frac{{( \overline{α} - \overline{L} / k )}^{2}}{1 + {( \overline{α} - \overline{L} / k )}^{2}} \qquad ( Q ‐ 2 )$$

$$\overline{L} = L ( \overline{α} , \overline{β} ) \qquad ( Q ‐ 3 )$$

$$L = - ( {α}^{2} {F}_{1} + {β}^{2} {F}_{2} + α {F}_{3} + β {F}_{4} + αβ {F}_{5} + {F}_{6} ) \text{?} \qquad ( Q ‐ 4 )$$

$$\overline{α} = \frac{{F}_{4} {F}_{5} - 2 {F}_{2} {F}_{3} - 2 {kF}_{2}}{4 {F}_{1} {F}_{2} - {F}_{5}^{2}} \text{?} \qquad ( Q ‐ 5 )$$

$$\overline{β} = \frac{{F}_{3} {F}_{\text{?}} - 2 {F}_{1} {F}_{4} + {kF}_{\text{?}}}{4 {F}_{1} {F}_{2} - {F}_{\text{?}}^{2}} \text{?} \qquad ( Q ‐ 6 )$$

$${F}_{1} = 2 γ {H}_{31} ( {q}_{\text{?}} ) + 2 δ {H}_{31} ( 2 a ) - kI ( a ) + kI ( 2 a ) - J ( 2 a ) + 2 ζ ( J ( 4 a ) - 2 J ( 3 a ) + J ( 2 a ) ) \text{?} \qquad ( Q ‐ 7 )$$

$${F}_{2} = 2 γ {H}_{33} ( {q}_{\text{?}} ) + 2 δ {H}_{33} ( 2 a ) + kI ( 2 a ) - 3 kI ( 3 a ) + 2 kI ( 4 a ) + J ( 2 a ) - 5 J ( 3 a ) + 4 J ( 4 a ) + 2 ζ ( J ( 4 a ) + J ( 6 a ) - 2 J ( 5 a ) \text{?} \qquad ( Q ‐ 8 )$$

$${F}_{3} = 2 γ ( M ( {q}_{\text{?}} , 0 ) - M ( {q}_{\text{?}} , a ) ) + 2 δ ( M ( 2 a , 0 ) - M ( 2 a , a ) ) - \frac{1}{2} I ( a ) - 2 kΚ ( a ) + 2 ζ ( I ( 2 a ) - I ( 3 a ) ) \text{?} \qquad ( Q ‐ 9 )$$

$${F}_{4} = 2 γ ( M ( {q}_{\text{?}} , a ) - M ( {q}_{\text{?}} , 2 a ) ) + 2 δ ( M ( 2 a , a ) - M ( 2 a , 2 a ) ) + \frac{1}{2} I ( a ) - 2 I ( 2 a ) + 2 kΚ ( a ) - 4 kK ( 2 a ) + 2 ζ ( - I ( 4 a ) + I ( 3 a ) ) \text{?} \qquad ( Q ‐ 10 )$$

$${F}_{5} = 4 γ {H}_{32} ( {q}_{s} ) + 4 δ {H}_{32} ( 2 a ) + kI ( a ) - 4 kI ( 2 a ) + 3 kI ( 3 a ) + J ( a ) - 6 J ( 2 a ) + 5 J ( 3 a ) + 2 ζ ( - 4 J ( 4 a ) + 2 J ( 5 a ) + 2 J ( 3 a ) ) \text{?} \qquad ( Q ‐ 11 )$$

$${F}_{6} = 2 ( γ {H}_{1} ( {q}_{\text{?}} ) + δ {H}_{1} ( 2 a ) + ζ K ( 2 a ) ) \text{?} \qquad ( Q ‐ 12 )$$

$${H}_{\text{?}} ( x , a ) = {\int }_{\text{?}}^{\text{?}} \frac{{e}^{\text{?}}}{r} {( 1 - {e}^{\text{?}} )}^{2} {cos}^{2} kr dr = \frac{1}{4} ln ( \frac{{( x + a )}^{\text{?}} {( {( x + a )}^{2} + 4 {k}^{\text{?}} )}^{2}}{{x}^{\text{?}} ( {x}^{\text{?}} + 4 {k}^{2} ) {( x + 2 a )}^{\text{?}} ( {( x + 2 a )}^{\text{?}} + 4 {k}^{\text{?}} )} ) \text{?} \qquad ( Q ‐ 13 )$$

$${H}_{\text{?}} ( x , a ) = {\int }_{\text{?}}^{\text{?}} \frac{{e}^{\text{?}}}{r} {( 1 - {e}^{\text{?}} )}^{2} {cos}^{\text{?}} kr dr = \frac{1}{4} ln ( \frac{{( x + 2 a )}^{\text{?}} {( {( x + 2 a )}^{2} + 4 {k}^{\text{?}} )}^{2}}{{( x + a )}^{\text{?}} ( {( x + a )}^{2} + 4 {k}^{\text{?}} ) {( x + 3 a )}^{\text{?}} ( {( x + 3 a )}^{\text{?}} + 4 {k}^{\text{?}} )} ) \text{?} \qquad ( Q ‐ 14 )$$

$${H}_{\text{?}} ( x , a ) = {\int }_{\text{?}}^{\text{?}} \frac{{e}^{\text{?}}}{\text{?}} {( 1 - {e}^{\text{?}} )}^{\text{?}} {cos}^{\text{?}} kr dr = \frac{1}{4} ln ( \frac{{( x + 3 a )}^{\text{?}} {( {( x + 3 a )}^{2} + 4 {k}^{\text{?}} )}^{2}}{{( x + 2 a )}^{2} ( {( x + 2 a )}^{2} + 4 {k}^{2} ) {( x + 4 a )}^{2} ( {( x + 4 a )}^{2} + 4 {k}^{\text{?}} )} ) \text{?} \qquad ( Q ‐ 15 )$$

$${H}_{\text{?}} ( x ) = {\int }_{\text{?}}^{\text{?}} \frac{{e}^{\text{?}}}{\text{?}} {sin}^{2} kr dr = \frac{1}{4} ln ( \frac{{x}^{2} + 4 {k}^{\text{?}}}{{x}^{\text{?}}} ) \text{?} \qquad ( Q ‐ 16 )$$

$$\text{?} ( x ) = {\int }_{\text{?}}^{\text{?}} {e}^{\text{?}} sin 2 kr \text{?} = \frac{2 k}{{x}^{2} + 4 {k}^{\text{?}}} \text{?} \qquad ( Q ‐ 17 )$$

$$J ( x ) = {\int }_{\text{?}}^{\text{?}} {cos}^{2} kr dr = \frac{1}{{x}^{2} + 4 {k}^{\text{?}}} ( x \text{?} \frac{2 {k}^{\text{?}}}{x} ) \text{?} \qquad ( Q ‐ 18 )$$

$$K ( x ) = {\int }_{\text{?}}^{\text{?}} {e}^{\text{?}} {sin}^{2} \text{?} = \frac{1}{x} - \text{?} ( x ) \text{?} \qquad ( Q ‐ 19 )$$

$$M ( x , y ) = {\int }_{\text{?}}^{\text{?}} \frac{\text{?}}{\text{?}} sin \text{?} = arctan ( \frac{\text{?}}{\text{?}} ) \qquad ( Q ‐ 20 )$$

$$γ = \frac{{q}_{s}^{2} ( {q}_{s}^{2} - 8 {a}^{2} )}{{( {q}_{s}^{2} - 4 {a}^{2} )}^{2}} \text{?} \qquad ( Q ‐ 21 )$$

$$δ = \frac{16 {a}^{4}}{{( {q}_{\text{?}}^{2} - 4 {a}^{2} )}^{2}} \text{?} \qquad ( Q ‐ 22 )$$

$$ζ = \frac{4 {a}^{3}}{4 {a}^{2} - {q}_{\text{?}}^{2}} \text{?} \qquad ( Q ‐ 23 )$$

$$\frac{1}{a} = {a}_{0} \frac{1 + ( 8 / 5 ) {( {a}_{0} {q}_{1} / 4 )}^{5 / 2}}{1 + {( {a}_{0} {q}_{\text{?}} / 4 )}^{5 / 2}} \text{?} \qquad ( Q ‐ 24 )$$

$${a}_{0} = \frac{4 π {ε}_{r} {ε}_{0} {ℏ}^{2}}{{m}^{*} {q}^{2}} \qquad ( Q ‐ 25 )$$

$${q}_{s} = \sqrt{\frac{{q}^{2} n}{{ε}_{r} {ε}_{0} kBT}} \qquad ( Q ‐ 26 )$$

$$\text{?} \text{indicates text missing or illegible when filed}$$

[In Expressions (Q-1) to (Q-26),
μ_{NI} is the mobility [cm²/Vs] determined by the Quisse model,
N_{NI} is a neutral impurity concentration [cm⁻³],
“k” is a wave number vector [cm⁻¹],
“q” is the elementary charge [C],
[symbol] is the Dirac constant [eVs],
m* is the effective mass [eV/c²] (“c” is the speed [cm/s] of light) normalized by the speed of light,
k_{B} is the Boltzmann constant [eV/K],
T is the temperature [K],
Q is the total scattering cross section [cm²],
L is the trial wave function,
L̅ is a minimum value of the trial wave function,
α is a phase parameter,
α̅ is a phase parameter at the minimum value L of the trial wave function,
β is a variational parameter,
β̅ is a variational parameter at the minimum value L of the trial wave function,
F₁ to F₆ are components of respective terms that form the trial wave function L,
H₃₁(x, a) is a constituent component of F₁,
H₃₂(x, a) is a constituent component of F₅,
H₃₃(x, a) is a constituent component of F₂,
H₁ (x) is a constituent component of F₆,
I(x) is a constituent component of each of F₁ to F₅,
J(x) is a constituent component of each of F₁, F₂, and F₅,
K(x) is a constituent component of each of F₃, F₄, and F₆,
M(x, y) is a constituent component of each of F₃ and F₄,
   “x” and “y” are variables,
   “a” is a reciprocal of the effective Bohr radius,
γ is a constituent component of each of F₁ to F₆,
δ is a constituent component of each of F₁ to F₆,
ζ is a constituent component of each of F₁ to F₆,
a₀ is the Bohr radius [cm],
qₛ is a Debye screening parameter [cm⁻¹],
εᵣ is the relative permittivity (static), and
ε₀ is a vacuum permittivity [F/cm].]

Next, the expression for the Debye screening parameter qₛ used in the Quisse paper was found to be difficult to apply to the high carrier concentration region, and was therefore modified to the Debye screening parameter qₛ expressed by the following expressions, which is applicable even to a degenerate semiconductor region having a high carrier concentration [C. Kittel, H. Kroemer, “Thermal Physics” Freeman, New York, 2nd ed. (1980) Chap. 13 pp. 367].

In one embodiment, the Debye screening parameter qₛ is selected from the group consisting of the following Expressions (Qq-1) to (Qq-5).

$${q}_{s} = \frac{q}{\sqrt{{ε}_{r} {ε}_{0} {k}_{B} T}} {( \frac{1}{n} )}^{- 1 / 2} \qquad ( Qq ‐ 1 )$$

$${q}_{s} = \frac{q}{\sqrt{{ε}_{r} {ε}_{0} {k}_{B} T}} {( \frac{1}{n} + \frac{1}{\sqrt{8} N c} )}^{- 1 / 2} \qquad ( Qq ‐ 2 )$$

$${q}_{s} = \frac{q}{\sqrt{{ε}_{r} {ε}_{0} {k}_{B} T}} {( \frac{1}{n} + \frac{1}{\sqrt{8} N c} + ( \frac{3}{16} - \frac{\sqrt{3}}{9} ) \frac{2}{N {c}^{2}} n )}^{- 1 / 2} \qquad ( Qq ‐ 3 )$$

$${q}_{s} = \frac{q}{\sqrt{{ε}_{r} {ε}_{0} {k}_{B} T}} {( \frac{1}{n} + \frac{1}{\sqrt{8} N c} + ( \frac{3}{16} - \frac{\sqrt{3}}{9} ) \frac{2}{N {c}^{2}} n + 1.48386 \times {10}^{- 4} \times \frac{3}{N {c}^{3}} {n}^{2} )}^{- 1 / 2} \qquad ( Qq ‐ 4 )$$

$${q}_{s} = \frac{q}{\sqrt{{ε}_{r} {ε}_{0} {k}_{B} T}} {( \frac{1}{n} + \frac{1}{\sqrt{8} N c} + ( \frac{3}{16} - \frac{\sqrt{3}}{9} ) \frac{2}{N {c}^{2}} n + 1.483 \; 86 \times {10}^{- 4} \times \frac{3}{N {c}^{3}} {n}^{2} - 4.42563 \times 1 {0}^{- 6} \times \frac{4}{N {c}^{4}} {n}^{3} )}^{- 1 / 2} \qquad ( Qq ‐ 5 )$$

[In Expressions (Qq-1) to (Qq-5),
ε₀ is the vacuum permittivity [F/cm],
εᵣ is the relative permittivity (static),
k_{B} is the Boltzmann constant [eV/K],
T is the temperature [K],
“n” is the free carrier concentration [cm⁻³] (equal to the free electron density [cm⁻³] in the oxide semiconductor treated herein), and
N_{C} is the effective density [cm⁻³] of states.]

In one embodiment, qₛ expressed by the following expression is used.

$${q}_{s} = \frac{e}{\sqrt{{k}_{B} T {ε}_{0} {ε}_{r}}} {( \frac{1}{n} + \frac{1}{\sqrt{8} {N}_{C}} )}^{- 1 / 2}$$

[In the expression,
“e” is the elementary charge [C],
k_{B} is the Boltzmann constant [eV/K],
T is the temperature [K],
ε₀ is the vacuum permittivity [F/cm],
εᵣ is the relative permittivity (static),
“n” is the free carrier concentration [cm⁻³] (equal to the free electron density [cm⁻³] in the oxide semiconductor treated herein), and
N_{C} is an effective density [cm⁻³] of states.]

Through application of the Debye screening parameter qₛ modified as described above, it was confirmed that the Quisse model can be extended up to a carrier concentration region of about 1×10²⁰ cm⁻³ in polycrystalline oxide semiconductors. Further, as a result of examining the carrier concentration dependence and temperature dependence of a_{NI} acquired from the Quisse model, it was found that, in a carrier concentration region corresponding to a plateau region of FIG. 12(d), extrapolated values converge to a single point when the scattering parameter a_{NI} (reciprocal of the mobility) is plotted against T^{-3/2}. This accordingly means presence of an a_{NI} component having the T⁰ dependence. It was confirmed that the experimental results are supported by the Quisse model.

In addition, it was confirmed that a_{NI} decreases in the high carrier concentration region at or above 1×10¹⁸ cm⁻³. This result does not directly describe the change in a₀(n) of FIG. 12(d) in the high carrier concentration region, but does not show such deviation as observed in the Erginsoy model, and rather suggests that the change can be described in combination with other scattering factors.

### (6-3) Formulation of Approximate Analytical Expression of Neutral Impurity Scattering Quisse Model

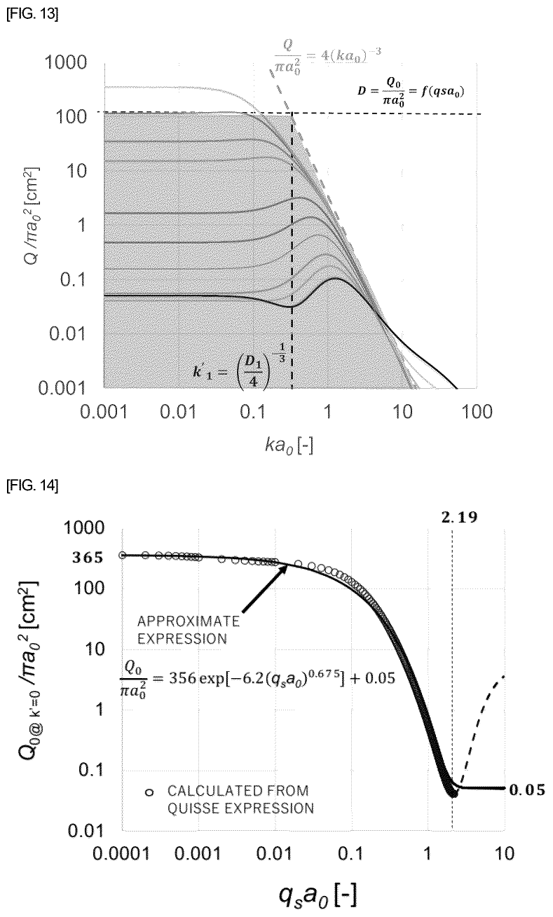

Up to this point, verification results of the Quisse paper have been described. However, in consideration of implementing model expressions into a simulator, in the Quisse model, it is required to combine a total of 24 analytical expressions to calculate the total scattering cross section Q, and further numerical calculation is required at a time of calculating the mobility, thereby placing constraints on the programs that incorporate the model expressions. In view of the foregoing, an attempt was made to formulate an analytical expression for the mobility by approximating the behavior of the total scattering cross section Q in the Quisse model as an integrable approximate expression. Specifically, the log-log graph of Q/πa₀² versus ka₀ presented in the Quisse paper was regarded as a right trapezoid with a fixed hypotenuse, and incorporated into integral calculation used to calculate the mobility by utilizing the fact that a height D of an upper base serves as a function of qₛa₀ (n, T) as shown in FIG. 13.

An approximate analytical expression of the Quisse type, expressed by the following Expression (A3Q-app), was obtained through expression expansion.

In one embodiment, the mobility μ_{NI} [cm²/Vs] determined by the mobility model of the Quisse type can be expressed by the following Approximate Expression (A3Q-app).

$${μ}_{NI} = \frac{e}{3 ℏ {N}_{N I}} \sqrt{\frac{2}{π}} \frac{{( 2 {a}_{0}^{2} C )}^{\frac{5}{2}}}{2 π {a}_{0}^{6}} 〈 - \frac{1}{D {C}^{2}} [ ( C {k}_{1}^{′ 2} + 1 ) exp ( - C {k}_{1}^{′ 2} ) - 1 ] + \frac{1}{4 {C}^{\frac{7}{2}}} \{ [ {( C {k}_{1}^{′2} )}^{\frac{5}{2}} + \frac{5}{2} {( C {k}_{1}^{′2} )}^{\frac{3}{2}} + \frac{15}{2} {( C {k}_{1}^{′2} )}^{\frac{1}{2}} ] exp ( - C {k}_{1}^{′2} ) + \frac{15}{8} \sqrt{π} ( 1 - erf ( \sqrt{- C {k}_{1}^{′ 2}} ) ) \} 〉 \qquad ( A3Q ‐ app )$$

[In Expression (A3Q-app),
μ_{NI} is the mobility [cm⁻²Vs] regarding the neutral impurity scattering determined by the approximate analytical expression of the Quisse type,
a₀ is the Bohr radius [cm], and is expressed by the following expression:

$${a}_{0} = \frac{4 {π}^{2} {ℏ}^{2} {ε}_{0} {ε}_{r}}{{m}^{*} {e}^{2}} ,$$

(in the expression,
[symbol] is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]),
C is expressed by the following expression:

$$C = \frac{{ℏ}^{2}}{2 {a}_{0}^{2} {m}^{*} {k}_{B} T} ,$$

(in the expression, [symbol] , a₀, and m* are as described above,
k_{B} is the Boltzmann constant [eV/K], and
T is the temperature [K]),
D is an empirical Q/πa₀² value (a function of qₛa₀) [cm²] at k=0 in the Quisse model.
l′₁ is an intersection point (ka₀ value) of D (upper base of the right trapezoid) and 4 (ka₀)⁻³ (hypotenuse of the right trapezoid) on the Q/πa₀³-ka₀ graph of the Quisse model,
N_{NI} is the neutral impurity scattering concentration [cm⁻³], and
[symbol] is the Dirac constant [eVs].]

In one embodiment, the parameters D and k′1 in Expression (A3Q-app) can be respectively expressed by the following expressions.

$$D = \frac{Q}{π {a}_{0}^{2}} = 356 exp [ - 6.2 {( {q}_{s} {a}_{0} )}^{0.675} ] + 0.05$$

[In the expression,
D is the empirical Q/πa₀² value at k=0 in the Quisse model,
a₀ is the Bohr radius [cm], and is expressed by the following expression:

$${a}_{0} = \frac{4 {π}^{2} {ℏ}^{2} {ε}_{0} {ε}_{r}}{{m}^{*} {e}^{2}} ,$$

(in the expression,
[symbol] is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]), and
qₛ is the above-mentioned modified Debye screening parameter [cm⁻¹], and is expressed by the following expression:

$${q}_{s} = \frac{e}{\sqrt{{k}_{B} T {ε}_{0} {ε}_{r}}} {( \frac{1}{n} + \frac{1}{\sqrt{8} {N}_{C}} )}^{- 1 / 2} ,$$

(in the expression,
“e” is the elementary charge [C],
k_{B} is the Boltzmann constant [eV/K],
T is the temperature [K],
ε₀ is the vacuum permittivity [F/cm],
εᵣ is the relative permittivity (static),
“n” is the free carrier concentration [cm⁻³] (equal to the free electron density [cm⁻³] in the oxide semiconductor treated herein), and
N_{C} is the effective density [cm⁻³] of states).]

$${k}_{1}^{′} = {( \frac{D}{4} )}^{- \frac{1}{3}}$$

[In the expression,
k′₁ is the ka₀ value at the intersection point of Q/πa₀²-D (upper base of the right trapezoid) and Q/πa₀²=4 (ka₀)⁻³ (hypotenuse of the right trapezoid) on the Q/πa₀²-ka₀ graph of the Quisse model, and
D is as described above.]

The approximate expression regarding D and the expression for expressing the hypotenuse of the right trapezoid in the Quisse model Q/πa₀²-ka₀ graph are not limited to the following:

$$D = \frac{Q}{π {a}_{0}^{2}} 356 exp [ - 6.2 {( {q}_{s} {a}_{0} )}^{0.675} ] + 0.05 ; and$$

$$Q / π {a}_{0}^{2} = 4 {( {ka}_{0} )}^{- 3} .$$

The approximate expressions may be adjusted depending on purposes.

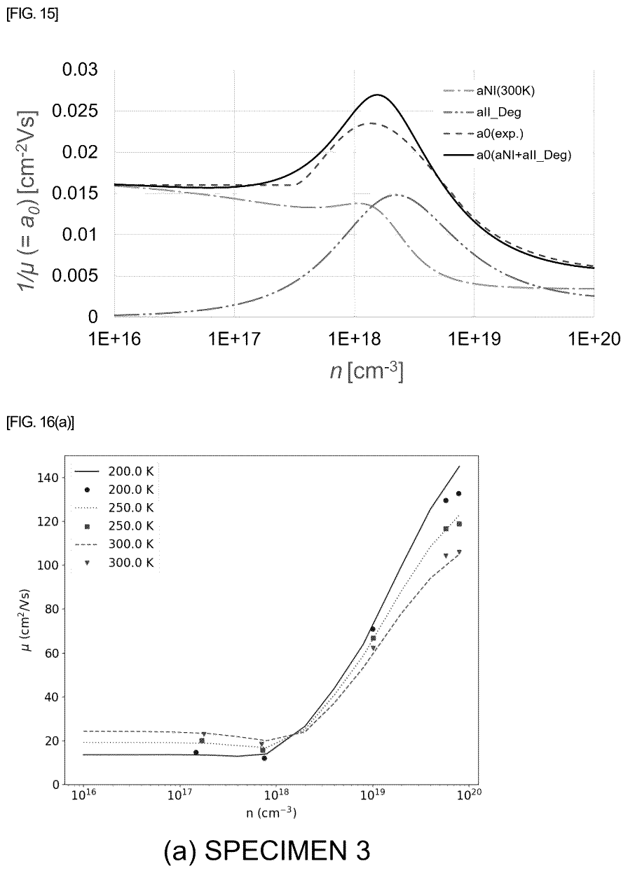

FIG. 14 is a graph in which a value (Q₀@k′=0) of Q/πa₀² at ka₀=0 for each qₛa₀ shown in FIG. 13 was acquired from the Quisse model to approximate the value D of the upper base at each qₛa₀ in FIG. 13.

In fact, it was confirmed that the results of the Quisse model and Approximate Analytical Expression (A3Q-app) show a satisfactory match. From the above description, it is now possible to express a neutral impurity scattering parameter a_{NI}(n) by the approximate analytical expression of the Quisse type.

### (6-4) Ionized Impurity Scattering (Degenerate) Model

As described above, the neutral impurity scattering was able to be modeled, but it was difficult to describe the behavior of the scattering parameter a₀(n) at carrier concentrations (3×10¹⁷ cm⁻³) or higher solely by the neutral impurity scattering. Due to a₀(n) serving as the dominant factor for a TFT mobility, it is required to survey scattering models other than those described above to elucidate the behavior over the entire carrier concentration region. As a result of an extensive survey, it was found that the ionized impurity scattering (degenerate) has a relationship of μ(T)∝T⁰ and that this had actually been widely reported as a scattering mechanism of transparent conductive films.

At this point, as an ionized impurity scattering (degenerate) mobility model, a Dingle model [R. B. Dingle, Philos. Mag. 46 831 (1955)] had generally been used, and was therefore examined in detail. Further, in regard to the screening parameter Fil, as a result of an extensive selection, it was found that use of the Pisarkiewicz type [T. Pisarkiewicz, et. al., Thin Solid Films 174 217 (1989)] is optimal, in the same manner as in the above-mentioned case of the ionized impurity scattering (non-degenerate).

In one embodiment, the mobility μ_{II}^{(Deg)}[cm²/Vs] determined by the ionized impurity scattering (degenerate) model can be expressed by a mobility model of a Dingle type.

In one embodiment, the mobility μ_{II}^{(Deg)}[cm²/Vs] determined by the ionized impurity scattering (degenerate) model can be expressed by the following Mobility Expression (A4D) of the Dingle type.

$${μ}_{II}^{( Deg )} = \frac{24 {{π}^{3} ( {ε}_{0} {ε}_{r} )}^{2} {ℏ}^{3}}{{Z}^{2} {m}^{* 2} {e}^{3} {F}_{II}} \times \frac{n}{{N}_{II \_ Deg}} \qquad ( A4D )$$

[In Expression (A4D),
ε₀ is the vacuum permittivity [F/cm],
εᵣ is the relative permittivity (static),
[symbol] is the Dirac constant [eVs],
Z is the ionic valence of the ionized impurity,
m* is the effective mass [eV/c²] (“c” is the speed [cm/s] of light) normalized by the speed of light,
F_{II} is the screening function in the ionized impurity scattering,
“n” is the free carrier concentration [cm⁻³] (equal to the free electron density [cm⁻³] in the oxide semiconductor treated herein), and
N_{II_Deg} is an ionized impurity concentration (degenerate) [cm^{-3].]}

Meanwhile, there is a concern that the ionized impurities may become neutralized as the carrier concentration increases, and hence, at a time of examining a scattering effect, it is required to discuss influences of energy positions and shapes of donor levels with the ionized impurities regarded as donors. In addition, for polycrystalline oxide semiconductor samples in this case, the carrier concentration was increased by an N₂ annealing treatment, in other words, electrons are increased together with oxygen vacancies, and hence a self-formation process of donors is also required to be taken into account. Meanwhile, in the non-degenerate region, there are a large number of ionized donors, the number of self-formed donors is also small compared to initial donors, and hence those influences can be regarded as negligible.

Through calculation incorporating the above-mentioned neutralization of donor levels and contribution of self-formed donors, it was found that, even when the donor levels are of a Gaussian type or donors (hereinafter referred to as “simple donors”) exhibit no energy level broadening, placing the donor levels 30 meV or more above a conduction band minimum (CBM) on a vacuum level side and using appropriate impurity concentrations enable reproduction of the behavior of a₀(n) in the high carrier concentration region (region at or above 1×10¹⁹ cm⁻³). In conclusion, a model in which the simple donor levels, which are easier to handle, are present at sufficiently high energy levels relative to the CBM and do not undergo neutralization, was adopted to obtain the following Expression (A₄-1)

In one embodiment, the mobility μ_{II}^{(Deg)} [cm²/Vs] determined by the ionized impurity scattering (degenerate) model is of the Dingle type, and can be further expressed by the following Mobility Expression (A4-1), which takes into account the self-formation process of donors.

$${μ}_{II}^{( Deg )} = \frac{24 {{π}^{3} ( {ε}_{0} {ε}_{r} )}^{2} {ℏ}^{3}}{{m}^{* 2} {e}^{3} {F}_{II}} \times \frac{1}{{Z}^{2} ( \frac{{N}_{II \_ Deg}}{n} + \frac{1}{Z} )} \qquad ( A4 - 1 )$$

[In Expression (A4-1),
ε₀ is the vacuum permittivity [F/cm],
εᵣ is the relative permittivity (static),
[symbol] is the Dirac constant [eVs],
m* is the effective mass [eV/c²] (“c” is the speed [cm/s] of light) normalized by the speed of light,
“e” is the elementary charge [C],
F_{II} is the screening function in the ionized impurity scattering,
Z is the ionic valence of the ionized impurity,
N_{II_Deg} is the ionized impurity concentration (degenerate) [cm⁻³], and
“n” is the free carrier concentration [cm⁻³] (equal to the free electron density [cm⁻³] in the oxide semiconductor treated herein).]

In one embodiment, the screening function Fu in Mobility Expression (A4D) or (A4-1) of the Dingle type is a screening function F_{II} in the ionized impurity scattering of the Pisarkiewicz type, which is expressed by the following Expression (F).

$${F}_{II} = [ 1 + \frac{4 {ξ}_{np}}{{ξ}_{d}} ( 1 - \frac{{ξ}_{np}}{8} ) ] ln ( 1 + {ξ}_{d} ) - \frac{{ξ}_{d}}{1 + {ξ}_{d}} - 2 {ξ}_{np} ( 1 - \frac{5 {ξ}_{np}}{16} ) \qquad ( F )$$

[In Expression (F),
ξₙₚ is an additional screening parameter in F_{II} for accommodating an effective mass change, and is expressed by the following expression:

$${ξ}_{np} = 1 - \frac{{m}_{0}^{*}}{{m}^{*}} ,$$

(in the expression,
m* is the effective mass [eV/c²] (“c” is the speed [cm/s] of light) normalized by the speed of light, and
m₀* is the minimum value of the effective mass at the bottom of the conduction band or the top of the valence band), and
ξ_{d} is the reduced screening parameter in F_{II}, and is expressed by the following expression:

$${ξ}_{d} = {( 3 {π}^{2} n )}^{1 / 3} \frac{4 {π}^{2} {ℏ}^{2} {ε}_{0} {ε}_{r}}{{m}^{*} {e}^{2}} ,$$

(in the expression,
“n” is the free carrier concentration [cm⁻³] (equal to the free electron density [cm⁻³] in the oxide semiconductor treated herein),
[symbol] is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]).]
   (6-5) Verification of Scattering Model having T⁰ Dependence

Next, in regard to a scattering model having the T⁰ dependence, it was confirmed whether or not the behavior of the scattering parameter a₀(n) of FIG. 12(d) can be described by the approximate analytical expression of the neutral impurity scattering Quisse model and the ionized impurity scattering (degenerate) Dingle model adapted to polycrystalline oxide semiconductor systems, which have been acquired so far.

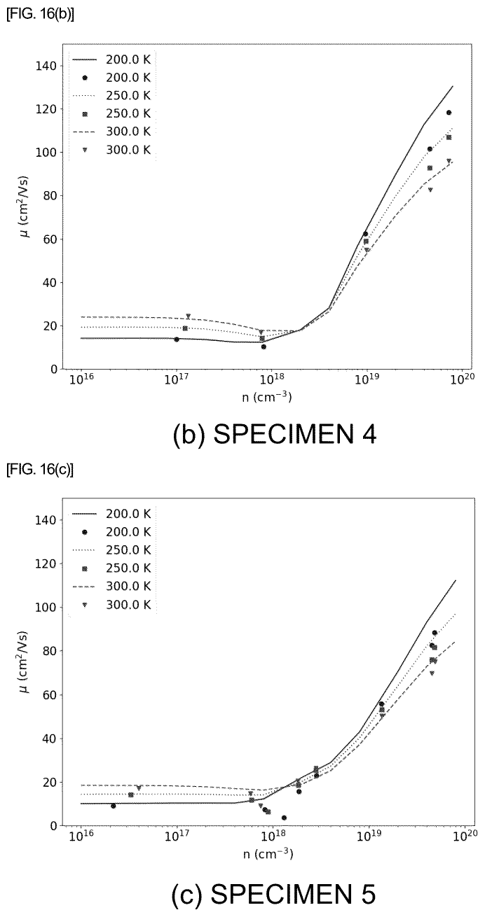

Specifically, FIG. 15 shows results of inputting parameters into each of Expression (A3Q-app) (approximate analytical expression of the neutral impurity scattering Quisse model) and Expression (A4-S) obtained by introducing the following sigmoid function into Expression (A4-1) (the ionized impurity scattering (degenerate) Dingle model).

As shown in FIG. 15, Expression (A3Q-app) and Expression (A4-S) obtained by introducing Expression (A4-1) well reproduce the experimental results. In this case, it is required to be noted that a slight temperature dependence is observed for Expression (A3Q-app). Further, the sigmoid function is introduced into Expression (A4-S) (sigmoid “a” parameter is set to 2 in FIG. 15) in order to express a transition from degenerate to non-degenerate with the effective density Nc of states (2×10¹⁸ cm⁻³ in this system) set as a boundary. In any case, it is possible to describe the behavior of a₀(n) by adjusting the parameters in FIG. 15, and it was verified that Expression (A3Q-app) and Expression (A4-S) obtained by introducing Expression (A4-1) are actually applicable.

In one embodiment, assuming that a mobility expression of the Dingle type expressed by Expression (A4D) or (A4-1) is μ_{II_Dingle}^{(Deg)} [cm²/s], the mobility μ_{II}^{(Deg)} [cm²/s] determined by the ionized impurity scattering (degenerate) model can be expressed by the following Expression (A4-S) of a sigmoid function type with respect to the carrier concentration “n”:

$${μ}_{II}^{( Deg )} = \frac{{μ}_{II \_ Dingle}^{( Deg )}}{1 + {( \frac{{N}_{C}}{n} )}^{+ a}} , \qquad ( A4 - S )$$

[in Expression (A4-S),
N_{C} is the effective density [cm⁻³] of states,
“n” is the free carrier concentration [cm⁻³] (equal to the free electron density [cm⁻³] in the oxide semiconductor treated herein), and
“a” is the parameter representing the rate of change of the sigmoid function.]

In this case, the neutral impurity scattering expressed by Expressions (AE3), (Q-1), and (A3Q-app) and the ionized impurity scattering (degenerate) (scattering model having the T⁰ dependence) expressed by Expressions (A4) and (A4-1) correspond to the term a₂T₀ in Expression (1).

4. Modeling of in-Grain Mobility μ_{in-Grain}(T)

Through use of the model expressions obtained in the above-mentioned section “3. Physical Modeling of Various Scattering Parameters,” it is possible to construct a model for calculating the in-grain mobility μ_{in-grain}(T).

In one embodiment, the reciprocal of the in-grain mobility μ_{in-grain}(T) of the semiconductor is expressed as the linear combination of two or more terms selected from the group consisting of 1/(exp(β/T)−1), T⁰, T^{-3/2}, T^{1/2}, T^{3/2}, T¹, and T², and further, a 1/μ_{NI}(T, n) term, of which the temperature dependence is a function of the carrier concentration “n”, is linearly combined.

In one embodiment, the 1/μ_{NI}(T, n) term is expressed by the following Expressions (Q-1) to (Q-26) determined by the mobility model of the Quisse type.

$${μ}_{NI} = \frac{q}{3 ℏ {N}_{NI}} \sqrt{\frac{2}{π}} {( \frac{{ℏ}^{2}}{{m}^{*} {k}_{B} T} )}^{\frac{5}{2}} {\int }_{0}^{∞} \frac{{k}^{3}}{Q} exp ( - \frac{{ℏ}^{2} {k}^{2}}{2 {m}^{*} {k}_{B} T} ) dk \qquad ( Q - 1 )$$

$$Q = \frac{4 π}{{k}^{2}} \frac{{( \overline{α} - \overline{L} / k )}^{2}}{1 + {( \overline{α} - \overline{L} / k )}^{2}} \qquad ( Q - 2 )$$

$$\overline{L} = L ( \overline{α} , \overline{β} ) \qquad ( Q - 3 )$$

$$L = - ( {α}^{2} {F}_{1} - {β}^{2} {F}_{2} + α {F}_{3} + β {F}_{4} + αβ {F}_{5} + {F}_{6} ) , \qquad ( Q - 4 )$$

$$\overline{α} = \frac{{F}_{4} {F}_{5} - 2 {F}_{2} {F}_{3} - 2 {kF}_{2}}{4 {F}_{1} {F}_{2} - {F}_{5}^{2}} , \qquad ( Q - 5 )$$

$$\overline{β} = \frac{{F}_{3} {F}_{5} - 2 {F}_{1} {F}_{3} - {kF}_{5}}{4 {F}_{1} {F}_{2} - {F}_{5}^{2}} , \qquad ( Q - 6 )$$

$${F}_{1} = 2 γ {H}_{31} ( {q}_{s} ) + 2 δ {H}_{31} ( 2 a ) - kI ( a ) + kI ( 2 a ) - J ( 2 a ) + 2 ζ ( J ( 4 a ) - 2 J ( 3 a ) + J ( 2 a ) ) , \qquad ( Q - 7 )$$

$${F}_{2} = 2 γ {H}_{33} ( {q}_{s} ) + 2 δ {H}_{33} ( 2 a ) + kI ( 2 a ) - 3 kI ( 3 a ) + 2 kI ( 4 a ) + J ( 2 a ) - 5 J ( 3 a ) + 4 J ( 4 a ) + 2 ζ ( J ( 4 a ) + J ( 6 a ) - 2 J ( 5 a ) ) , \qquad ( Q - 8 )$$

$${F}_{3} = 2 γ ( M ( {q}_{s} , 0 ) - M ( {q}_{s} , a ) ) + 2 δ ( M ( 2 a , 0 ) … M ( 2 a , a ) ) - \frac{1}{2} I ( a ) - 2 kK ( a ) + 2 ζ ( I ( 2 a ) - I ( 3 a ) ) , \qquad ( Q - 9 )$$

$${F}_{3} = 2 γ ( M ( {q}_{s} , a ) - M ( {q}_{s} , 2 a ) ) + 2 δ ( M ( 2 a , a ) - M ( 2 a , 2 a ) ) + \frac{1}{2} I ( a ) - 2 I ( 2 a ) + 2 kK ( a ) - 4 kK ( 2 a ) + 2 ζ ( - I ( 4 a ) + I ( 3 a ) ) , \qquad ( Q - 10 )$$

$${F}_{5} = 4 γ {H}_{32} ( {q}_{s} ) + 4 δ {H}_{32} ( 2 a ) + kI ( a ) - 4 kI ( 2 a ) + 3 kI ( 3 a ) + J ( a ) - 6 J ( 2 a ) + 5 J ( 3 a ) + 2 ζ ( - 4 J ( 4 a ) + 2 J ( 5 a ) + 2 J ( 3 a ) ) , \qquad ( Q - 11 )$$

$${F}_{6} = 2 ( γ {H}_{1} ( {q}_{s} ) + δ {H}_{1} ( 2 a ) + ζ K ( 2 a ) ) , \qquad ( Q - 12 )$$

$${H}_{31} ( x , a ) = {\int }_{0}^{∞} \frac{{e}^{- x r}}{r} {( 1 - {e}^{- xr} )}^{2} {cos}^{2} k r dr = \frac{1}{4} ln ( \frac{{( x + a )}^{4} {( {( x + a )}^{2} + 4 {k}^{2} )}^{2}}{{x}^{2} ( {x}^{2} + 4 {k}^{2} ) {( x + 2 a )}^{2} ( {( x + 2 a )}^{2} + 4 {k}^{2} )} ) , \qquad ( Q - 13 )$$

$${H}_{32} ( x , a ) = {\int }_{0}^{∞} \frac{{e}^{- x r + xr}}{r} {( 1 - {e}^{- xr} )}^{2} {cos}^{2} kr dr = \frac{1}{4} ln ( \frac{{( x + 2 a )}^{4} {( {( x + 2 a )}^{2} + 4 {k}^{2} )}^{2}}{{( x + a )}^{2} ( {( x + a )}^{2} + 4 {k}^{2} ) {( x + 3 a )}^{2} ( {( x - 3 a )}^{2} + 4 {k}^{2} )} ) , \qquad ( Q - 14 )$$

$${H}_{33} ( x , a ) = {\int }_{0}^{∞} \frac{{e}^{- x r + 2 xr}}{r} {( 1 - {e}^{- xr} )}^{2} {cos}^{2} kr dr = \frac{1}{4} ln ( \frac{{( x + 3 a )}^{4} {( {( x + 3 a )}^{2} + 4 {k}^{2} )}^{2}}{{( x + 2 a )}^{2} ( {( x + 2 a )}^{2} + 4 {k}^{2} ) {( x + 4 a )}^{2} ( {( x + 4 a )}^{2} + 4 {k}^{2} )} ) , \qquad ( Q - 15 )$$

$${H}_{1} ( x ) = {\int }_{0}^{∞} \frac{{e}^{- x r}}{r} {sin}^{2} kr dr = \frac{1}{4} ln ( \frac{{x}^{2} + 4 {k}^{2}}{{x}^{2}} ) , \qquad ( Q - 16 )$$

$$I ( x ) = {\int }_{0}^{∞} {e}^{- x r} sin 2 kr dr = \frac{2 k}{{x}^{2} + 4 {k}^{2}} , \qquad ( Q - 17 )$$

$$J ( x ) = {\int }_{0}^{∞} {e}^{- x r} cos kr dr = \frac{1}{{x}^{2} + 4 {k}^{2}} ( x + \frac{2 {k}^{2}}{x} ) , \qquad ( Q - 18 )$$

$$K ( x ) = {\int }_{0}^{∞} {e}^{- xr} {sin}^{2} kr dr = \frac{1}{x} - J ( x ) , \qquad ( Q - 19 )$$

$$M ( x , y ) = {\int }_{0}^{∞} \frac{{e}^{- x r + sr}}{r} sin 2 kr dr = arctan ( \frac{2 k}{x - y} ) \qquad ( Q - 20 )$$

$$γ = \frac{{q}_{s}^{2} ( {q}_{s}^{2} - 8 {a}^{2} )}{{( {q}_{s}^{2} - 4 {a}^{2} )}^{2}} , \qquad ( Q - 21 )$$

$$δ = \frac{16 {a}^{4}}{{( {q}_{s}^{2} - 4 {a}^{2} )}^{2}} , \qquad ( Q - 22 )$$

$$ζ = \frac{4 {a}^{3}}{4 {a}^{2} - {q}_{s}^{2}} , \qquad ( Q - 23 )$$

$$\frac{1}{a} = {a}_{0} \frac{1 + ( 8 / 5 ) {( {a}_{0} {q}_{s} / 4 )}^{5 / 2}}{1 + {( {a}_{0} {q}_{s} / 4 )}^{5 / 2}} , \qquad ( Q - 24 )$$

$${a}_{0} = \frac{4 π {ε}_{r} {ε}_{0} {ℏ}^{2}}{{m}^{*} {q}^{2}} \qquad ( Q - 25 )$$

$${q}_{s} = \sqrt{\frac{{q}^{2} n}{{ε}_{r} {ε}_{0} kBT}} \qquad ( Q - 26 )$$

[In Expressions (Q-1) to (Q-26),
μ_{NI} is the Quisse model mobility [cm²/Vs],
N_{NI} is the neutral impurity concentration [cm⁻³],
“k” is the wave number vector [cm⁻¹],
“q” is the elementary charge [C],
[symbol] is the Dirac constant [eVs],
m* is the effective mass [eV/c²] (“c” is the speed [cm/s] of light) normalized by the speed of light,
k_{B} is the Boltzmann constant [eV/K],
T is the temperature [K],
Q is the total scattering cross section [cm²],
L is the trial wave function,
L̅ is the minimum value of the trial wave function,
α is the phase parameter,
α̅ is the phase parameter at the minimum value L̅ of the trial wave function,
β is the variational parameter,
β̅ is the variational parameter at the minimum value L̅ of the trial wave function,
F₁ to F₆ are components of the respective terms that form the trial wave function L,
H₃₁(x, a) is the constituent component of F₁,
H₃₂(x, a) is the constituent component of F₅,
H₃₃(x, a) is the constituent component of F₂,
H₁(x) is the constituent component of F₆,
I(x) is the constituent component of each of F₁ to F₅,
J(x) is the constituent component of each of F₁, F₂ and F₅,
K(x) is the constituent component of each of F₃, F₄, and F₆,
M(x, y) is the constituent component of each of F₃ and F₄,
   “x” and “y” are variables,
   “a” is the reciprocal of the effective Bohr radius,
γ is the constituent component of each of F₁ to F₆,
δ is the constituent component of each of F₁ to F₆,
ζ is the constituent component of each of F₁ to F₆,
a₀ is the Bohr radius [cm],
qₛ is the Debye screening parameter [cm⁻¹],
εᵣ is the relative permittivity (static), and
ε₀ is the vacuum permittivity [F/cm].]

In one embodiment, the Debye screening parameter qₛ is selected from the group consisting of the following Expressions (Qq-1) to (Qq-5).

$${q}_{s} = \frac{q}{\sqrt{{ε}_{r} {ε}_{0} {k}_{B} T}} {( \frac{1}{n} )}^{- 1 / 2} \qquad ( Qq - 1 )$$

$${q}_{s} = \frac{q}{\sqrt{{ε}_{r} {ε}_{0} {k}_{B} T}} {( \frac{1}{n} + \frac{1}{\sqrt{8} Nc} )}^{- 1 / 2} \qquad ( Qq - 2 )$$

$${q}_{s} = \frac{q}{\sqrt{{ε}_{r} {ε}_{0} {k}_{B} T}} {( \frac{1}{n} + \frac{1}{\sqrt{8} Nc} + ( \frac{3}{16} - \frac{\sqrt{3}}{9} ) \frac{2}{{Nc}^{2}} n )}^{- 1 / 2} \qquad ( Qq - 3 )$$

$${q}_{s} = \frac{q}{\sqrt{{ε}_{r} {ε}_{0} {k}_{B} T}} {( \frac{1}{n} + \frac{1}{\sqrt{8} Nc} + ( \frac{3}{16} - \frac{\sqrt{3}}{9} ) \frac{2}{{Nc}^{2}} n + 1.48386 \times 1 {0}^{- 4} \times \frac{3}{{Nc}^{3}} {n}^{2} )}^{- 1 / 2} \qquad ( Qq - 4 )$$

$${q}_{s} = \frac{q}{\sqrt{{ε}_{r} {ε}_{0} {k}_{B} T}} {( \begin{matrix}\frac{1}{n} + \frac{1}{\sqrt{8} Nc} + ( \frac{3}{16} - \frac{\sqrt{3}}{9} ) \frac{2}{{Nc}^{2}} n + \\ 1.48386 \times 1 {0}^{- 4} \times \frac{3}{{Nc}^{3}} {n}^{2} - 4.42563 \times 1 {0}^{- 6} \times \frac{4}{{Nc}^{4}} {n}^{3}\end{matrix} )}^{- 1 / 2} \qquad ( Qq - 5 )$$

[In Expressions (Qq-1) to (Qq-5),
ε₀ is the vacuum permittivity [F/cm],
εᵣ is the relative permittivity (static),
k_{B} is the Boltzmann constant [eV/K],
T is the temperature [K],
“n” is the free carrier concentration [cm⁻³] (equal to the free electron density [cm⁻³] in the oxide semiconductor treated herein), and
N_{C} is the effective density [cm⁻³] of states.]

In one embodiment, the 1/μ_{NI}(T, n) term is expressed by the following Approximate Expression (A5Q-app) determined by the mobility model of the Quisse type.

$${μ}_{NI} ( T , n ) = \frac{e}{3 ℏ {N}_{NI}} \sqrt{\frac{2}{π}} \frac{{( 2 {a}_{0}^{2} C )}^{\frac{5}{2}}}{2 π {a}_{0}^{6}} 〈 - \frac{1}{{DC}^{2}} [ ( C {k}_{1}^{{′}^{2}} + 1 ) exp ( - C {k}_{1}^{{′}^{2}} ) - 1 ] + \frac{1}{4 {C}^{\frac{7}{2}}} \{ [ {( {Ck}_{1}^{{′}^{2}} )}^{\frac{5}{2}} + \frac{5}{2} {( {Ck}_{1}^{{′}^{2}} )}^{\frac{3}{2}} + \frac{15}{2} {( {Ck}_{1}^{{′}^{2}} )}^{\frac{1}{2}} ] exp ( - {Ck}_{1}^{{′}^{2}} ) + \frac{15}{8} \sqrt{π} ( 1 - erf ( \sqrt{- {Ck}_{1}^{{′}^{2}}} ) ) \} 〉 \qquad ( A 5 Q - app )$$

[In Expression (A5Q-app),
μ_{NI}(T, n) is a mobility [cm²/s] regarding the neutral impurity scattering determined by the approximate analytical expression of the Quisse type, and (T, n) means that UNI is a function of the temperature T and the free carrier concentration “n”,
a₀ is the Bohr radius [cm], and is expressed by the following expression:

$${a}_{0} = \frac{4 {π}^{2} {ℏ}^{2} {ε}_{0} {ε}_{r}}{{m}^{*} {e}^{2}} ,$$

(in the expression,
[symbol] is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]),
C is expressed by the following expression:

$$C = \frac{{ℏ}^{2}}{2 {a}_{0}^{2} {m}^{*} {k}_{B} T} ,$$

(in the expression, [symbol] , a₀, and m′ are as described above,
k_{B} is the Boltzmann constant [eV/K], and
T is the temperature [K]),
D is the empirical Q/πa₀² value (the function of qₛa₀) [cm²] at k=0 in the Quisse model,
k′₁ is the ka₀ value at the intersection point of Q/πa₀²=D (upper base of the right trapezoid) and Q/πa₀²=4 (ka₀)⁻³ (hypotenuse of the right trapezoid) on the Q/πa₀²-ka₀ graph of the Quisse model,
N_{NI} is the neutral impurity scattering concentration [cm⁻³], and
[symbol] is the Dirac constant [eVs].]

In one embodiment, the effective mass m′ can be expressed by any one of the following Expression (M-1) or (M-2):

$${m}^{*} = {m}_{0}^{*} ( 1 + 2 {α}^{′} E ) \qquad ( M - 1 )$$

$${m}^{*} = {m}_{0}^{*} {\{ 1 + 2 {α}^{′} \frac{{{ℏ}^{2} ( 3 {π}^{2} n )}^{\frac{2}{3}}}{{m}_{0}^{*}} \}}^{\frac{1}{2}} , \qquad ( M - 2 )$$

[in Expressions (M-1) and (M-2),
m* is the effective mass [eV/c²] (“c” is the speed of light [cm/s]) normalized by the speed of light,
m₀* is the minimum value [eV/c²] of the effective mass at the bottom of the conduction band or the top of the valence band (“c” is the speed [cm/s] of light),
α′ is a non-parabolicity coefficient regarding a band curvature of the conduction band or valence electrons (where α′>0 is satisfied; an E-k band in a wave number “k” space is parabolic when α′=0 is satisfied, and becomes non-parabolic and expands when a′ increases),
E is energy [eV],
“n” is the free carrier concentration [cm⁻³] (equal to the free electron density [cm⁻³] in the oxide semiconductor treated herein), and
[symbol] is the Dirac constant [eVs].]

In one embodiment, the parameters D and k′₁ in Expression (A5Q-app) can be respectively expressed by the following expressions.

$$D = \frac{Q}{π {a}_{0}^{2}} = 356 exp [ - 6.2 {( {q}_{s} {a}_{0} )}^{0.675} ] + 0.05$$

[In the expression,
D is the empirical Q/πa₀² value at k=0 in the Quisse model,
a₀ is the Bohr radius [cm], and is expressed by the following expression:

$${a}_{0} = \frac{4 {π}^{2} {ℏ}^{2} {ε}_{0} {ε}_{r}}{{m}^{*} {e}^{2}} ,$$

(in the expression,
[symbol] is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]), and
qₛ is the above-mentioned modified Debye screening parameter [cm⁻¹], and is expressed by the following expression:

$${q}_{s} = \frac{e}{\sqrt{{k}_{B} T {ε}_{0} {ε}_{r}}} {( \frac{1}{n} + \frac{1}{\sqrt{8} {N}_{C}} )}^{- 1 / 2} .$$

(In the expression,
“e” is the elementary charge [C],
k_{B} is the Boltzmann constant [eV/K],
T is the temperature [K],
ε₀ is the vacuum permittivity [F/cm],
εᵣ is the relative permittivity (static),
“n” is the free carrier concentration [cm⁻³] (equal to the free electron density [cm⁻³] in the oxide semiconductor treated herein), and
N_{C} is the effective density [cm⁻³] of states.)]

$${k}_{1}^{′} = {( \frac{D}{4} )}^{- \frac{1}{3}}$$

[In the expression,
k′₁ is the ka₀ value at the intersection point of Q/πa₀²=D (upper base of the right trapezoid) and Q/πa₀²=4 (ka₀)⁻³ (hypotenuse of the right trapezoid) on the Q/πa₀²-ka₀ graph of the Quisse model, and
D is as described above.]

The approximate expression regarding D and the expression for expressing the hypotenuse of the right trapezoid in the Quisse model Q/πa₀²-ka₀ graph are not limited to the following:

$$D = \frac{Q}{π {a}_{0}^{2}} = 356 exp [ - 6.2 {( {q}_{s} {a}_{0} )}^{0.675} ] + 0.05 ;$$

$$and$$

$$Q / π {a}_{0}^{2} = 4 {( {ka}_{0} )}^{- 3}$$

The approximate expressions may be adjusted depending on purposes.

In one embodiment, as the reciprocal of the in-grain mobility μ_{in-grain}(T) of the semiconductor in the following Expression (1-1), two or more terms selected from the group consisting of 1/(exp(β/T)−1), T⁰, T^{-3/2}, T^{1/2}, and T^{3/2}, and the 1/μ_{NI}(T, n) term, of which the temperature dependence is a function of the carrier concentration “n”, are used.

$$\frac{1}{{μ}_{in - grain} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} + 1 / {μ}_{NI} ( T , n ) \qquad ( 1 - 1 )$$

[In Expression (1-1),
μ_{in-grain} represents the in-grain mobility [cm²/Vs] of the semiconductor,
T represents the temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and as [cm⁻²Vs·K^{3/2}] each represent a coefficient.
provided that, in Expression (1-1), the coefficients a₁ to a₅ of unselected terms among the 1/(exp(β/T)−1), the T⁰, the T^{-3/2}, the T^{1/2}, and the T^{3/2} are set to 0.]

In one embodiment, the a₂T₀ term in Expression (1-1) can be expressed by the neutral impurity scattering model.

In one embodiment, the a₂T₀ term in Expression (1-1) can be expressed by the ionized impurity scattering (degenerate) model.

In one embodiment, in Expression (1-1), the a₂T₀ term can be expressed by any one of the ionized impurity scattering (degenerate) models, and the 1/μ_{NI}(T, n) term can be expressed by any one of the neutral impurity scattering models.

In one embodiment, the reciprocal of the in-grain mobility μ_{in-grain}(T) of the semiconductor expressed by Expression (1) can be expressed by the following Expression (A1-1):

$$\frac{1}{{μ}_{in - grain} ( T )} = \frac{1}{{μ}_{OP}} + \frac{1}{{μ}_{NI}} + \frac{1}{{μ}_{II}^{( Deg )}} + \frac{1}{{μ}_{II}^{( nonDeg )}} , \qquad ( A1 - 1 )$$

[in Expression (A1-1),
μ_{OP} is as defined in Expression (A2) or (A2-2),
μ_{NI} is as defined in Expression (A3E), (Q-1), or (A3Q-app),
μ_{II}^{(Deg)} is as defined in Expression (A4), (A4-1), or (A4-S), and μ_{II}^{(nonDeg)} is as defined in Expression (A5-CVV), (A5-BH), or (A5-S).]

In one embodiment, Expression (1-1) can be expressed by the following Expression (A1-2):

$$\frac{1}{{μ}_{in - grain} ( T )} = \frac{1}{{μ}_{OP}} + \frac{1}{{μ}_{II}^{( Deg )}} + \frac{1}{{μ}_{II}^{( nonDeg )}} + 1 / {μ}_{NI} ( T , n ) , \qquad ( A1 - 2 )$$

[in Expression (A1-2),
μ_{OP} is as defined in Expression (A2) or (A2-2),
μ_{II}^{(Deg)} is as defined in Expression (A4D), (A4-1), or (A4-S),
μ_{II}^{(nonDeg)} is as defined in Expression (A5-CW), (A5-BH), or (A5-S), and
μ_{NI}(T, n) is as defined in Expression (A3E), (Q-1), or (A3Q-app).]

In one embodiment, in Expression (A1-2), μ_{OP} is expressed by Expression (A2-2), μ_{II}^{(Deg)} is expressed by Expression (A4-1) or (A4-S), μ_{II}^{(nonDeg)} is expressed by Expression (A5-BH) or (A5-S), and μ_{NI}(T, n) is expressed by Expression (A3E), (Q-1), or (A5Q-app).

In one embodiment, the mobility μ_{II}^{(Deg)} determined by the ionized impurity scattering (degenerate) model expressed by Expression (A4D) or (A4-1) and the mobility μ_{II}^{(nonDeg)} determined by the ionized impurity scattering (non-degenerate) model expressed by Expression (A5-CW) or (A5-BH) are linearly combined with respect to the carrier concentration “n” through the sigmoid function having the effective density Nc of states as a boundary, and each screening function F_{II} is F_{II} of the Pisarkiewicz type, which is expressed by Expression (F).

### 5. Modeling of Macro DC Mobility μ(T)

Through use of the in-grain mobility μ_{in-grain}(T) of the semiconductor obtained by Expression (1), (1-1), (A1-1), or (A1-2), it is possible to calculate the macro DC mobility μ(T) of the semiconductor expressed by the following Expression (A10).

In one embodiment, the macro DC mobility μ(T) of the semiconductor can be calculated by the following Expression (A10).

This embodiment represents a case in which the coefficient θ [K²] in Expression (10) is 0.

$$μ ( T ) = [ exp ( - \frac{{qV}_{B}}{{k}_{B} T} ) ] {μ}_{in - grain} ( T ) \qquad ( A10 )$$

[In Expression (A10),
q is the elementary charge [C],
V_{B} is the grain boundary barrier height [eV],
k is the wave number vector [cm^{1],}
T is the temperature [K], and
μ_{in-grain}(T) is the in-grain mobility [cm²/Vs] of the semiconductor obtained by the calculation method for an in-grain mobility μ_{in-grain}(T) of a semiconductor.]

In one embodiment, V_{B} in Expression (10A) is expressed by the following Expression (A11):

$${V}_{B} = {δ}_{{E}_{F}} [ 1 + \frac{α}{2 {δ}_{{E}_{F}}} - {( \frac{α}{{δ}_{{E}_{F}}} + \frac{{α}^{2}}{4 {δ}_{{E}_{F}}^{2}} )}^{1 / 2} ] , \qquad ( A11 )$$

[in Expression (A11),
α is expressed by the following expression:

$$α = \frac{8 {ε}_{0} {ε}_{r} n}{{e}^{2} {N}_{T}^{2}} ,$$

(in the expression,
ε₀ is the vacuum permittivity [F/cm],
εᵣ is the relative permittivity (static),
“n” is the free carrier concentration [cm⁻³] (equal to the free electron density [cm⁻³] in the oxide semiconductor treated herein),
“e” is the elementary charge [C], and
N_{T} is a grain boundary trap density [cm² eV⁻¹]), and
δ_{EF} is a Fermi energy difference [eV] between the grain boundary and the grain interior, and is expressed by the following expression:

$${δ}_{{E}_{F}} = {E}_{F}^{GB} - {E}_{F}^{G} ,$$

(in the expression,
E_{F}^{GB} is the Fermi energy [eV] in the grain boundary, and
E_{F}^{G} is the Fermi energy [eV] in the grain interior.),
where V_{B}≥0 is satisfied.]

In one embodiment, the reciprocal of the mobility μ_{in-grain}(T) in Expression (A10) can be expressed by any one of Expression (1-1), (A1-1), or (A1-2).

Herein, “q” (elementary charge of 1.602×10⁻¹⁹ [C]) is the same as the “e” (elementary charge [C]).

The in-grain mobility μ_{in-grain}(T) of the semiconductor calculated by Expression (A-1) and the macro DC mobility μ(T) of the semiconductor calculated by Expression (A10) satisfactorily match actually measured values of measurement samples, as is demonstrated in Examples, which are described later.

### 6. Device Simulation Method

A device simulation method of obtaining a macro DC mobility μ(T) of a semiconductor according to one aspect of the present invention is characterized by including a step of using the above-mentioned calculation method for a macro DC mobility μ(T) of a semiconductor according to one aspect of the present invention.

Through use of the device simulation method according to this aspect, it is possible to perform device design with high reliability before a semiconductor device is actually produced.

### (Simulation Service)

Through use of the device simulation method according to this aspect, it is possible to provide a simulation service in which input of required physical property values is received from a customer to present simulation results to the customer.

### 7. Manufacturing Method for Thin Film Transistor

A manufacturing method for a thin film transistor according to one aspect of the present invention is characterized by including the steps of:
calculating a macro DC mobility μ(T) of a semiconductor through use of the above-mentioned calculation method for a macro DC mobility μ(T) of a semiconductor according to one aspect of the present invention; and
manufacturing the thin film transistor based on the calculated macro DC mobility μ(T) of the semiconductor.

Further, a manufacturing method for a thin film transistor according to one aspect of the present invention is characterized by including the steps of:
calculating a macro DC mobility μ(T) of a semiconductor through use of the above-mentioned device simulation method according to one aspect of the present invention; and
performing device design based on the calculated macro DC mobility μ(T) of the semiconductor.

When the above-mentioned device simulation method or calculation method for a macro DC mobility μ(T) of a semiconductor according to one aspect of the present invention is used to calculate the macro DC mobility μ(T) of the semiconductor, it is possible to efficiently manufacture a thin film transistor having a desired mobility.

### 8. Electronic Apparatus

An electronic apparatus according to one aspect of the present invention is characterized by including a thin film transistor manufactured through use of the above-mentioned manufacturing method for a thin film transistor according to one aspect of the present invention.

### 9. Calculation Program for Macro DC Mobility μ(T) of Semiconductor

A program for calculating a macro DC mobility μ(T) of a semiconductor (hereinafter sometimes abbreviated as “calculation program for a macro DC mobility”) according to one aspect of the present invention is characterized by using the following Expressions (1) and (10):

$$\frac{1}{{μ}_{in - grain} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} , \qquad ( 1 )$$

[in Expression (1),
μ_{in-grain} represents the in-grain mobility [cm²/s] of the semiconductor, T represents the temperature [K], and
β [K], a₁ [cm⁻²Vs], a₂ [cm⁻²Vs], a₃ [cm⁻²Vs·K³²], a₄ [cm⁻²Vs·K^{-1/2}], and as [cm⁻²Vs·K^{-3/2}] each represent a coefficient,
provided that, in Expression (1), two or more terms selected from the group consisting of 1/(exp(β/T)−1), T⁰, T^{-3/2}, T^{1/2}, and T^{3/2} are used, and the coefficients a₁ to a₅ of unselected terms are set to 0]; and

$$μ ( T ) = exp ( - γ / T ) exp ( - θ / {T}^{2} ) {μ}_{in - grain} ( T ) , \qquad ( 10 )$$

[in Expression (10),
μ is the mobility [cm²/Vs] of the semiconductor,
T is the temperature [K],
γ [K] and θ [K²] are coefficients and positive numbers including 0, and
μ_{in-grain}(T) is the in-grain mobility [cm²/Vs] of the semiconductor obtained by the above-mentioned calculation method for an in-grain mobility μ_{in-grain}(T) of a semiconductor according to one aspect of the present invention],
to cause a computer to function as:
means for receiving input of the temperature T [K] and the carrier concentration “n” [cm⁻³];
means for receiving input of the type of the material of the semiconductor,
means for selecting values of the coefficients a₁ to a₅, β, γ, and θ; and
means for calculating the macro DC mobility μ(T) of the semiconductor by Expressions (1) and (10).

Details of the coefficients and the like in Expression (1) are as described in the above-mentioned calculation method for an in-grain mobility according to one aspect of the present invention, details of the coefficients and the like in Expression (10) are as described in the above-mentioned calculation method for a macro DC mobility according to one aspect of the present invention, and hence further description is omitted here.

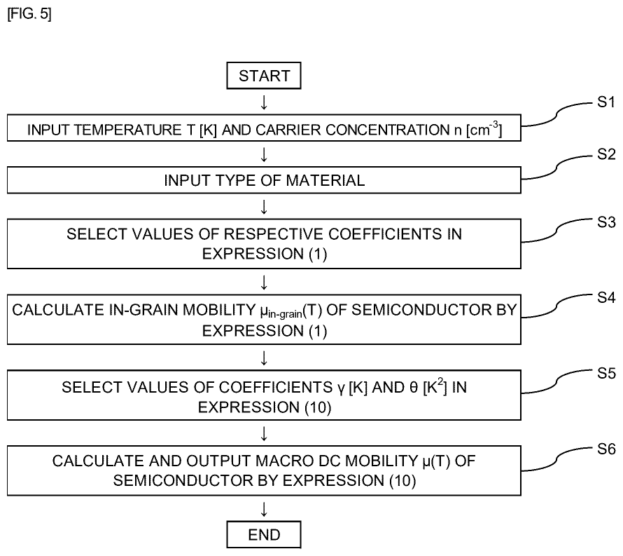

The calculation program for a macro DC mobility according to one embodiment is described with reference to FIG. 5.

FIG. 5 is a flow chart for illustrating an operating procedure of one Example of the present invention. First, in Step S1, the temperature T [K] and the carrier concentration “n” [cm⁻³] are input to the computer.

Subsequently, in Step S2, a type of a semiconductor material is input to the computer. The type of the semiconductor material input here is selected from a database. The database used here is built by inputting actually measured values corresponding to types of each semiconductor material and performing calculation to accumulate data.

The types of each material to be selected include, for example, a semiconductor composition, a crystalline state (amorphous, single crystal, polycrystalline, or the like), and a crystal structure (a space group, a lattice constant, and atomic coordinates).

In Step S3, the computer selects the values of respective coefficients in Expression (1) based on pieces of data input in Step S1 and Step S2. In this case, the coefficients in Expression (1) mean all the coefficients in Expressions (1) to (5) and (5-1) to (5-3). Specifically, those are the values of the coefficients a₁ to a₅, β, γ, and θ.

In Step S4, the computer calculates the in-grain mobility μ_{in-grain}(T) of the semiconductor by substituting the values of the respective coefficients selected in Step S3 into Expression (1).

In Step S5, the computer selects the values of the coefficients γ [K] and θ [K] in Expression (10) based on the type of the material input in Step S2.

Finally, in Step S6, the computer calculates the macro DC mobility μ(T) of the semiconductor by substituting the values of the coefficients selected in Step S5 into Expression (10), and outputs a result thereof, thereby ending the flow.

In one embodiment, a program for causing the computer to function as means for calculating the macro DC mobility μ(T) of the semiconductor is a program for calculating a macro DC mobility μ(T) of a semiconductor through use of Expression (1-1), (A1-1), or (A1-2), and Expression (A10),
the program being for causing the computer to function as:
the means for receiving the input of the temperature T [K] and the carrier concentration “n” [cm⁻³],
the means for receiving the input of the type of material of the semiconductor,
the means for selecting the values of the coefficients a₁ to a₅, β, γ, and θ, and
means for calculating the macro DC mobility μ(T) of the semiconductor by Expression (1-1), (A1-1), or (A1-2), and Expression (A10).

### 10. Derivation Program for Macro DC Mobility μ(T, n) of Semiconductor

A program (hereinafter sometimes abbreviated as “derivation program”) for deriving a macro DC mobility μ(T, n) [cm²/Vs] of the semiconductor dependent on the temperature T [K] and the carrier concentration “n” [cm⁻³] according to one aspect of the present invention is characterized by causing the computer to function as:
means for receiving data input of the μ(T, n) for the T and “n” actually measured from a semiconductor film;
means for receiving input of type of a semiconductor material from which initial values of respective coefficients in Expression (1) are to be acquired;
means for receiving selection of the values of the coefficients a₁ to a₅, β, γ, and θ; and
means for deriving the macro DC mobility μ(T, n) by performing regression through use of the above-mentioned program for calculating a macro DC mobility μ(T) of a semiconductor according to one aspect of the present invention.

In one embodiment, a program for deriving a macro DC mobility μ(T, n) [cm²/Vs] of a semiconductor dependent on the temperature T [K] and the carrier concentration “n” [cm⁻³] causes the computer to function as:
means for receiving data input of the μ(T, n) for the T and “n” actually measured from a semiconductor film;
means for receiving input of a type of a semiconductor material from which initial values of the respective coefficients in Expression (1-1) or (A1-2) are to be acquired; and
means for deriving the macro DC mobility μ(T, n) by performing regression through use of the program for calculating a macro DC mobility μ(T) of the semiconductor.

With the derivation program according to this aspect, it is possible to predict the macro DC mobility of the semiconductor by inputting the carrier concentration “n” [cm⁻³] of the semiconductor film and the temperature T [K] at a time of the measurement. As another example of using the derivation program according to this aspect, it is possible to derive contribution of each scattering parameter and potential barrier to the mobility by regressing the actually measured mobility and the predicted mobility.

Further, it is possible to predict voltage-current characteristics during driving of a device by incorporating the derivation program according to this aspect into a program for a device simulation. Further, it is possible to calculate the contribution of each scattering parameter and potential barrier to the mobility by regressing prediction results from the device simulation and the actually measured current-voltage characteristics of the device.

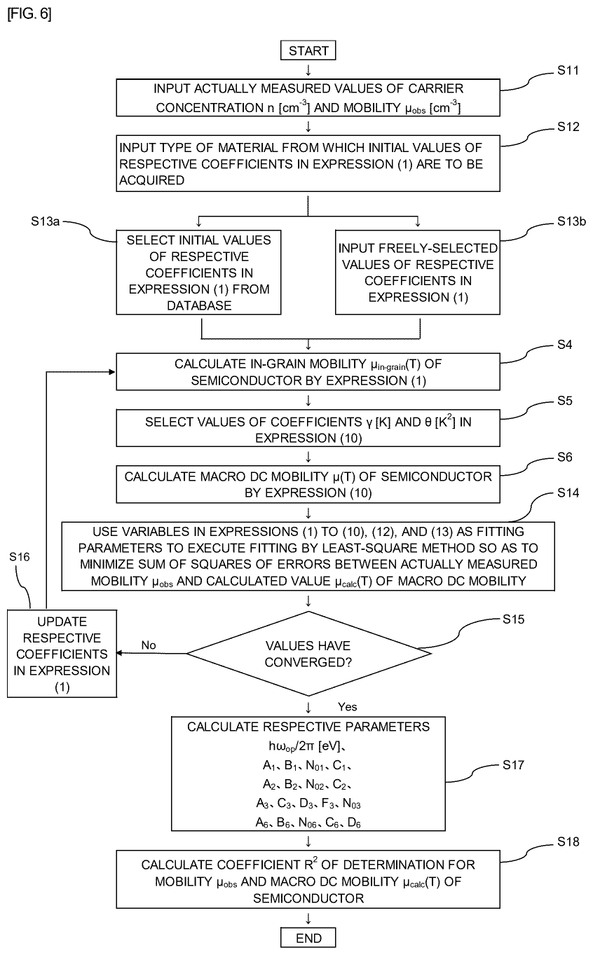

The derivation program for a macro DC mobility μ(T) according to one embodiment is described with reference to FIG. 6.

First, in Step S11, the actually measured values of the carrier concentration “n” [cm⁻³] and the mobility Jobs. [cm⁻³] are input to the computer. The carrier concentration and mobility input here refer to data measured through use of the Hall effect for each thin film sample at the measurement temperature T [K].

In Step S12, the type of the semiconductor material from which the initial values of the respective coefficients in Expression (1) are to be acquired is input to the computer.

In Step S13a, the computer selects the initial values of the respective coefficients in Expression (1) from the database based on the type of the semiconductor material input in Step S12. The database used here is built by inputting the actually measured values corresponding to the types of each semiconductor material and performing the calculation to accumulate the data.

When the corresponding type of the semiconductor material is not included in the database, freely-selected values are input to the computer in Step S13b.

The respective coefficients in Expression (1) include all the coefficients in Expressions (2) to (5) and (5-1) to (5-3) relating to Expression (1).

Subsequently, the computer substitutes the initial values of the respective coefficients in Expression (1) selected in Step S13a or the freely-selected values of the respective coefficients input in Step S13b into Expression (1), and uses the above-mentioned Step S4 to Step S6 of calculating the macro DC mobility μ(T) of the semiconductor in this aspect to calculate the macro DC mobility μ(T) of the semiconductor. (The obtained calculated value is hereinafter referred to as “mobility μ_{calc}(T).”)

In Step S14, the respective variables in Expressions (1) to (13) are used as fitting parameters to perform fitting by a least-square method so as to minimize a sum of squares of errors between the actually measured mobility (hereinafter referred to as mobility Jobs.) and the mobility μ_{calc}(T) obtained by causing the computer to execute Step S4 to Step S6.

In this case, values at room temperature are used for the carrier concentrations in Expressions (3) to (5) and (13) in Step S14.

Subsequently, in Step S15, the computer determines whether or not the values of the respective parameters have converged.

When the computer determines that convergence has not occurred, the process advances to Step S16 to update the values of the respective coefficients in Expression (1) and repeat Step S4 to Step S6 and Step S14, and the computer determines in Step S15 whether or not the values of the respective parameters have converged.

Step S16, Step S4 to Step S6, Step S14, and Step S15 are repeated until the computer determines in Step S15 that the values of the respective parameters have converged.

When the computer determines in Step S15 that the values of the respective parameters have converged, the process advances to Step S17, in which the computer outputs the values of the respective parameters in Expressions (1) to (13).

Subsequently, in Step S18, the computer calculates the coefficient R² of determination for the mobility Jobs. and the macro DC mobility μ_{calc}(T) of the semiconductor, thereby ending the flow.

Through execution of such regression as illustrated in FIG. 6 on the computer, it becomes possible to obtain a more accurate, namely, more highly reproducible, calculated value of the macro DC mobility μ(T) of the semiconductor.

### (Mobility Calculation Method-Machine Learning)

The calculation method for a macro DC mobility μ(T, n) dependent on the temperature T [K] and the carrier concentration “n” [cm⁻³] according to this aspect can be configured to enhance prediction accuracy through machine learning by a computer program, to thereby receive input of the temperature T [K] and the carrier concentration “n” [cm⁻³] and obtain an optimal macro DC mobility.

In the calculation method for a macro DC mobility μ(T, n) of the semiconductor dependent on the temperature T [K] and the carrier concentration “n” [cm⁻³] according to this aspect which uses the machine learning, the machine learning is used to calculate data of the μ(T, n) for T and “n” actually measured from a semiconductor film, by a non-parametric model that does not assume a mathematical model.

In one embodiment, the calculation using the non-parametric model is performed by regression with μ(T, n) used as an objective variable and the temperature T and the carrier concentration “n” used as explanatory variables.

In one embodiment, the regression is performed by a method selected from the group consisting of Gaussian process regression, linear regression, Ridge regression, LASSO regression, Elastic Net regression, random forest regression, support vector machine regression, SGD regression, quadratic regression, and derived algorithms thereof.

In one embodiment, the regression is performed by the Gaussian process regression.

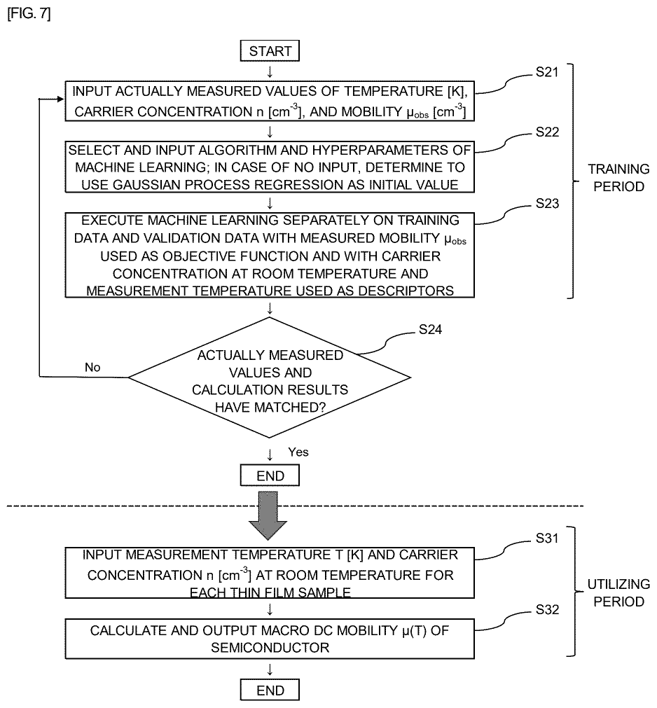

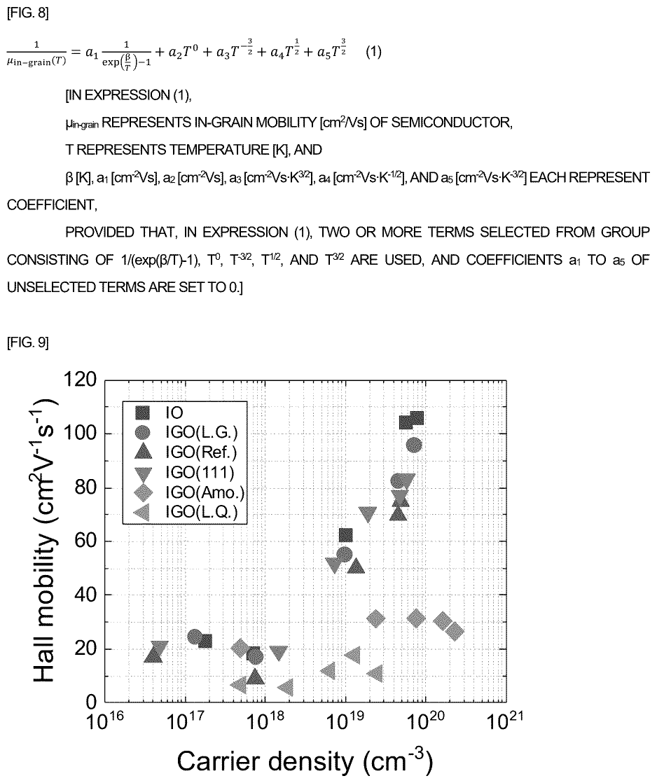

A machine learning flow of the calculation method for a macro DC mobility μ(T, n) according to one embodiment is described with reference to FIG. 7.

First, in Step S21, the actually measured values of the carrier concentration “n” [cm⁻³] and the mobility Jobs. [cm⁻³] are input to the computer. The carrier concentration and mobility input here refer to data measured through use of the Hall effect for each thin film sample at the measurement temperature T [K].

Subsequently, the actually measured values of the carrier concentration “n” [cm⁻³] and the mobility Jobs. [cm⁻³] input in Step S21 are used to perform the machine learning by the machine learning flow. In the machine learning algorithm, the non-parametric model that combines a polynomial, a Gaussian function, a sigmoid function, and the like is used, and hence the mathematical model of the dependence of the mobility on T and “n” is not obvious. For that reason, the trained model is black-boxed (the black-boxed machine learning model is hereinafter referred to as “black-box flow”).

Subsequently, in Step S22, an algorithm and hyperparameters (constants used in an algorithm model) of the machine learning are selected and input. In a case of selecting no algorithm, the computer determines to use a Gaussian process regression as the initial value of the algorithm.

In Step S23, the machine learning algorithm that has been selected and input or has been determined is used to execute the machine learning separately on training data and validation data with the mobility Jobs. used as an objective function and with the carrier concentration at room temperature and the measurement temperature used as descriptors. At this time, there is no obvious mathematical model, and the computer executes the calculation by the machine learning.

In Step S24, through use of an evaluation index of whether or not the actually measured values and the calculation results have matched, the computer confirms that there is no significant difference between the evaluation indices of the training data and the validation data, to thereby determine that the learning model has predictive performance (generalization performance), and determines whether or not the actually measured values and the calculation results have matched. As the evaluation index of whether or not the actually measured values and the calculation results have matched, a maximum absolute error (MAE), a mean squared error (MSE), the coefficient R² of determination, or the like is used for the determination.

Step S22 to Step S24 are repeated until the match between the actually measured values and the calculation results reaches a predetermined tolerance (that is, a certain error range).

The term “predetermined tolerance” refers to, for example, a range of 10% or less of the mobility in a case of the determination using the maximum absolute error MAE.

The flow is ended when the match between the actually measured values and the calculation results reaches the predetermined tolerance. The flow of from Step S21 to Step S23 is referred to as “training period.”

Next, steps of utilizing a machine learning program that has undergone the training period are described.

In Step 31, the measurement temperature T [K], the carrier concentration “n” [cm⁻³] at room temperature, and the mobility Jobs. [cm⁻³] are input for each thin film sample. Thus, in Step 23, the computer calculates and outputs the macro DC mobility μ(T) of the semiconductor, thereby ending the flow.

Through the machine learning performed through use of the computer, it becomes possible to obtain still more accurate calculated value of the macro DC mobility μ(T) of the semiconductor.

### EXAMPLES

Now, the present invention is described in detail based on Examples. However, the present invention is not limited to those Examples in any way.

### (A-1) Production of Semiconductor Thin Film Specimens for Actual Measurement Specimen 1

Through use of an oxide target having a metal composition ratio shown in Table 1, an oxide layer was deposited on a glass substrate by a sputtering method under deposition conditions shown in Table 1 so as to aim for a film thickness of 30 nm.

The metal composition ratio (at %) of the oxide target was obtained by the following expression.

$$[ ln ] / {( [ ln ] + [ M ] )}^{*} 100$$

(In the expression, [In] represents the number of moles of ln in the oxide target, and [M] represents the number of moles of metal elements other than ln in the oxide target.)

Subsequently, a first heat treatment (1st annealing) was performed under the conditions shown in Table 1 to produce a specimen 1. Crystallinity of the obtained specimen 1 was evaluated by XRD measurement. Results thereof are shown in Table 1.

After that, a second heat treatment (2nd annealing) was carried out under respective conditions 1 to 5 shown in Table 1 to obtain specimens 1-1 to 1-5.

### Specimen 2

A specimen 2 was produced in the same manner as in the case of the specimen 1, except that the oxide target composition, deposition conditions, and 1st annealing conditions were changed, and crystallinity evaluation was performed therefor.

After that, the second heat treatment (2nd annealing) was carried out in the same manner as in the case of the specimen 1 to obtain specimens 2-1 to 2-5.

TABLE 1

| | | Specimen 1 | Specimen 2 |
|---|---|---|---|
| Metal composition ratio of | | ≥70 | ≥50 |
| oxide target material [In]/ | | | |
| ([In] + [M])*100 [at %] | | | |
| Deposition | Deposition method | DC sputtering | DC sputtering |
| conditions | Target size | 4″Φ, 5 mmt | 4″Φ, 5 mmt |
| | Output [W] | 400 | 400 |
| | Pressure [Pa] | 0.50 | 0.50 |
| | Magnetic flux density [G] | 600 | 1,000 |
| | Film thickness [nm] | 29.2 | 32.5 |
| 1st annealing | Atmosphere | Air | Air |
| conditions | Humidity (measured at room | 45 | 45 |
| | temperature) [%] | | |
| | Maximum temperature | ≥400 | ≥400 |
| | reached [° C.] | | |
| | Annealing temperature [° C.] | 400 | 400 |
| | Annealing time [h] | 1 | 1 |
| Crystallinity | Crystallinity evaluation | Polycrystalline | Amorphous |
| evaluation | results by XRD | | |
| results after | Crystal structure | Bixbyite structure | — |
| 1st annealing | identification results by XRD | | |
| 2nd annealing | Atmosphere | — | — |
| conditions 1 | Maximum temperature reached [° C.] | — | — |
| (not implemented) | Annealing temperature [° C.] | — | — |
| | Annealing time [min] | — | — |
| 2nd annealing | Atmosphere | N₂ | N₂ |
| conditions 2 | Maximum temperature reached [° C.] | 200 | 200 |
| | Annealing temperature [° C.] | 200 | 200 |
| | Annealing time [min] | 5 | 5 |
| 2nd annealing | Atmosphere | N₂ | N₂ |
| conditions 3 | Maximum temperature reached [° C.] | 250 | 250 |
| | Annealing temperature [° C.] | 250 | 250 |
| | Annealing time [min] | 5 | 5 |
| 2nd annealing | Atmosphere | N₂ | N₂ |
| conditions 4 | Maximum temperature reached [° C.] | 300 | 300 |
| | Annealing temperature [° C.] | 300 | 300 |
| | Annealing time [min] | 5 | 5 |
| 2nd annealing | Atmosphere | N₂ | N₂ |
| conditions 5 | Maximum temperature reached [° C.] | 350 | 350 |
| | Annealing temperature [° C.] | 350 | 350 |
| | Annealing time [min] | 5 | 5 |

### (A-2) Measurement of Physical Properties of Semiconductor Thin Film for Actual Measurement

The following physical properties were measured for each of the obtained specimens.

(Carrier Concentration [cm⁻³] and Mobility μ_{obs.} [cm²/Vs])

For the evaluation of the carrier concentration (cm⁻³) and the mobility Jobs. [cm²/Vs] of the semiconductor thin film, electrical characteristics were evaluated through use of Hall effect measurement (AC Hall effect measurement) and resistivity measurement using a van der Pauw method. For the measurement, thin film samples cut into 1 cm squares with Ti electrodes formed on four corners thereof were used, and AC Hall measurement was carried out on each sample every 50 [K] in a temperature range of from 20 [K] to 300 [K]. Measurement conditions therefor are shown below.
Measuring device: ResiTest8400 manufactured by TOYO Corporation
Maximum applied voltage: 20 [V]
Applied magnetic field: 0.4 [T]

### Examples 1 and 2

For the specimens 1 and 2 obtained above, the calculation of the macro DC mobility μ(T) in one aspect of the present invention was performed.

(B) Calculation of ln-grain Mobility μ_{in-grain}(T)

Expression (1) and Expression (2) were used to calculate the in-grain mobility μ_{in-grain}(T) with respect to each temperature T and carrier concentration “n”. Here, as Aₙₑᵤₜᵣₐₗ, Aₒₚ, the weak localization constant, and the acoustic phonon scattering constant for each carrier concentration, values shown in Table 2 and values calculated through use of Expressions (3), (4), and (5) with respect to the value of “n” (300 K) were used.

The values of the respective parameters used to calculate the in-grain mobility μ_{in-grain}(T) are shown in Table 2 below.
(C) Calculation of Macro DC Mobility μ(T)

The macro DC mobility μ(T) with respect to each temperature T and carrier concentration “n” was calculated through use of the in-grain mobility μ_{in-grain}(T) calculated above, Expression (10), and Expression (12). The potential barrier V_{B} calculated through use of the values shown in Table 2 and Expression (13) was used.

Here, when the actually measured value Jobs, and the macro DC mobility μ(T) did not satisfactorily match, regression was performed through use of a non-linear least-square method, and when there was no change even after a plurality of times of repetitive fitting, the convergence was confirmed, thereby regarding the parameters as the experimental results.

The values of the respective parameters used to calculate the macro DC mobility μ(T) are shown in Table 2 below.

### Comparative Examples 1 and 2

For the above-mentioned specimens 1 and 2, the mobility μ_{d} was calculated through use of the related-art Tokyo Model.

### (D) Calculation of Mobility μ_{d} by the Tokyo Model

The calculation of the mobility μ_{d} [cm²/Vs] with respect to each temperature T and carrier concentration “n” by the Tokyo Model was performed through use of the following Expressions (I) and (II).

$${μ}_{d} = {{μ}_{d 0} ( \frac{n}{{n}_{cr}} )}^{γ / 2} \qquad ( I )$$

$$γ = \frac{{T}_{γ}}{T} + {γ}_{0} \qquad ( II )$$

In the expression, “n” is the free carrier concentration [cm⁻³] (equal to the free electron density [cm⁻³] in the oxide semiconductor treated herein), T is the temperature [K], and μ_{do} [cm²/Vs], n_{cr} [cm⁻³], T_{γ} [K], and γ₀ are each a coefficient.

When the actually measured value Jobs, and the mobility μ_{d} by the Tokyo Model did not satisfactorily match, regression was performed through use of the non-linear least-square method, and when there was no change even after a plurality of times of repetitive fitting, the convergence was confirmed, thereby regarding the parameters as the experimental results.

The values of the respective parameters used to calculate the calculation of the mobility μ_{d} by the Tokyo Model are shown in Table 3 below.

### (E) Evaluation (Coefficient R² of Determination) of Calculation Results

The coefficient R² of determination between the actually measured value Jobs. of the mobility obtained in the section (A-2) and the macro DC mobility μ(T) calculated in the section (C) or the mobility u calculated by the section (D) Tokyo Model was calculated by the following Expression (X). The obtained values of the coefficient R² of determination are respectively shown in Table 2 and Table 3 below.

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - \hat{y} )}^{2}} \qquad ( X )$$

In the expression, yᵢ is the actually measured value of an i-th mobility, ŷᵢ is the calculation result of the i-th mobility, and y̅ is an average value of the actually measured mobility values.

When the actually measured value Jobs. of the macro DC mobility is plotted on a horizontal axis and the macro DC mobility μ_{calc} calculated through use of each model is plotted on a vertical axis, the coefficient R² of determination that is closer to 1 means that the used model was more appropriate.

In the tables, “E” denotes exponential notation, and an integer following “E” represents a power of 10 applied to that numerical value. For example, “4.60E-2” represents 4.60×10⁻².

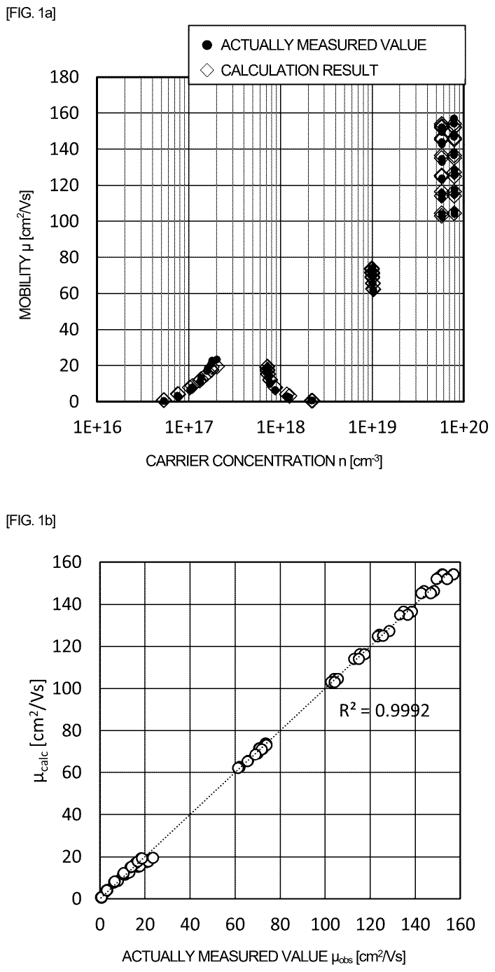

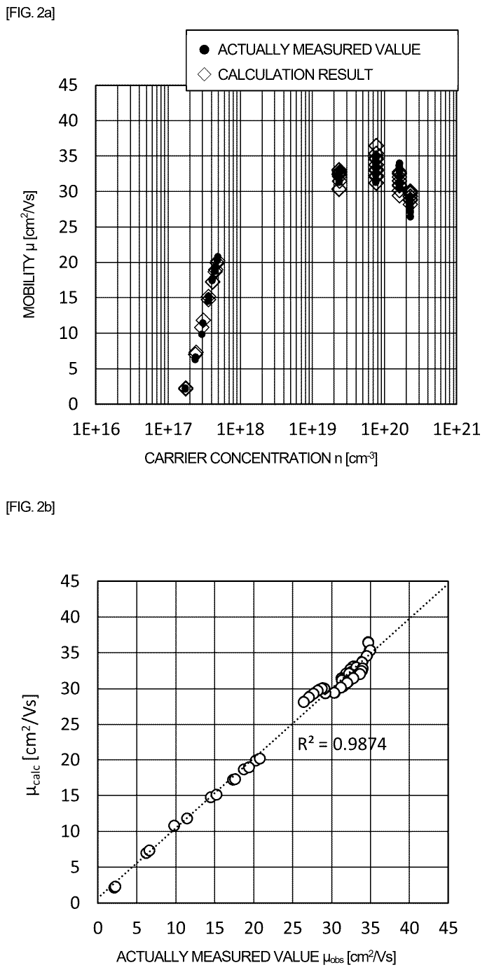

TABLE 2

| | | Example 1 | Example 2 |
|---|---|---|---|
| | | Specimen 1 | Specimen 2 |
| Crystallinity | | Polycrystalline | Amorphous |
| Parameters | hωop/2π [eV] | 4.60E−02 | 4.60E−02 |
| | A₁[cm⁻²Vs] | 1.05E−03 | 2.77E−02 |
| | B₁ | 20.06 | 0.0 |
| | log(N₀₁) | 19.58 | 20.4 |
| | C₁[cm⁻²Vs] | 1.40E−02 | 0.00E+00 |
| | A₂[cm⁻²Vs] | 1.33E−02 | 2.92E−02 |
| | B₂ | 16.15 | −1.2 |
| | log(N₀₂) | 19.01 | 21.4 |
| | C₂[cm⁻²Vs] | 6.50E−03 | 2.58E−02 |
| | A₃[cm⁻⁸Vs · T^{3/2}] | 8.00E−36 | 2.76E−35 |
| | B₃ | 15.00 | 9.3 |
| | C₃[cm⁻²Vs · T^{3/2}] | 1.987E−04 | −1.20E+08 |
| | D₃[cm³] | 2.84E−15 | 1.93E+09 |
| | F₃[cm⁻²Vs · T^{3/2}] | −4.776E−04 | 0.6854 |
| | log(N₀₃) | 18.50 | 17.7 |
| | A₆ [eV] | 4.046E−02 | 1.55E−01 |
| | B₆ | 10.80 | 1.0 |
| | log(N₀₆) | 18.37 | 18.0 |
| | C₆ [eV] | −1.33E−05 | 4.7E−02 |
| | D₆ [eV] | 0.027 | 0.069 |

| | | |
|---|---|---|
| Comparison between calculation | FIG. 1a and | FIG. 2a and |
| results and actually measured values | FIG. 1b | FIG. 2b |
| R² error | 0.9992 | 0.9874 |

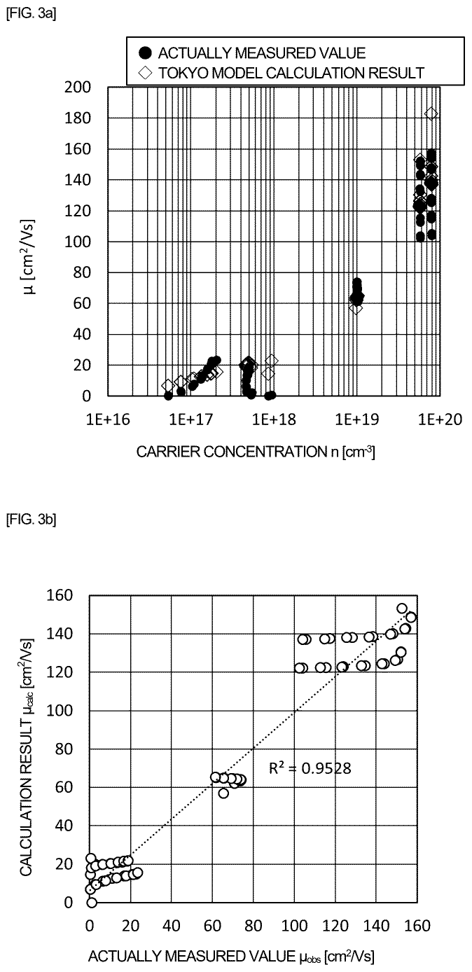

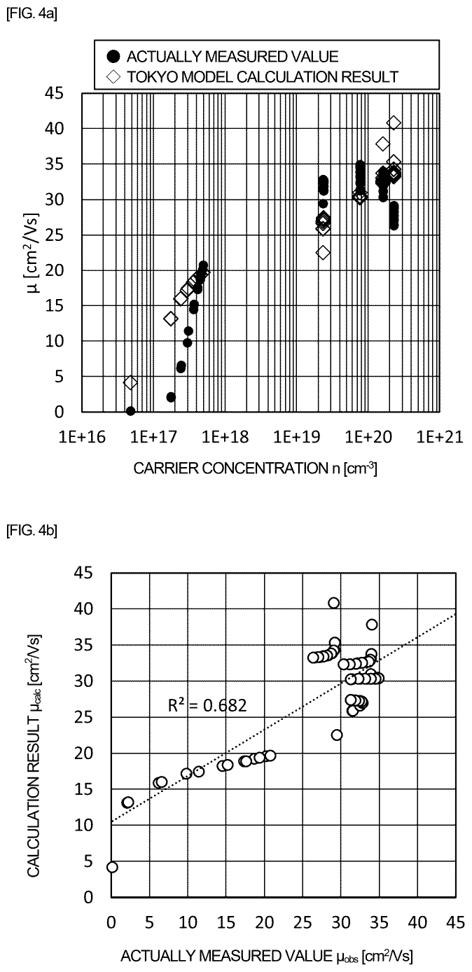

TABLE 3

| | | Comparative | Comparative |
|---|---|---|---|
| | | Example 1 | Example 2 |
| | | Specimen 1 | Specimen 2 |
| Crystallinity | | Polycrystalline | Amorphous |
| Parameters | μ_{d0}[cm²/Vs] | 79.5 | 30.0 |
| | n_{cr}[cm⁻³] | 1.77E+19 | 6.81E+19 |
| | γ₀ | 0.70 | 0.14 |
| | T_{γ}[K] | 8.8 | 8.0 |

| | | |
|---|---|---|
| Comparison between calculation | FIG. 3a and | FIG. 4a and |
| results and actually measured values | FIG. 3b | FIG. 4b |
| R² error | 0.9528 | 0.6820 |

Further, FIG. 1a to FIG. 4a each show a graph in which a relationship between the actually measured value Jobs. of the mobility of each specimen and the calculated value of the mobility obtained in each of Examples and Comparative Examples is plotted against the carrier concentration “n”, and FIG. 1b to FIG. 4b each show a graph in which the actually measured value Jobs. of the mobility of each specimen is plotted on the horizontal axis and the calculated value μ_{calc} of the mobility is plotted on the vertical axis.

From FIG. 1 to FIGS. 4, the calculated values of the mobility obtained by the Tokyo Model (Comparative Examples 1 and 2) were found to deviate from the actually measured values, while the calculated values obtained by the calculation method for a macro DC mobility μ(T) according to the present invention (Examples 1 and 2) each showed a satisfactory match both in the case of crystalline oxide semiconductors and in the case of amorphous oxide semiconductors, and hence it is understood that high reproducibility was demonstrated.

### <Verification of Mobility Model>

### (F-1) Semiconductor Thin Film Specimens 3 to 8 for Actual Measurement

Thin films were produced in the same manner as in the case of the specimen 1, except that the oxide target composition, deposition conditions, and 1st annealing conditions were changed as shown in Tables 4-1 to 4-3, and crystallinity evaluation was performed therefor.

After that, the second heat treatment (2nd annealing) was carried out in the same manner as in the case of the specimen 1 to obtain specimens 3 to 8.

TABLE 4-1

| | | Specimen 3: | Specimen 4: |
|---|---|---|---|
| | | IO | IGO(L.G.) |
| In composition ratio | [In]/([In] + [Ga] + | 100 | >90 |
| of oxide target material | [M])*100 [at %] | | |
| Ga composition ratio | [Ga]/([Ga] + [M])*100 | 0 | >95 |
| of oxide target material | [at %] | | |
| Deposition conditions | Deposition method | DC sputtering | DC sputtering |
| | Target size | 4″ Φ, 5 mmt | 4″ Φ, 5 mmt |
| | Output [W] | 400 | 300 |
| | Pressure [Pa] | 0.50 | 0.50 |
| | Magnetic flux density [G] | 600 | 600 |
| | Gas introduced during deposition | Ar + H₂O | Ar + H₂O |
| | Film thickness [nm] | 29.2 | 29.4 |
| 1st annealing conditions | Atmosphere | Air | Air |
| | Humidity (measured at room | 45 | 45 |
| | temperature) [%] | | |
| | Maximum temperature reached [° C.] | ≥400 | ≥400 |
| | Annealing temperature [° C.] | 400 | 400 |
| | Annealing time [h] | 1 | 1 |
| Crystallinity evaluation | Crystallinity evaluation results | Polycrystalline | Polycrystalline |
| results after 1st | by XRD | | |
| annealing | Crystal structure identification | Bixbyite | Bixbyite |
| | results by XRD | structure | structure |
| 2nd annealing | Atmosphere | — | — |
| conditions 1 | Maximum temperature reached [° C.] | — | — |
| (not implemented) | Annealing temperature [° C.] | — | — |
| | Annealing time [min] | — | — |
| 2nd annealing | Atmosphere | N₂ | N₂ |
| conditions 2 | Maximum temperature reached [° C.] | 200 | 200 |
| | Annealing temperature [° C.] | 200 | 200 |
| | Annealing time [min] | 5 | 5 |
| 2nd annealing | Atmosphere | N₂ | N₂ |
| conditions 3 | Maximum temperature reached [° C.] | 250 | 250 |
| | Annealing temperature [° C.] | 250 | 250 |
| | Annealing time [min] | 5 | 5 |
| 2nd annealing | Atmosphere | N₂ | N₂ |
| conditions 4 | Maximum temperature reached [° C.] | 300 | 300 |
| | Annealing temperature [° C.] | 300 | 300 |
| | Annealing time [min] | 5 | 5 |
| 2nd annealing | Atmosphere | N₂ | N₂ |
| conditions 5 | Maximum temperature reached [° C.] | 350 | 350 |
| | Annealing temperature [° C.] | 350 | 350 |
| | Annealing time [min] | 5 | 5 |

TABLE 4-2

| | | Specimen 5: | Specimen 6: |
|---|---|---|---|
| | | IGO(Ref) | IGO(111) |
| In composition ratio of | [In]/([In] + [Ga] + | >80 | >80 |
| oxide target material | [M])*100 [at %] | | |
| Ga composition ratio of | [Ga]/([Ga] + [M])*100 | >80 | >90 |
| oxide target material | [at %] | | |
| Deposition conditions | Deposition method | DC sputtering | DC sputtering |
| | Target size | 4″ Φ, 5 mmt | 4″ Φ, 5 mmt |
| | Output [W] | 300 | 300 |
| | Pressure [Pa] | 0.50 | 0.50 |
| | Magnetic flux density [G] | 1,000 | 1,000 |
| | Gas introduced during deposition | Ar + O₂ | Ar + O₂ |
| | Film thickness [nm] | 29.9 | 33.4 |
| 1st annealing conditions | Atmosphere | Air | Air |
| | Humidity (measured at room | 45 | 45 |
| | temperature) [%] | | |
| | Maximum temperature reached [° C.] | ≥400 | ≥400 |
| | Annealing temperature [° C.] | 400 | 400 |
| | Annealing time [h] | 1 | 1 |
| Crystallinity evaluation | Crystallinity evaluation results | Polycrystalline | Polycrystalline |
| results after 1st | by XRD | | |
| annealing | Crystal structure identification | Bixbyite | Bixbyite |
| | results by XRD | structure | structure |
| 2nd annealing | Atmosphere | — | — |
| conditions 1 | Maximum temperature reached [° C.] | — | — |
| (not implemented) | Annealing temperature [° C.] | — | — |
| | Annealing time [min] | — | — |
| 2nd annealing | Atmosphere | N₂ | N₂ |
| conditions 2 | Maximum temperature reached [° C.] | 200 | 200 |
| | Annealing temperature [° C.] | 200 | 200 |
| | Annealing time [min] | 5 | 5 |
| 2nd annealing | Atmosphere | N₂ | N₂ |
| conditions 3 | Maximum temperature reached [° C.] | 250 | 250 |
| | Annealing temperature [° C.] | 250 | 250 |
| | Annealing time [min] | 5 | 5 |
| 2nd annealing | Atmosphere | N₂ | N₂ |
| conditions 4 | Maximum temperature reached [° C.] | 300 | 300 |
| | Annealing temperature [° C.] | 300 | 300 |
| | Annealing time [min] | 5 | 5 |
| 2nd annealing | Atmosphere | N₂ | N₂ |
| conditions 5 | Maximum temperature reached [° C.] | 350 | 350 |
| | Annealing temperature [° C.] | 350 | 350 |
| | Annealing time [min] | 5 | 5 |

TABLE 4-3

| | | Specimen 7: | Specimen 8: |
|---|---|---|---|
| | | IGO(Amo.) | IGO(L.Q.) |
| In composition ratio | [In]/([In] + [Ga] + | >75 | >80 |
| of oxide target material | [M])*100 [at %] | | |
| Ga composition ratio | [Ga]/([Ga] + [M])*100 | >70 | >80 |
| of oxide target material | [at %] | | |
| Deposition conditions | Deposition method | DC sputtering | DC sputtering |
| | Target size | 4″ Φ, 5 mmt | 4″ Φ, 5 mmt |
| | Output [W] | 300 | 100 |
| | Pressure [Pa] | 0.50 | 0.50 |
| | Magnetic flux density [G] | 1,000 | 1,000 |
| | Gas introduced during deposition | Ar + O₂ | Ar + O₂ |
| | Film thickness [nm] | 32.5 | 32.6 |
| 1st annealing conditions | Atmosphere | Air | Air |
| | Humidity (measured at room | 45 | 45 |
| | temperature) [%] | | |
| | Maximum temperature reached [° C.] | ≥400 | ≥400 |
| | Annealing temperature [° C.] | 400 | 400 |
| | Annealing time [h] | 1 | 1 |
| Crystallinity evaluation | Crystallinity evaluation results | Amorphous | Polycrystalline |
| results after 1st | by XRD | | |
| annealing | Crystal structure identification | — | Bixbyite |
| | results by XRD | | structure |
| 2nd annealing | Atmosphere | — | — |
| conditions 1 | Maximum temperature reached [° C.] | — | — |
| (not implemented) | Annealing temperature [° C.] | — | — |
| | Annealing time [min] | — | — |
| 2nd annealing | Atmosphere | N₂ | N₂ |
| conditions 2 | Maximum temperature reached [° C.] | 200 | 200 |
| | Annealing temperature [° C.] | 200 | 200 |
| | Annealing time [min] | 5 | 5 |
| 2nd annealing | Atmosphere | N₂ | N₂ |
| conditions 3 | Maximum temperature reached [° C.] | 250 | 225 |
| | Annealing temperature [° C.] | 250 | 225 |
| | Annealing time [min] | 5 | 5 |
| 2nd annealing | Atmosphere | N₂ | N₂ |
| conditions 4 | Maximum temperature reached [° C.] | 300 | 250 |
| | Annealing temperature [° C.] | 300 | 250 |
| | Annealing time [min] | 5 | 5 |
| 2nd annealing | Atmosphere | N₂ | N₂ |
| conditions 5 | Maximum temperature reached [° C.] | 350 | 300 |
| | Annealing temperature [° C.] | 350 | 300 |
| | Annealing time [min] | 5 | 5 |

FIG. 9 shows a graph in which mobility-carrier concentrations of respective specimens that were obtained are plotted.

Further, FIG. 10 shows an electron backscatter diffraction orientation map (EBSD pattern IPF map) indicating the crystal grain sizes and crystal orientations of the respective specimens.

### (F-2) Measurement of Physical Properties of Semiconductor Thin Film for Actual Measurement

The following physical properties were measured for each of the obtained specimens.

(Carrier Concentration [cm⁻³] and Mobility Jobs. [cm²/Vs])

For the evaluation of the carrier concentration (cm⁻³) and the mobility Hobs. [cm²/Vs] of the semiconductor thin film, the electrical characteristics were evaluated through use of the Hall effect measurement (AC Hall effect measurement) and the resistivity measurement using the van der Pauw method. For the measurement, thin film samples cut into 1 cm squares with Ti electrodes formed on four corners thereof were used, and the AC Hall measurement was carried out on each sample every 50 [K] in the temperature range of from 20 [K] to 300 [K]. Measurement conditions therefor are shown below.
Measuring device: ResiTest8400 manufactured by TOYO Corporation
Maximum applied voltage: 20 [V]
Applied magnetic field: 0.4 [T]

### (G) Calculation of Macro DC Mobility μ(T)

### Examples 3 to 8

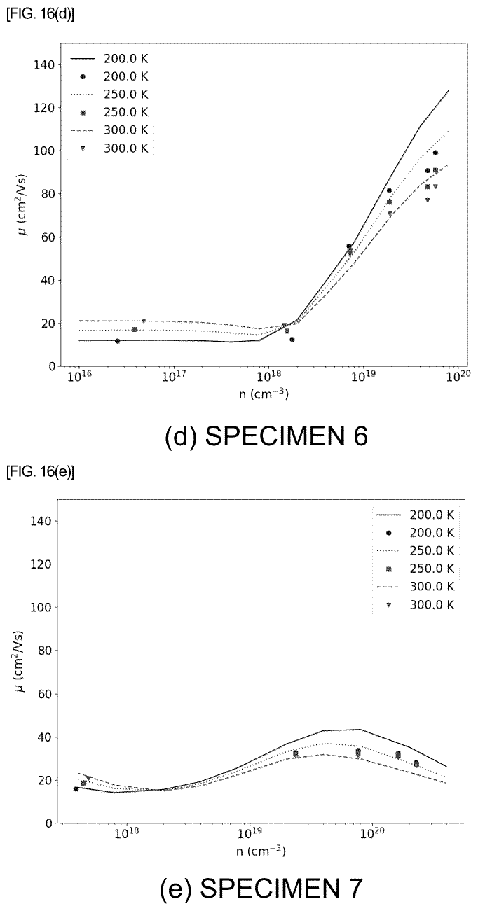

The mobility-carrier concentration lines (μ-n lines) of the respective scattering parameters at temperatures of 200.0 K, 250.0 K, and 300.0 K, which were obtained by inputting fitting parameters shown in Table 6 below into a set of expressions (mobility model expressions) shown in Tables 5-1 and 5-2 below, which have been described in the detailed description, are shown in FIG. 16 together with plots of the respective actually measured values of the specimens 3 to 8.

TABLE 5-1

| Scattering factors | Model expressions | |
|---|---|---|
| Overall expression | $μ = [ exp ( - \frac{{qV}_{B}}{kT} ) ] {μ}_{in - grain} \qquad ( A - 10 )$ | |
| | $\frac{1}{{μ}_{in - grain}} = \frac{1}{{μ}_{NI}} + \frac{1}{{μ}_{II}^{( Deg )}} + \frac{1}{{μ}_{II}^{( nonDeg )}} + \frac{1}{{μ}_{OP}} \qquad ( A1 - 1 )$ | |
| Neutral impurity scattering | ${μ}_{NI} = \frac{e}{3 ℏ {N}_{N I}} \sqrt{\frac{2}{π}} \frac{{( 2 {a}_{0}^{2} C )}^{\frac{5}{2}}}{2 π {a}_{0}^{6}} 〈 - \frac{1}{{DC}^{2}} [ ( {Ck}_{1}^{{′}^{2}} + 1 ) exp ( - {Ck}_{1}^{{′}^{2}} ) - 1 ] + \frac{1}{4 {C}^{\frac{7}{2}}} \{ [ {( {Ck}_{1}^{{′}^{2}} )}^{\frac{5}{2}} + \frac{5}{2} {( {Ck}_{1}^{{′}^{2}} )}^{\frac{3}{2}} + \frac{15}{2} {( {Ck}_{1}^{{′}^{2}} )}^{\frac{1}{2}} ] exp ( - {Ck}_{1}^{{′}^{2}} ) + \frac{15}{8} \sqrt{π} ( 1 - erf ( \sqrt{- {Ck}_{1}^{{′}^{2}}} ) ) \} 〉 \qquad ( A3Q - app )$ | |
| | ${m}^{*} = {m}_{0}^{*} {\{ 1 + 2 {α}^{′} \frac{{{ℏ}^{2} ( 3 {π}^{2} n )}^{\frac{2}{3}}}{{m}_{0}^{*}} \}}^{\frac{1}{2}} \qquad ( M - 2 )$ | |
| | ${q}_{s} = \frac{e}{\sqrt{{k}_{B} T {ε}_{0} {ε}_{r}}} {( \frac{1}{n} + \frac{1}{\sqrt{8} {N}_{C}} )}^{- 1 / 2} {a}_{0} = \frac{4 {π}^{2} {ℏ}^{2} {ε}_{0} {ε}_{r}}{{m}^{*} {e}^{2}} C = \frac{{ℏ}^{2}}{2 {a}_{0}^{2} {m}^{*} {k}_{B} T} \\ D = 356 exp [ - 6.2 {( {q}_{s} {a}_{0} )}^{0.675} ] + 0.05 {k}_{1}^{′} = {( \frac{D}{4} )}^{- \frac{1}{3}}$ | |
| Ionized impurity scattering | Degenerate | ${μ}_{II}^{′ ( Deg )} = \frac{24 {{π}^{3} ( {ε}_{0} {ε}_{r} )}^{2} {ℏ}^{3}}{{m}^{* 2} {e}^{3} {F}_{II}} \times \frac{1}{{Z}^{2} ( \frac{{N}_{II \_ Deg}}{n} + \frac{1}{Z} )} \qquad ( A4 - 1 )$ ${μ}_{II}^{( Deg )} = \frac{{μ}_{II}^{′ ( Deg )}}{1 + {( \frac{{N}_{C}}{n} )}^{+ a}} \qquad ( A4 - S )$ ${m}^{*} = {m}_{0}^{*} {\{ 1 + 2 {α}^{′} \frac{{{ℏ}^{2} ( 3 {π}^{2} n )}^{\frac{2}{3}}}{{m}_{0}^{*}} \}}^{\frac{1}{2}} \qquad ( M - 2 )$ ${F}_{II} = [ 1 + \frac{4 {ξ}_{np}}{{ξ}_{d}} ( 1 - \frac{{ξ}_{np}}{8} ) ] ln ( 1 + {ξ}_{d} ) - \frac{{ξ}_{d}}{1 + {ξ}_{d}} - 2 {ξ}_{np} ( 1 - \frac{5 {ξ}_{np}}{16} ) \qquad ( F )$ ${ξ}_{d} = {( 3 {π}^{2} n )}^{1 / 3} \frac{4 {π}^{2} {ℏ}^{2} {ε}_{0} {ε}_{r}}{{m}^{*} {e}^{2}} {ξ}_{np} = 1 - \frac{{m}_{0}^{*}}{{m}^{*}}$ |
| | Non- degenerate | ${μ}_{II}^{′ ( nonDeg )} = \frac{128 \sqrt{2 π} {( {ε}_{0} {ε}_{r} )}^{2} {( {k}_{B} T )}^{3 / 2}}{\sqrt{{m}^{*}} {e}^{3}} \times \frac{1}{{Z}^{2} {N}_{{II}_{non} Deg}} \times \frac{1}{{F}_{II}} \qquad ( A5 - BH )$ ${μ}_{II}^{( nonDeg )} = \frac{{μ}_{II}^{′ ( nonDeg )}}{1 + {( \frac{{N}_{C}}{n} )}^{- a}} \qquad ( A 5 - S )$ ${m}^{*} = {m}_{0}^{*} {\{ 1 + 2 {α}^{′} \frac{{{ℏ}^{2} ( 3 {π}^{2} n )}^{\frac{2}{3}}}{{m}_{0}^{*}} \}}^{\frac{1}{2}} \qquad ( M - 2 )$ ${F}_{II} = [ 1 + \frac{4 {ξ}_{np}}{{ξ}_{d}} ( 1 - \frac{{ξ}_{np}}{8} ) ] ln ( 1 + {ξ}_{d} ) - \frac{{ξ}_{d}}{1 + {ξ}_{d}} - 2 {ξ}_{np} ( 1 - \frac{5 {ξ}_{np}}{16} ) \qquad ( F )$ ${ξ}_{d} = {( 3 {π}^{2} n )}^{1 / 3} \frac{4 {π}^{2} {ℏ}^{2} {ε}_{0} {ε}_{r}}{{m}^{*} {e}^{2}}$ |

TABLE 5-2

| Scattering factors | Model expressions |
|---|---|
| Optical phonon scattering | ${μ}_{OP} = \frac{4 π {ε}_{0} {ℏ}^{2} [ exp ( \frac{{ℏω}_{opt}}{{k}_{B} T} ) - 1 ]}{{{em}^{*} ( 2 {m}^{*} {ℏω}_{opt} )}^{1 / 2}} / ( \frac{1}{{ε}_{opt}} - \frac{1}{{ε}_{r}} ) \qquad ( A2 - 2 )$ ${m}^{*} = {m}_{0}^{*} {\{ 1 + 2 {α}^{′} \frac{{{ℏ}^{2} ( 3 {π}^{2} n )}^{\frac{2}{3}}}{{m}_{0}^{*}} \}}^{\frac{1}{2}} \qquad ( M - 2 )$ |
| Grain boundary scattering | ${V}_{B} = {δ}_{{E}_{F}} [ 1 \text{?} \qquad ( A11 )$ $α = \frac{8 {ε}_{0} {ε}_{r} n}{{e}^{2} {N}_{T}^{2}} , {δ}_{{E}_{F}} = {E}_{F}^{GB} - {E}_{F}^{G} , {}_{}^{*} {V}_{B}^{} \geq 0$ |

Note:
In Table 5-1, the left-hand sides μ_{∥}^{(Deg)} of Expression (A4-1) and Expression (A4-S) are represented in the same manner, and hence, for distinction therebetween, the left-hand side of Expression (A4-1) is represented as μ′_{∥}^{(Deg)}. In the same manner, the left-hand sides μ_{∥}^{(nonDeg)} of Expression (A5-BH) and Expression (A5-S) are represented in the same manner, and hence, for distinction therebetween, the left-hand side of Expression (A5-BH) is represented as μ′_{∥}^{(nonDeg)}.
$\text{?} \text{indicates text missing or illegible when filed}$

TABLE 6

| | | Example | Example | Example | Example | Example | Example |
|---|---|---|---|---|---|---|---|
| | | 3 | 4 | 5 | 6 | 7 | 8 |
| | | Specimen | Specimen | Specimen | Specimen | Specimen | Specimen |
| Fitting parameters | | 3 | 4 | 5 | 6 | 7 | 8 |
| Relative permittivity (static) | εᵣ | 14 | 14 | 14 | 14 | 14 | 14 |
| Relative permittivity (optical) | εₒₚₜ | 4.05 | 4.05 | 4.05 | 4.05 | 4.05 | 4.05 |
| Optical phonon energy | ℏωₒₚₜ[eV] | 0.0446 | 0.0446 | 0.0446 | 0.0446 | 0.0446 | 0.8 |
| Effective density of states | N_{c} [cm⁻³] | 2.00E+18 | 2.00E+18 | 2.00E+18 | 2.00E+18 | 2.00E+18 | 2.00E+18 |
| Ionic valence (degenerate) | Z | 2 | 2 | 2 | 2 | 2 | 2 |
| Ionized impurity | N_{II}_{_{—}}_{Deg} [cm⁻³] | 4.00E+19 | 4.40E+19 | 6.50E+19 | 4.30E+19 | 7.50E+19 | 2.00E+20 |
| concentration (degenerate) | | | | | | | |
| Neutral impurity scattering | N_{NI} [cm⁻³] | 3.10E+19 | 3.80E+19 | 4.30E+19 | 4.00E+19 | 2.50E+19 | 5.00E+19 |
| concentration | | | | | | | |
| Effective mass | m*₀[eV/c²] | 0.15 mₑ | 0.15 mₑ | 0.15 mₑ | 0.15 mₑ | 0.15 mₑ | 0.15 mₑ |
| | mₑ is electron mass: | | | | | | |
| | 0.511 MeV/c² | | | | | | |
| Fermi energy difference | δ_{EF}[eV] | 0.015 | 0.0115 | 0.015 | 0.013 | 0.0075 | 0.015 |
| (grain boundary − grain | | | | | | | |
| interior) | | | | | | | |
| Grain boundary trap | N_{T}[cm⁻²eV⁻¹] | 7.50E+13 | 1.50E+14 | 5.50E+13 | 9.00E+13 | 1.00E+14 | 1.00E+14 |
| density | | | | | | | |
| Ionic valence (non- | Z′ | 2 | 2 | 2 | 2 | 2 | 2 |
| degenerate) | | | | | | | |
| Ionized impurity | N_{II}_{_{—}}_{nonDeg}[cm⁻²eV⁻¹] | 8.00E+18 | 8.00E+18 | 1.00E+19 | 1.00E+19 | 9.00E+18 | 9.00E+18 |
| concentration (non- | | | | | | | |
| degenerate) | | | | | | | |
| Non-parabolicity coefficient | α′[eV⁻¹] | 0 | 0 | 0 | 0 | 2.293 | 2.293 |
| of band curvature | | | | | | | |

Note:
In Table 6, although Z is the ionic valence of an ionized impurity, the ionic valence (degenerate) is represented as Z, and the ionic valence (non-degenerate) is represented as Z′ in the table above.

From FIG. 16(a) to FIG. 16(f), the calculated values obtained by the calculation method for a macro DC mobility μ(T) based on a physical model according to the present invention each showed a satisfactory match both in the case of polycrystalline oxide semiconductors and in the case of amorphous oxide semiconductors, and hence it is understood that high reproducibility was demonstrated.

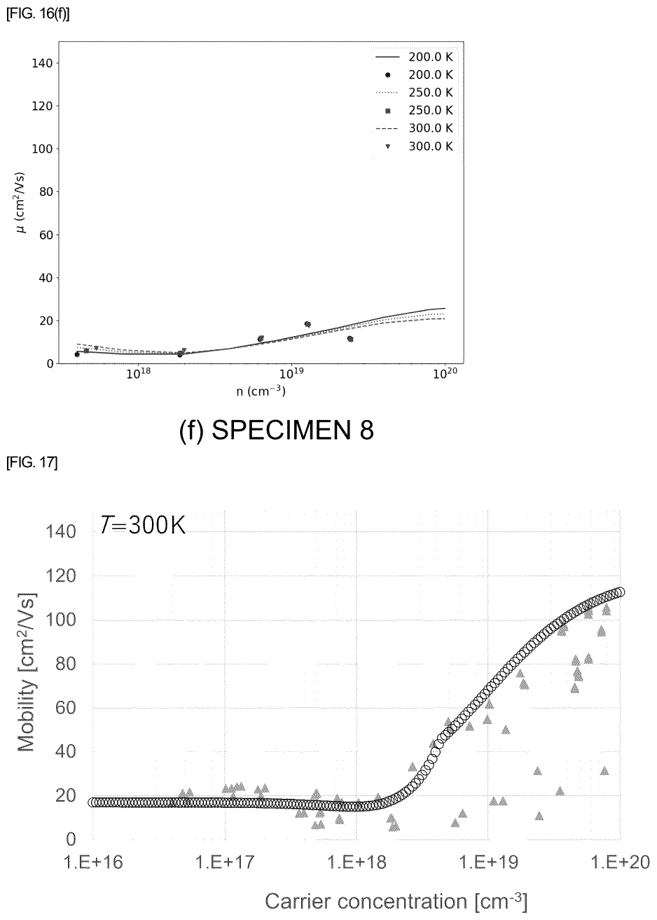

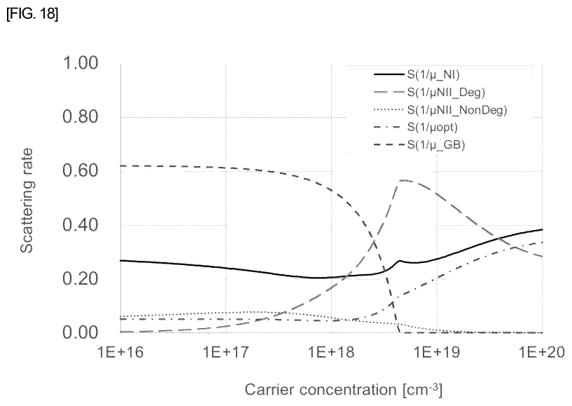

FIG. 17, in the same manner as FIGS. 16, shows a mobility-carrier concentration line at 300 K obtained by inputting parameters in Table 7 below into the mathematical expression list of Table 5. An upper limit value of each plot of the mobility-carrier concentration of a polycrystalline oxide semiconductor material is well reproduced. In FIG. 18, through use of the fact that μ, μ_{OP}, μ_{NI}, μ_{II}^{(Deg)}, and μ_{II}^{(nonDeg)} at each carrier concentration are obtained at a time of acquiring the graph of FIG. 17, scattering rates of the respective scattering parameters were calculated. A scattering rate S of each scattering parameter was defined as μ/μₓ, where μₓ is any one of μ_{OP}, μ_{NI}, μ_{II}^{(Deg)}, μ_{II}^{(nonDeg)}, or μ_{GB}. Here, as the mobility μ_{GB} at the grain boundary (GB), μ_{GB} was defined so as to satisfy the following Matthiessen rule as a mobility decrease amount due to V_{B} from the macro DC mobility μ.

$$\frac{1}{{μ}_{G B}} = \frac{1}{μ} - ( \frac{1}{{μ}_{NI}} + \frac{1}{{μ}_{II}^{( Deg )}} + \frac{1}{{μ}_{II}^{( nonDeg )}} + \frac{1}{{μ}_{OP}} )$$

TABLE 7

| Fitting parameters | | Poly-OS |
|---|---|---|
| Relative permittivity (static) | εᵣ | 14 |
| Relative permittivity (optical) | εₒₚₜ | 4.05 |
| Optical phonon energy | ℏωₒₚₜ[eV] | 0.0446 |
| Effective density of states | N_{c}[cm⁻³] | 2.00E+18 |
| Ionic valence (degenerate) | Z | 2 |
| Ionized impurity concentration | N_{II}_{_{—}}_{Deg}[cm⁻³] | 3.00E+19 |
| (degenerate) | | |
| Neutral impurity scattering | N_{NI}[cm⁻³] | 3.00E+19 |
| concentration | | |
| Effective mass | m*₀[eV/c²] | 0.15 mₑ |
| | mₑ is electron | |
| | mass: 0.511 MeV/c² | |
| Fermi energy difference (grain | δ_{EF}[eV] | 0.025 |
| boundary-grain interior) | | |
| Grain boundary trap density | N_{T}[cm⁻²eV⁻¹] | 7.50E+13 |
| Ionic valence (non-degenerate) | Z′ | 2 |
| Ionized impurity concentration | N_{II}_{_{—}}_{nonDeg}[cm⁻²eV⁻¹] | 8.00E+18 |
| (non-degenerate) | | |
| Non-parabolicity coefficient | α′[eV⁻¹] | 0 |
| of band curvature | | |

Note:
In Table 7, although Z is the ionic valence of an ionized impurity, the ionic valence (degenerate) is represented as Z, and the ionic valence (non-degenerate) is represented as Z′ in the above table.

### (H) Calculation of Scattering Rate

FIG. 18 shows graphs in each of which the carrier concentration of each specimen is plotted on the horizontal axis and the scattering rate of each scattering parameter on the vertical axis. In this manner, the mobility model has become clearer, and hence it has become possible to visualize the scattering rate, which is a degree of influence of each scattering factor at each carrier concentration.

### INDUSTRIAL APPLICABILITY

The macro DC mobility calculation method and calculation program according to one aspect of the present invention are useful as simulation means in the device design of semiconductor devices that use crystalline oxide thin films containing ln as a main component.

Several embodiments and/or Examples of the present invention have been described above in detail, but it is easy for a person skilled in the art to add numerous modifications to those exemplary embodiments and/or Examples without substantially departing from the novel teachings and advantageous effects of the present invention. Accordingly, those numerous modifications fall within the scope of the present invention.

The literatures cited herein and the contents of the applications from which the present application claims priority under the Paris Convention are incorporated by reference in their entirety.

1. A calculation method for an in-grain mobility μ_{in-grain}(T) of a semiconductor,
wherein, assuming that a temperature T [K] is a fluctuation factor, a reciprocal of the in-grain mobility μ_{in-grain}(T) is expressed as a linear combination of two or more terms selected from the group consisting of 1/(exp(β/T)−1), T⁰, T^{-3/2}, T^{1/2}, T^{3/2}, T¹, and T², [where β [K] is a coefficient].

2. The calculation method for an in-grain mobility μ_{in-grain}(T) of a semiconductor according to claim 1, wherein, as the reciprocal of the in-grain mobility μ_{in-grain}(T) in the following Expression (1), two or more terms selected from the group consisting of 1/(exp(β/T)−1), T⁰, T^{-3/2}, T^{1/2}, and T^{3/2} are used:
$$\frac{1}{{μ}_{i n - g r a i n} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} , \qquad ( 1 )$$
[in Expression (1),
μ_{in-grain} represents an in-grain mobility [cm²/Vs] of the semiconductor,
T represents the temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and as [cm⁻²Vs·K^{-3/2}] each represent a coefficient,
provided that, in Expression (1), the coefficients a₁ to a₅ of unselected terms among the 1/(exp(β/T)−1), the T⁰, the T^{-3/2}, the T^{1/2}, and the T^{3/2} are set to 0.]

3. The calculation method for an in-grain mobility μ_{in-grain}(T) of a semiconductor according to claim 1, wherein the β [K] is expressed by the following Expression (2):
$$β = h {{ω}_{o p} ( 2 π \cdot {k}_{B} )}^{- 1} , \qquad ( 2 )$$
[in Expression (2),
hωₒₚ/2π represents energy [eV] of an optical phonon that varies depending on a carrier concentration,
k_{B} represents a Boltzmann constant (8.617×10⁻⁵ [eV/K]), and
“h” represents a Planck constant (4.1357×10⁻¹⁵ [eVs]).]

4. The calculation method for an in-grain mobility μ_{in-grain}(T) of a semiconductor according to claim 2, wherein the a₁ [cm⁻²Vs] is a coefficient a₁(n) that varies depending on a carrier concentration “n” [cm⁻³], and the a₁(n) is expressed by the following Expression (3):
$${a}_{1} ( n ) = {A}_{1} * \frac{1}{1 + exp ( - {B}_{1} * ( log ( n ) - log ( {N}_{01} ) ) )} + {C}_{1} , \qquad ( 3 )$$
[in Expression (3),
“n” is a free carrier concentration [cm⁻³] (equal to a free electron density [cm⁻³] in the oxide semiconductor treated herein),
A₁ [cm⁻²Vs], B₁, and C₁ [cm⁻²Vs] each represent a coefficient, and
N₀₁ is a carrier concentration corresponding to an inflection point in Expression (3) represented by a₁(n).]

5. The calculation method for an in-grain mobility μ_{in-grain}(T) of a semiconductor according to claim 4, wherein the A₁ is equal to or greater than 0 cm⁻²Vs and equal to or less than 0.1 cm⁻²Vs, the B₁ is equal to or greater than 0, the C₁ is equal to or less than 1 cm⁻²Vs, and the N₀₁ is equal to or greater than 1×10¹⁸ cm⁻³ and equal to or less than 1×10²³ cm⁻³.

6. The calculation method for an in-grain mobility μ_{in-grain}(T) of a semiconductor according to claim 2, wherein the a₂ [cm⁻²Vs] is a coefficient a₂(n) that varies depending on a carrier concentration “n” [cm⁻³], and the a₂(n) is expressed by the following Expression (4):
$${a}_{2} ( n ) = {A}_{2} * \frac{1}{1 + exp ( {B}_{2} * ( log ( n ) - log ( {N}_{02} ) ) )} + {C}_{2} , \qquad ( 4 )$$
[in Expression (4),
“n” is a free carrier concentration [cm⁻³] (equal to a free electron density [cm⁻³] in the oxide semiconductor treated herein),
A₂ [cm⁻²Vs], B₂, and C₂ [cm⁻²Vs] are each a coefficient, and
N₀₂ is a carrier concentration corresponding to an inflection point in Expression (4) represented by a₂(n).

7. The calculation method for an in-grain mobility μ_{in-grain}(T) of a semiconductor according to claim 6, wherein the A₂ is equal to or greater than 0.005 cm⁻²Vs and equal to or less than 0.5 cm⁻²Vs, the B₂ is equal to or less than 1,000, the C₂ is less than 1×10⁻¹ cm⁻²Vs, and the N₀₂ is equal to or greater than 1×10¹⁷ cm⁻³ and equal to or less than 1×10²² cm⁻³.

8. The calculation method for an in-grain mobility μ_{in-grain}(T) of a semiconductor according to claim 2, wherein the a₃ [cm⁻²Vs·K^{3/2}] is a coefficient a₃(n) that varies depending on a carrier concentration “n” [cm⁻³], and the a₃(n) is expressed by the following Expression (5):
$${a}_{3} ( n ) = \frac{{A}_{3} {n}^{2}}{1 + exp ( - {B}_{3} ( log ( n ) - log ( {N}_{03} ) ) )} + \frac{{C}_{3}}{1 + exp ( {B}_{3} ( log ( n ) - log ( {N}_{03} ) ) )} \frac{1}{1 + {D}_{3} n} + {F}_{3} , \qquad ( 5 )$$
[in Expression (5),
“n” is a free carrier concentration [cm⁻³] (equal to a free electron density [cm⁻³] in the oxide semiconductor treated herein),
A₃ [cm⁻⁸Vs·K^{3/2}], B₃, C₃ [cm⁻²Vs·K^{3/2}], D₃ [cm⁻³], and F₃ [cm⁻²Vs·K^{3/2}] are each a coefficient, and
N₀₃ is a carrier concentration [cm⁻³] at a maximum value in Expression (5) represented by a₃(n).]

9. The calculation method for an in-grain mobility μ_{in-grain}(T) of a semiconductor according to claim 8, wherein the A₃ is equal to or greater than 10⁻³⁹ cm⁻⁸Vs·K^{3/2} and equal to or less than 10-33 cm⁻⁸Vs·K^{3/2}, the B₃ is equal to or greater than 1 and equal to or less than 5,000, the C₃ is less than 104 cm⁻²Vs·K^{3/2}, the D₃ is equal to or greater than 10⁻²⁰ cm⁻³, the F₃ is less than 500 cm⁻²Vs·K^{3/2}, and the Nos is equal to or greater than 1×10¹⁶ cm⁻³ and equal to or less than 1×10²⁰ cm⁻³

10. The calculation method for an in-grain mobility μ_{in-grain}(T) of a semiconductor according to claim 8, wherein the as is a coefficient a₃(n) that varies depending on a carrier concentration “n” [cm⁻³], and assuming that N₀₃ [cm⁻³] and N₁₃ [cm⁻³] are freely-selected carrier concentrations, the as (n) is expressed by the following Expression (5-1) when n<N₀₃ is satisfied, is satisfied expressed by the following Expression (5-2) when N₀₃≤n≤N₁₃ is satisfied, and expressed by the following Expression (5-3) when n>N₁₃ is satisfied:
$${a}_{3} ( n ) = {A}_{3}^{′} {n}^{2} \qquad ( 5 - 1 )$$
$${a}_{3} ( n ) = {B}_{3}^{′} \qquad ( 5 - 2 )$$
$${a}_{3} ( n ) = \frac{{C}_{3}^{′}}{1 + {D}_{3}^{′} n} , \qquad ( 5 - 3 )$$
[in Expression (5-1), Expression (5-2), and Expression (5-3),
“n” is a free carrier concentration [cm⁻³] (equal to a free electron density [cm⁻³] in the oxide semiconductor treated herein),
A′₃ [cm⁻⁸Vs·K^{3/2}], C′₃ [cm⁻²Vs·K^{3/2}], and D′3 [cm⁻³] are each a coefficient, and
B′3 [cm⁻²Vs·K^{3/2}] is a constant.]

11. The calculation method for an in-grain mobility μ_{in-grain}(T) of a semiconductor according to claim 10, wherein the A'₃ is equal to or greater than 10⁻³⁹ cm⁻⁸Vs·K^{3/2} and equal to or less than 10⁻³³ cm⁻⁸Vs·K^{3/2}, the C′3 is equal to or less than 5,000 cm⁻²Vs·K^{3/2}, and the D′3 is equal to or greater than 10⁻²⁰ cm⁻³.

12. The calculation method for an in-grain mobility μ_{in-grain}(T) of a semiconductor according to claim 2, wherein the a₄ [cm⁻²Vs·K^{-1/2}] is a coefficient that varies depending on a carrier concentration.

13. The calculation method for an in-grain mobility μ_{in-grain}(T) of a semiconductor according to claim 2, wherein the as [cm⁻²Vs·K^{-3/2}] is a coefficient that varies depending on a carrier concentration.

14. The calculation method for an in-grain mobility μ_{in-grain}(T) of a semiconductor according to claim 2, wherein the semiconductor comprises a non-degenerate semiconductor, the a₁ in Expression (1) is an optical phonon scattering constant Aₒₚ [cm⁻²Vs], the a₂ is a neutral impurity scattering coefficient Aₙₑᵤₜᵣₐₗ [cm⁻²Vs·K^{3/2}], the as is an ionized impurity scattering coefficient Aᵢₒₙ [cm⁻²Vs], the a₄ is a weak localization constant [cm⁻²Vs·K^{3/2}], and the as is an acoustic phonon scattering constant [cm⁻²Vs·K^{-3/2}].

15. The calculation method for an in-grain mobility μ_{in-grain}(T) of a semiconductor according to claim 1, wherein a coefficient of the 1/(exp(β/T)−1) term is a₁ [cm⁻²Vs], and is expressible by a mobility μₒₚ determined by an optical phonon scattering model, and a reciprocal of the mobility μₒₚ [cm²/Vs] determined by the optical phonon scattering model is expressed by the following Expression (A2):
$$\frac{1}{{μ}_{OP}} = {a}_{1} \frac{1}{exp ( \frac{β}{T} ) - 1} , \qquad ( A2 )$$
[in Expression (A2),
T is the temperature [K], and
β [K] is the coefficient.]

16. The calculation method for an in-grain mobility μ_{in-grain}(T) of a semiconductor according to claim 15, wherein the coefficient β [K] is expressible by the following expression:
$$β = ℏ {{ω}_{o p} ( {k}_{B} )}^{- 1} ,$$
[in the expression, [symbol]
Ωₒₚ is energy [eV] of an optical phonon that varies depending on a carrier concentration,
k_{B} is a Boltzmann constant (8.617×10⁻⁵ [eV/K]), and [symbol]
is a Dirac constant (6.58212×10⁻¹⁶ [eVs]).]

17. The calculation method for an in-grain mobility μ_{in-grain}(T) of a semiconductor according to claim 15, wherein the coefficient a₁ [cm⁻²Vs] is expressible by the following Expression (A2-1):
$${a}_{1} = {[ \frac{4 π {ε}_{0} {ℏ}^{2}}{em * {( 2 m * {ℏω}_{o p t} )}^{1 / 2}} / ( \frac{1}{{ε}_{opt}} - \frac{1}{{ε}_{r}} ) ]}^{- 1} , \qquad ( A2 - 1 )$$
[in Expression (A2-1),
ε₀ is a vacuum permittivity [F/cm], [symbol]
is a Dirac constant (6.58212×10⁻¹⁶ [eVs]),
“e” is an elementary charge [C],
m* is an effective mass [eV/c²] (“c” is the speed [cm/s] of light) normalized by the speed of light, [symbol]
ωₒₚ is energy [eV] of an optical phonon that varies depending on a carrier concentration,
hεₒₚₜ is a relative permittivity (optical), and
εᵣ is a relative permittivity (static).]

18. The calculation method for an in-grain mobility μ_{in-grain}(T) of a semiconductor according to claim 15, wherein the mobility μ_{OP} [cm²/Vs] determined by the optical phonon scattering model is expressible by the following Expression (A2-2):
$${μ}_{OP} = \frac{4 π {ε}_{0} {ℏ}^{2} [ exp ( \frac{{ℏω}_{o p t}}{{k}_{B} T} ) - 1 ]}{em * {( 2 m * {ℏω}_{o p t} )}^{1 / 2}} / ( \frac{1}{{ε}_{opt}} - \frac{1}{{ε}_{r}} ) , \qquad ( A2 - 2 )$$
[in Expression (A2-2),
ε₀ is a vacuum permittivity [F/cm], [symbol]
is a Dirac constant (6.58212×10⁻¹⁶ [eVs]),
“e” is an elementary charge [C],
m* is an effective mass [eV/c²] (“c” is the speed [cm/s] of light) normalized by the speed of light, [symbol]
ωₒₚ is energy [eV] of an optical phonon that varies depending on a carrier concentration,
k_{B} is a Boltzmann constant (8.617×10⁻⁵ [eV/K]),
T is the temperature [K],
εₒₚₜ is a relative permittivity (optical), and
εᵣ is a relative permittivity (static).]

19. The calculation method for an in-grain mobility μ_{in-grain}(T) of a semiconductor according to claim 1, wherein a coefficient of a T⁰ term is a₂ [cm⁻²Vs], and is expressible by any one or both of a reciprocal 1/μ_{NI} of a mobility μ_{NI} [cm²/Vs] determined by a neutral impurity scattering model and a reciprocal 1/μ_{II}^{(Deg)} of a mobility μ_{II}^{(Deg)} [cm²/Vs] determined by an ionized impurity scattering (degenerate) model.

20. The calculation method for an in-grain mobility μ_{in-grain}(T) of a semiconductor according to claim 19, wherein the mobility μ_{NI} [cm²/Vs] determined by the neutral impurity scattering model is expressible by a mobility model of an Erginsoy type, a mobility model of a Quisse type, or a mobility approximate expression of the Quisse type.

21. The calculation method for an in-grain mobility μ_{in-grain}(T) of a semiconductor according to claim 20, wherein the mobility μ_{NI} [cm²/Vs] determined by the mobility model of the Erginsoy type is expressed by the following Expression (A3E):
$${μ}_{NI} = \frac{m * {e}^{2}}{80 π {ε}_{0} {ε}_{r} {ℏ}^{3}} \times \frac{1}{{N}_{NI}} , \qquad ( A3E )$$
[in Expression (A3E),
m* is an effective mass [eV/c²] (“c” is the speed [cm/s] of light) normalized by the speed of light,
“e” is an elementary charge [C],
ε₀ is a vacuum permittivity [F/cm],
εᵣ is a relative permittivity (static), [symbol]
is a Dirac constant [eVs], and
N_{NI} is a neutral impurity scattering concentration [cm⁻³].]

22. The calculation method for an in-grain mobility μ_{in-grain}(T) of a semiconductor according to claim 20, wherein the mobility μ_{NI} [cm²/Vs] determined by the mobility model of the Quisse type is expressed by the following Expressions (Q-1) to (Q-26):
$${μ}_{NI} = \frac{q}{3 ℏ {N}_{NI}} \sqrt{\frac{2}{π}} {( \frac{{ℏ}^{2}}{m * {k}_{B} T} )}^{\frac{5}{2}} {\int }_{0}^{∞} \frac{{k}^{3}}{Q} exp ( - \frac{{ℏ}^{2} {k}^{2}}{2 m * {k}_{B} T} ) dk \qquad ( Q - 1 )$$
$$Q = \frac{4 π}{{k}^{2}} \frac{{( \overline{α} - \overline{L} / k )}^{2}}{1 + {( \overline{α} - \overline{L} / k )}^{2}} \qquad ( Q - 2 )$$
$$\overline{L} = L ( \overline{α} , \overline{β} ) \qquad ( Q - 3 )$$
$$L = - ( {α}^{2} {F}_{1} + {β}^{2} {F}_{2} + α {F}_{3} + β {F}_{4} + αβ {F}_{5} + {F}_{6} ) . \qquad ( Q - 4 )$$
$$\overline{α} = \frac{{F}_{4} {F}_{5} - 2 {F}_{2} {F}_{3} - 2 {kF}_{2}}{4 {F}_{1} {F}_{2} - {F}_{5}^{2}} , \qquad ( Q - 5 )$$
$$\overline{β} = \frac{{F}_{3} {F}_{5} - 2 {F}_{1} {F}_{4} + {kF}_{2}}{4 {F}_{1} {F}_{2} - {F}_{5}^{2}} . \qquad ( Q - 6 )$$
$${F}_{1} = 2 γ {H}_{31} ( {q}_{8} ) + 2 δ {H}_{31} ( 2 a ) - kI ( a ) + kI ( 2 a ) - J ( 2 a ) + 2 ζ ( J ( 4 a ) - 2 J ( 3 a ) + J ( 2 a ) ) , \qquad ( Q - 7 )$$
$${F}_{2} = 2 γ {H}_{33} ( {q}_{8} ) + 2 δ {H}_{33} ( 2 a ) + kI ( a ) - 3 kI ( 3 a ) + 2 kI ( 4 a ) + J ( 2 a ) - 5 J ( 3 a ) + 4 J ( 4 a ) + 2 ζ ( J ( 4 a ) + J ( 6 a ) - 2 J ( 5 a ) ) , \qquad ( Q - 8 )$$
$${F}_{3} = 2 γ ( M ( {q}_{8} , 0 ) - M ( {q}_{8} , a ) ) + 2 δ ( M ( 2 a , 0 ) - M ( 2 a , a ) ) - \frac{1}{2} I ( a ) - 2 kK ( a ) + 2 ζ ( I ( 2 a ) - I ( 3 a ) ) , \qquad ( Q - 9 )$$
$${F}_{4} = 2 γ ( M ( {q}_{8} , a ) - M ( {q}_{8} , 2 a ) ) + 2 δ ( M ( 2 a , a ) - M ( 2 a , 2 a ) ) - \frac{1}{2} I ( a ) - 2 I ( 2 a ) 2 kK ( a ) - 4 kK ( 2 a ) + 2 ζ ( - I ( 4 a ) + I ( 3 a ) ) , \qquad ( Q - 10 )$$
$${F}_{5} = 4 γ {H}_{32} ( {q}_{8} ) + 4 δ {H}_{32} ( 2 a ) + kI ( a ) - 4 kI ( 2 a ) + 3 kI ( 3 a ) + J ( a ) - 6 J ( 2 a ) + 5 J ( 3 a ) + 2 ζ ( - 4 J ( 4 a ) + 2 J ( 5 a ) + 2 J ( 3 a ) ) , \qquad ( Q - 11 )$$
$${F}_{6} = 2 ( γ {H}_{1} ( {q}_{8} ) + δ {H}_{1} ( 2 a ) + ζ K ( 2 a ) ) , \qquad ( Q - 12 )$$
$$\text{?} \qquad ( Q - 13 )$$
$$\text{?} \qquad ( Q - 14 )$$
$$\text{?} \qquad ( Q - 15 )$$
$${H}_{1} ( x ) = \text{?} \qquad ( Q - 16 )$$
$$I ( x ) = \text{?} \qquad ( Q - 17 )$$
$$J ( x ) = \text{?} \qquad ( Q - 18 )$$
$$K ( x ) = \text{?} \qquad ( Q - 19 )$$
$$M ( x , y ) = \text{?} = arctan ( \frac{2 k}{x + y} ) \qquad ( Q - 20 )$$
$$γ = \frac{{q}_{8}^{2} ( {q}_{8}^{2} - 8 {a}^{2} )}{{( {q}_{8}^{2} - 4 {a}^{2} )}^{2}} , \qquad ( Q - 21 )$$
$$δ = \frac{16 {a}^{4}}{{( {q}_{8}^{2} - 4 {a}^{2} )}^{2}} , \qquad ( Q - 22 )$$
$$ζ = \frac{4 {a}^{3}}{4 {a}^{2} - {q}_{8}^{2}} , \qquad ( Q - 23 )$$
$$\frac{1}{a} = {a}_{0} \frac{1 + ( 8 / 5 ) {( {a}_{0} {q}_{8} / 4 )}^{5 / 2}}{1 + {( {a}_{0} {q}_{8} / 4 )}^{5 / 2}} . \qquad ( Q - 24 )$$
$${a}_{0} = \frac{4 π {ε}_{r} {ε}_{0} {ℏ}^{2}}{m * {q}^{2}} \qquad ( Q - 25 )$$
$${q}_{s} = \sqrt{\frac{{q}^{2} n}{{ε}_{r} {ε}_{0} k B T}} , \qquad ( Q - 26 )$$
$$\text{?} \text{indicates text missing or illegible when filed}$$
[in Expressions (Q-1) to (Q-26),
μ_{NI} is the mobility [cm²/Vs] determined by the mobility model of the Quisse type,
N_{NI} is a neutral impurity concentration [cm⁻³],
“k” is a wave number vector [cm⁻¹],
“q” is an elementary charge [C], [symbol]
is a Dirac constant [eVs],
m* is an effective mass [eV/c²] (“c” is the speed [cm/s] of light) normalized by the speed of light,
k_{B} is a Boltzmann constant [eV/K],
T is the temperature [K],
Q is a total scattering cross section [cm²],
L is a trial wave function,
L̅ is a minimum value of the trial wave function,
α is a phase parameter,
α̅ is a phase parameter at the minimum value L̅ of the trial wave function,
β is a variational parameter,
β̅ is a variational parameter at the minimum value L̅ of the trial wave function,
F₁ to F₆ are components of respective terms that form the trial wave function L,
H₃₁(x, a) is a constituent component of F₁,
H₃₂(x, a) is a constituent component of F₅,
H₃₃(x, a) is a constituent component of F₂,
H₁(x) is a constituent component of F₆,
I(x) is a constituent component of each of F₁ to F₅,
J(x) is a constituent component of each of F₁, F₂, and F₅,
K(x) is a constituent component of each of F₃, F₄, and F₆,
M(x, y) is a constituent component of each of F₃ and F₄,
“x” and “y” are variables,
“a” is a reciprocal of an effective Bohr radius,
γ is a constituent component of each of F₁ to F₆,
δ is a constituent component of each of F₁ to F₆,
ζ is a constituent component of each of F₁ to F₆,
a₀ is a Bohr radius [cm],
qₛ is a Debye screening parameter [cm⁻¹],
εᵣ is a relative permittivity (static), and
ε₀ is a vacuum permittivity [F/cm].]

23. The calculation method for an in-grain mobility μ_{in-grain}(T) of a semiconductor according to claim 20, wherein the mobility μ_{NI} [cm²/Vs] determined by the mobility model of the Quisse type is expressible by the following Approximate Expression (A3Q-app):
$${μ}_{NI} = \frac{e}{3 ℏ {N}_{NI}} \sqrt{\frac{2}{π}} \frac{{( 2 {a}_{0}^{2} C )}^{\frac{5}{2}}}{2 π {a}_{0}^{6}} 〈 - \frac{1}{D {C}^{2}} [ ( C {k}_{1}^{′ 2} + 1 ) exp ( - C {k}_{1}^{′ 2} ) - 1 ] + \frac{1}{4 {C}^{\frac{7}{2}}} \{ [ {( C {k}_{1}^{′ 2} )}^{\frac{5}{2}} + \frac{5}{2} {( C {k}_{1}^{′ 2} )}^{\frac{3}{2}} + \frac{15}{2} {( C {k}_{1}^{′ 2} )}^{\frac{1}{2}} ] exp ( - C {k}_{1}^{′ 2} ) + \frac{15}{8} \sqrt{π} ( 1 - erf ( \sqrt{- {Ck}_{1}^{′ 2}} ) ) \} 〉$$
[in Expression (A3Q-app),
μ_{NI} is a mobility [cm⁻²Vs] regarding neutral impurity scattering determined by an approximate analytical expression of the Quisse type,
a₀ is a Bohr radius [cm], and is expressed by the following expression:
$${a}_{0} = \frac{4 {π}^{2} {ℏ}^{2} {ε}_{0} {ε}_{r}}{{m}^{*} {e}^{2}} ,$$
(in the expression, [symbol]
is a Dirac constant [eVs],
ε₀ is a vacuum permittivity [F/cm],
εᵣ is a relative permittivity (static),
m* is an effective mass [eV/c²] (“c” is the speed [cm/s] of light) normalized by the speed of light, and
“e” is an elementary charge [C]),
C is expressed by the following expression:
$$C = \frac{{ℏ}^{2}}{2 {a}_{0}^{2} {m}^{*} {k}_{B} T} ,$$
(in the expression, [symbol] , a₀, and m* are as described above,
k_{B} is a Boltzmann constant [eV/K], and
T is the temperature [K]),
D is an empirical Q/πa₀² value (a function of qₛa₀) [cm²] at k=0 in a Quisse model.
k′₁ is an intersection point (ka₀ value) of D (upper base of a right trapezoid) and 4 (ka₀)⁻³ (hypotenuse of the right trapezoid) on a Q/πa₀²-ka₀ graph of the Quisse model,
N_{NI} is a neutral impurity scattering concentration [cm⁻³], and
h is the Dirac constant [eVs].]

24. The calculation method for an in-grain mobility μ_{in-grain}(T) of a semiconductor according to claim 19, wherein the mobility μ_{II}^{(Deg)} [cm²/Vs] determined by the ionized impurity scattering (degenerate) model is expressible by a mobility model of a Dingle type.

25. The calculation method for an in-grain mobility μ_{in-grain}(T) of a semiconductor according to claim 19, wherein the mobility μ_{II}^{(Deg)} [cm²/Vs] determined by the ionized impurity scattering (degenerate) model is expressible by the following Mobility Expression (A4D) of a Dingle type:
$${μ}_{II}^{( Deg )} = \frac{24 {{π}^{3} ( {ε}_{0} {ε}_{r} )}^{2} {ℏ}^{3}}{{Z}^{2} {m}^{* 2} {e}^{3} {F}_{II}} \times \frac{n}{{N}_{II\_Deg}} , \qquad ( A4D )$$
[in Expression (A4D),
ε₀ is a vacuum permittivity [F/cm],
εᵣ is a relative permittivity (static), [symbol]
is a Dirac constant [eVs],
Z¹ is an ionic valence of an ionized impurity,
m* is an effective mass [eV/c²] (“c” is the speed [cm/s] of light) normalized by the speed of light,
F_{II} is a screening function in ionized impurity scattering,
“n” is a free carrier concentration [cm⁻³] (equal to a free electron density [cm⁻³] in the oxide semiconductor treated herein), and
N_{II_Deg} is an ionized impurity concentration (degenerate) [cm⁻³].]

26. The calculation method for an in-grain mobility μ_{in-grain}(T) of a semiconductor according to claim 19, wherein the mobility μ_{II}^{(Deg)} [cm²/Vs] determined by the ionized impurity scattering (degenerate) model is of a Dingle type, and is further expressible by the following Mobility Expression (A4-1), which takes into account a self-formation process of donors:
$${μ}_{II}^{( Deg )} = \frac{24 {{π}^{3} ( {ε}_{0} {ε}_{r} )}^{2} {ℏ}^{3}}{{m}^{* 2} {e}^{3} {F}_{II}} \times \frac{1}{{Z}^{2} ( \frac{{N}_{II\_Deg}}{n} + \frac{1}{Z} )} \qquad ( A4 - 1 ) ,$$
[in Expression (A4-1),
ε₀ is a vacuum permittivity [F/cm],
εᵣ is a relative permittivity (static), [symbol]
is a Dirac constant [eVs],
m* is an effective mass [eV/c²] (“c” is the speed [cm/s] of light) normalized by the speed of light,
“e” is an elementary charge [C],
F_{II} is a screening function in ionized impurity scattering,
Z is an ionic valence of an ionized impurity,
N_{II_Deg} is an ionized impurity concentration (degenerate) [cm⁻³], and
“n” is a free carrier concentration [cm⁻³] (equal to a free electron density [cm⁻³] in the oxide semiconductor treated herein).]

27. The calculation method for an in-grain mobility μ_{in-grain}(T) of a semiconductor according to claim 25, wherein the screening function F_{II} in Mobility Expression (A4D) or (A₄-1) of the Dingle type comprises a screening function F_{II} in the ionized impurity scattering of a Pisarkiewicz type, which is expressed by the following Expression (F):
$${F}_{II} = [ 1 + \frac{4 {ξ}_{np}}{{ξ}_{d}} ( 1 - \frac{{ξ}_{np}}{8} ) ] ln ( 1 + {ζ}_{d} ) - \frac{{ξ}_{d}}{1 + {ξ}_{d}} - 2 {ξ}_{n p} ( 1 - \frac{5 {ξ}_{np}}{16} ) , \qquad ( F )$$
[in Expression (F),
ξₙₚ is an additional screening parameter in F_{II} for accommodating an effective mass change, and is expressed by the following expression:
$${ξ}_{np} = 1 - \frac{{m}_{0}^{*}}{{m}^{*}} ,$$
(in the expression,
m* is the effective mass [eV/c²] (“c” is the speed [cm/s] of light) normalized by the speed of light,
m₀* is a minimum value of the effective mass at a bottom of a conduction band or a top of a valence band), and
ξ_{d} is a reduced screening parameter in F_{II}, and is expressed by the following expression:
$${ξ}_{d} = {( 3 {π}^{2} n )}^{1 / 3} \frac{4 {π}^{2} {ℏ}^{2} {ε}_{0} {ε}_{r}}{{m}^{*} {e}^{2}} ,$$
(in the expression,
“n” is the free carrier concentration [cm⁻³] (equal to a free electron density [cm⁻³] in the oxide semiconductor treated herein), [symbol]
is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is an elementary charge [C]).]

28. The calculation method for an in-grain mobility μ_{in-grain}(T) of a semiconductor according to claim 25, wherein, assuming that a mobility expression of the Dingle type expressed by Expression (A4D) or (A₄-1) is μ_{II_Dingle}^{(Deg)} [cm²/Vs], the mobility μ_{II}^{(Deg)} [cm²/Vs] determined by the ionized impurity scattering (degenerate) model is expressible by the following Expression (A4-S) of a sigmoid function type with respect to a carrier concentration “n”:
$${μ}_{II}^{( Deg )} = \frac{{μ}_{II\_Dingle}^{( Deg )}}{1 + {( \frac{{N}_{C}}{n} )}^{+ a}} , \qquad ( A4 - S )$$
[in Expression (A4-S),
N_{C} is an effective density [cm⁻³] of states,
“n” is a free carrier concentration [cm⁻³] (equal to a free electron density [cm⁻³] in the oxide semiconductor treated herein), and
“a” is a parameter representing a rate of change of a sigmoid function.]

29. The calculation method for an in-grain mobility μ_{in-grain}(T) of a semiconductor according to claim 1, wherein a coefficient of the T^{-3/2} term is a₃ [cm⁻²VsK^{3/2}], and a product of the coefficient a₃ and T^{-3/2} is expressible by a reciprocal 1/μ_{II}^{(nonDeg)} of a mobility μ_{II}^{(nonDeg)} [cm⁻²Vs] determined by an ionized impurity scattering (non-degenerate) model.

30. The calculation method for an in-grain mobility μ_{in-grain}(T) of a semiconductor according to claim 29, wherein the mobility μ_{II}^{(nonDeg)} [cm²/Vs] determined by the ionized impurity scattering (non-degenerate) model is expressible by a mobility expression of a Conwell-Weisskopf model type or a Brooks-Herring model type.

31. The calculation method for an in-grain mobility μ_{in-grain}(T) of a semiconductor according to claim 29, wherein the mobility μ_{II}^{(nonDeg)} [cm²/Vs] determined by the ionized impurity scattering (non-degenerate) model is expressible by the following Mobility Expression (A5-CW) of the Conwell-Weisskopf model type:
$${μ}_{II}^{( nonDeg )} = \frac{128 \sqrt{2 π} {( {ε}_{0} {ε}_{r} )}^{2} {( {k}_{B} T )}^{3 / 2}}{\sqrt{{m}^{*}} {e}^{3}} \times \frac{1}{{Z}^{2} {N}_{{II}_{-} nonDeg}} \times {\{ ln [ 1 + {( \frac{12 π {ε}_{0} {ε}_{r} {k}_{B} T}{{e}^{3} Z {N}_{II\_nonDeg}^{1 / 3}} )}^{2} ] \}}^{- 1} , \qquad ( A5 - CW )$$
[in Expression (A5-CW),
ε₀ is a vacuum permittivity [F/cm],
εᵣ is a relative permittivity (static),
k_{B} is a Boltzmann constant [eV/K],
T is the temperature [K],
m* is an effective mass [eV/c²] (“c” is the speed [cm/s] of light) normalized by the speed of light,
“e” is an elementary charge [C],
Z is an ionic valence of an ionized impurity, and
N_{II_nonDeg} is an ionized impurity concentration [cm⁻³].]

32. The calculation method for an in-grain mobility μ_{in-grain}(T) of a semiconductor according to claim 29, wherein the mobility μ_{II}^{(nonDeg)} [cm²/Vs] determined by the ionized impurity scattering (non-degenerate) model is expressible by the following Mobility Expression (A5-BH) of the Brooks-Herring model type:
$${μ}_{II}^{( n onDeg )} = \frac{128 \sqrt{2 π} {( {ε}_{0} {ε}_{r} )}^{2} {( {k}_{B} T )}^{3 / 2}}{\sqrt{{m}^{*}} {e}^{3}} \times \frac{1}{{Z}^{2} {N}_{{II}_{non} Deg}} \times \frac{1}{{F}_{II}} , \qquad ( A5 - BH )$$
[in Expression (A5-BH),
F_{II} is a screening function in ionized impurity scattering,
ε₀ is a vacuum permittivity [F/cm],
εᵣ is a relative permittivity (static),
k_{B} is a Boltzmann constant [eV/K],
T is the temperature [K],
m* is an effective mass [eV/c²] (“c” is the speed [cm/s] of light) normalized by the speed of light,
“e” is an elementary charge [C],
Z is an ionic valence of an ionized impurity, and
N_{II_nonDeg} is an ionized impurity concentration [cm⁻³].]

33. The calculation method for an in-grain mobility μ_{in-grain}(T) of a semiconductor according to claim 32, wherein the screening function Fu in a mobility expression of the Brooks-Herring model type comprises a screening function Fu in the ionized impurity scattering of a Pisarkiewicz type, which is expressed by the following Expression (F):
$${F}_{II} = [ 1 + \frac{4 {ξ}_{n p}}{{ξ}_{d}} ( 1 - \frac{{ξ}_{n p}}{8} ) ] ln ( 1 + {ξ}_{d} ) - \frac{{ξ}_{d}}{1 + {ξ}_{d}} - 2 {ξ}_{n p} ( 1 - \frac{5 {ξ}_{n p}}{16} ) , \qquad ( F )$$
[in Expression (F),
ξ_{d} is a reduced screening parameter in F_{II}, and is expressed by the following expression:
$${ξ}_{d} = {( 3 {π}^{2} n )}^{1 / 3} \frac{4 {π}^{2} {ℏ}^{2} {ε}_{0} {ε}_{r}}{{m}^{*} {e}^{2}} ,$$
(in the expression,
“n” is a free carrier concentration [cm⁻³] (equal to a free electron density [cm⁻³] in the oxide semiconductor treated herein), [symbol]
is a Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]), and
ξₙₚ is an additional screening parameter in Fu for accommodating an effective mass change, and is expressed by the following expression:
$${ξ}_{np} = 1 - \frac{{m}_{0}^{*}}{{m}^{*}} ,$$
(in the expression,
m₀* is a minimum value of the effective mass at a bottom of a conduction band or a top of a valence band, and
m* is the effective mass [eV/c²] (“c” is the speed [cm/s] of light) normalized by the speed of light).]

34. The calculation method for an in-grain mobility μ_{in-grain}(T) of a semiconductor according to claim 31, wherein, assuming that a mobility determined by an ionized impurity scattering (non-degenerate) model that is expressible by a mobility expression of the Conwell-Weisskopf model type or the Brooks-Herring model type is μ_{II_CW-BH}^{(nonDeg)} [cm²/Vs], the mobility μ_{II}^{(nonDeg)} [cm²/Vs] determined by the ionized impurity scattering (non-degenerate) model is expressible by the following Expression (A5-S) of a sigmoid function type with respect to a carrier concentration “n”:
$${μ}_{II}^{( nonDeg )} = \frac{{μ}_{{II}_{C W - B H}}^{( n o n D e g )}}{1 + {( \frac{{N}_{C}}{n} )}^{- a}} , \qquad ( A5 - S )$$
[in Expression (A5-S),
N_{C} is an effective density [cm⁻³] of states,
“n” is a free carrier concentration [cm⁻³] (equal to a free electron density [cm⁻³] in the oxide semiconductor treated herein), and
“a” is a parameter representing a rate of change of a sigmoid function.]

35. The calculation method for an in-grain mobility μ_{in-grain}(T) of a semiconductor according to claim 1, wherein the reciprocal of the in-grain mobility μ_{in-grain}(T) of the semiconductor is expressed as the linear combination of two or more terms selected from the group consisting of 1/(exp(β/T)−1), T⁰, T^{-3/2}, T^{1/2}, T^{3/2}, T¹, and T², and further, a 1/μ_{NI}(T, n) term, of which a temperature dependence is a function of a carrier concentration “n”, is linearly combined,
[where β [K] is a coefficient].

36. The calculation method for an in-grain mobility μ_{in-grain}(T) of a semiconductor according to claim 35, wherein the 1/μ_{NI}(T, n) term is expressed by the following Expressions (Q-1) to (Q-26) determined by a mobility model of a Quisse type:
$${μ}_{NI} = \frac{q}{3 ℏ {N}_{NI}} \sqrt{\frac{2}{π}} {( \frac{{ℏ}^{2}}{{m}^{*} {k}_{B} T} )}^{\frac{5}{2}} {\int }_{0}^{∞} \frac{{k}^{3}}{Q} exp ( - \frac{{ℏ}^{2} {k}^{2}}{2 {m}^{*} {k}_{B} T} ) dk \qquad ( Q - 1 )$$
$$Q = \frac{4 π}{{k}^{2}} \frac{{( \overline{α} - \overline{L} / k )}^{2}}{1 + {( \overline{α} - \overline{L} / k )}^{2}} \qquad ( Q - 2 )$$
$$\overline{L} = L ( \overline{α} , \overline{β} ) \qquad ( Q - 3 )$$
$$L = - ( {α}^{2} {F}_{1} + {β}^{2} {F}_{2} + α {F}_{3} + β {F}_{4} + α β {F}_{5} + {F}_{6} ) . \qquad ( Q - 4 )$$
$$\overline{α} = \frac{{F}_{4} {F}_{5} - 2 {F}_{2} {F}_{3} - 2 {kF}_{2}}{4 {F}_{1} {F}_{2} - {F}_{5}^{2}} , \qquad ( Q - 5 )$$
$$\overline{β} = \frac{{F}_{3} {F}_{5} - 2 {F}_{1} {F}_{4} + {kF}_{5}}{4 {F}_{1} {F}_{2} - {F}_{5}^{2}} . \qquad ( Q - 6 )$$
$${F}_{1} = 2 γ {H}_{31} ( {q}_{s} ) + 2 δ {H}_{31} ( 2 a ) - kI ( a ) + kI ( 2 a ) - J ( 2 a ) + 2 ζ ( J ( 4 a ) - 2 J ( 3 a ) + J ( 2 a ) ) , \qquad ( Q - 7 )$$
$${F}_{2} = 2 γ {H}_{33} ( {q}_{s} ) + 2 δ {H}_{33} ( 2 a ) + kI ( a ) - 3 kI ( 3 a ) + 2 kI ( 4 a ) + J ( 2 a ) - 5 J ( 3 a ) + 4 J ( 4 a ) + 2 ζ ( J ( 4 a ) + J ( 6 a ) - 2 J ( 5 a ) , \qquad ( Q - 8 )$$
$${F}_{3} = 2 γ ( M ( {q}_{s} , 0 ) - M ( {q}_{s} , a ) + 2 δ ( M ( 2 a , 0 ) - M ( 2 a , a ) ) - \frac{1}{2} I ( a ) - 2 kK ( a ) + 2 ζ ( I ( 2 a ) - I ( 3 a ) ) , \qquad ( Q - 9 )$$
$${F}_{4} = 2 γ ( M ( {q}_{s} , 0 ) - M ( {q}_{s} , 2 a ) + 2 δ ( M ( 2 a , a ) - M ( 2 a , a ) ) + \frac{1}{2} I ( a ) - 2 I ( 2 a ) + 2 kK ( a ) - 4 kK ( 2 a ) + 2 ζ ( - I ( 4 a ) + I ( 3 a ) ) , \qquad ( Q - 10 )$$
$${F}_{5} = 4 γ {H}_{32} ( {q}_{s} ) + 4 δ {H}_{32} ( 2 a ) + kI ( a ) - 4 kI ( 2 a ) + 3 kI ( 3 a ) + J ( a ) - 6 J ( 2 a ) + 5 J ( 3 a ) + 2 ζ ( - 4 J ( 4 a ) + 2 J ( 5 a ) + 2 J ( 3 a ) ) , \qquad ( Q - 11 )$$
$${F}_{6} = 2 ( γ {H}_{1} ( {q}_{s} ) + δ {H}_{1} ( 2 a ) + ζ K ( 2 a ) ) , \qquad ( Q - 12 )$$
$${H}_{33} ( x , a ) = {\int }_{0}^{∞} \frac{e \text{?}}{r} {( 1 - e \text{?} )}^{2} {cos}^{2} kr dr = \frac{1}{4} ln ( \frac{{( x + a )}^{4} {( {( x + a )}^{2} + 4 {k}^{2} )}^{2}}{{x}^{2} ( {x}^{2} + 4 {k}^{2} ) {( x + 2 a )}^{2} ( {( x + 2 a )}^{2} + 4 {k}^{2} )} ) , \qquad ( Q - 13 )$$
$${H}_{32} ( x , a ) = {\int }_{0}^{∞} \frac{e \text{?}}{r} {( 1 - e \text{?} )}^{2} {cos}^{2} kr dr = \frac{1}{4} ln ( \frac{{( x + 2 a )}^{4} {( {( x + 2 a )}^{2} + 4 {k}^{2} )}^{2}}{{( x + a )}^{2} ( {( x + a )}^{2} + 4 {k}^{2} ) {( x + 3 a )}^{2} ( {( x + 3 a )}^{2} + 4 {k}^{2} )} ) , \qquad ( Q - 14 )$$
$${H}_{33} ( x , a ) = {\int }_{0}^{∞} \frac{e \text{?}}{r} {( 1 - e \text{?} )}^{2} {cos}^{2} kr dr = \frac{1}{4} ln ( \frac{{( x + 3 a )}^{4} {( {( x + 3 a )}^{2} + 4 {k}^{2} )}^{2}}{{( x + 2 a )}^{2} ( {( x + 2 a )}^{2} + 4 {k}^{2} ) {( x + 4 a )}^{2} ( {( x + 4 a )}^{2} + 4 {k}^{2} )} ) , \qquad ( Q - 15 )$$
$${H}_{1} ( x ) = {\int }_{0}^{∞} \frac{e \text{?}}{r} {sin}^{2} kr dr = \frac{1}{4} ln ( \frac{{x}^{2} + 4 {k}^{2}}{{x}^{2}} ) , \qquad ( Q - 16 )$$
$$I ( x ) = {\int }_{0}^{∞} e \text{?} {sin}^{2} 2 kr dr = ( \frac{2 k}{{x}^{2} + 4 {k}^{2}} ) , \qquad ( Q - 17 )$$
$$J ( x ) = {\int }_{0}^{∞} e \text{?} {cos}^{2} kr dr = \frac{1}{{x}^{2} + 4 {k}^{2}} ( x + \frac{2 {k}^{2}}{x} ) , \qquad ( Q - 18 )$$
$$K ( x ) = {\int }_{0}^{∞} e \text{?} {sin}^{2} kr dr = \frac{1}{x} - J ( x ) , \qquad ( Q - 19 )$$
$$M ( x , y ) = {\int }_{0}^{∞} \frac{e \text{?}}{r} sin 2 kr dr = arctan ( \frac{2 k}{x + y} ) \qquad ( Q - 20 )$$
$$γ = \frac{{q}_{s}^{2} ( {q}_{s}^{2} - 8 {a}^{2} )}{{( {q}_{s}^{2} - 4 {a}^{2} )}^{2}} , \qquad ( Q - 21 )$$
$$δ = \frac{16 {a}^{4}}{{( {q}_{s}^{2} - 4 {a}^{2} )}^{2 s}} , \qquad ( Q - 22 )$$
$$ζ = \frac{4 {a}^{3}}{4 {a}^{2} - {q}_{s}^{2}} , \qquad ( Q - 23 )$$
$$\frac{1}{a} = {a}_{0} \frac{1 + ( 8 / 5 ) {( {a}_{0} {q}_{s} / 4 )}^{6 / 2}}{1 + {( {a}_{0} {q}_{s} / 4 )}^{3 / 2}} , \qquad ( Q - 24 )$$
$${a}_{0} = \frac{4 {πε}_{r} {ε}_{0} {ℏ}^{2}}{{m}^{*} {q}^{2}} \qquad ( Q - 25 )$$
$${q}_{s} = \sqrt{\frac{{q}^{2} n}{{ε}_{r} {ε}_{0} kBT}} , \qquad ( Q - 26 )$$
$$\text{?} \text{indicates text missing or illegible when filed}$$
[in Expressions (Q-1) to (Q-26),
μ_{NI} is a mobility [cm²/Vs] determined by a Quisse model,
N_{NI} is a neutral impurity concentration [cm⁻³],
“k” is a wave number vector [cm-1],
“q” is an elementary charge [C], [symbol]
is a Dirac constant [eVs],
m* is an effective mass [eV/c²] (“c” is the speed [cm/s] of light) normalized by the speed of light,
k_{B} is a Boltzmann constant [eV/K],
T is the temperature [K],
Q is a total scattering cross section [cm²],
L is a trial wave function,
L̅ is a minimum value of the trial wave function,
α is a phase parameter,
α̅ is a phase parameter at the minimum value L of the trial wave function,
β is a variational parameter,
β̅ is a variational parameter at the minimum value L of the trial wave function,
F₁ to F₆ are components of respective terms that form the trial wave function L,
H₃₁(x, a) is a constituent component of F₁,
H₃₂(x, a) is a constituent component of F₅,
H₃₃(x, a) is a constituent component of F₂,
H₁(x) is a constituent component of F₆,
I(x) is a constituent component of each of F₁ to F₅,
J(x) is a constituent component of each of F₁, F₂, and F₅,
K(x) is a constituent component of each of F₃, F₄, and F₆,
M(x, y) is a constituent component of each of F₃ and F₄,
“x” and “y” are variables,
“a” is a reciprocal of an effective Bohr radius,
γ is a constituent component of each of F₁ to F₆,
δ is a constituent component of each of F₁ to F₆,
ζ is a constituent component of each of F₁ to F₆,
a₀ is a Bohr radius [cm],
qₛ is a Debye screening parameter [cm⁻¹],
εᵣ is a relative permittivity (static), and
ε₀ is a vacuum permittivity [F/cm].]

37. The calculation method for an in-grain mobility μ_{in-grain}(T) of a semiconductor according to claim 35, wherein the 1/μ_{NI}(T, n) term is expressed by the following Approximate Expression (A5Q-app) determined by a mobility model of a Quisse type:
$${μ}_{NI} ( T , n ) = \frac{e}{3 ℏ {N}_{NI}} \sqrt{\frac{2}{π}} \frac{{( 2 {a}_{0}^{2} C )}^{\frac{5}{2}}}{2 π {a}_{0}^{6}} 〈 - \frac{1}{{DC}^{2}} [ ( {Ck}_{1}^{{′}^{2}} + 1 ) exp ( - {Ck}_{1}^{{′}^{2}} ) - 1 ] + \frac{1}{4 {C}^{\frac{7}{2}}} \{ [ {( {Ck}_{1}^{{′}^{2}} )}^{\frac{5}{2}} + \frac{5}{2} {( {Ck}_{1}^{{′}^{2}} )}^{\frac{3}{2}} + \frac{15}{2} {( {Ck}_{1}^{{′}^{2}} )}^{\frac{1}{2}} ] exp ( - {Ck}_{1}^{{′}^{2}} ) + \frac{15}{8} \sqrt{π} ( 1 - erf ( \sqrt{- {Ck}_{1}^{{′}^{2}}} ) ) \} 〉 , \qquad ( A5Q - app )$$
[in Expression (A5Q-app),
μ_{NI}(T, n) is a mobility [cm²/Vs] regarding neutral impurity scattering determined by an approximate analytical expression of the Quisse type, and (T, n) means that μ_{NI} is a function of the temperature T and a free carrier concentration “n”,
a₀ is a Bohr radius [cm], and is expressed by the following expression:
$${a}_{0} = \frac{4 {π}^{2} {ℏ}^{2} {ε}_{0} {ε}_{r}}{{m}^{*} {e}^{2}} ,$$
(in the expression, [symbol]
is a Dirac constant [eVs],
ε₀ is a vacuum permittivity [F/cm],
εᵣ is a relative permittivity (static),
m is an effective mass [eV/c²] (“c” is the speed [cm/s] of light) normalized by the speed of light, and
“e” is an elementary charge [C]),
C is expressed by the following expression:
$$C = \frac{{ℏ}^{2}}{2 {a}_{0}^{2} {m}^{*} {k}_{B} T} ,$$
(in the expression, [symbol] , a₀, and m* are as described above,
k_{B} is a Boltzmann constant [eV/K], and
T is the temperature [K]),
D is an empirical Q/πa₀² value (a function of qₛa₀) [cm²] at k=0 in a Quisse model.
k′₁ is a ka₀ value at an intersection point of Q/πa₀²-D (upper base of a right trapezoid) and Q/πa₀²=4(ka₀)⁻³ (hypotenuse of the right trapezoid) on a Q/πa₀²−ka₀ graph of the Quisse model,
N_{NI} is a neutral impurity scattering concentration [cm⁻³], and
h is the Dirac constant [eVs].]

38. The calculation method for an in-grain mobility μ_{in-grain}(T) of a semiconductor according to claim 17, wherein the effective mass m* is expressible by any one of the following Expression (M-1) or (M-2):
$${m}^{*} = {m}_{0}^{*} ( 1 + 2 {α}^{′} E ) \qquad ( M - 1 )$$
$${m}^{*} = {m}_{0}^{*} {\{ 1 + 2 {α}^{′} \frac{{{ℏ}^{2} ( 3 {π}^{2} n )}^{\frac{2}{3}}}{{m}_{0}^{*}} \}}^{\frac{1}{2}} , \qquad ( M - 2 )$$
[in Expressions (M-1) and (M-2),
m* is the effective mass [eV/c²] (“c” is the speed [cm/s] of light) normalized by the speed of light,
m₀* is a minimum value [eV/c²] of the effective mass at a bottom of a conduction band or a top of a valence band (“c” is the speed [cm/s] of light),
α′ is a non-parabolicity coefficient regarding a band curvature of the conduction band or valence electrons (where a′>0 is satisfied; an E-k band in a wave number “k” space is parabolic when α′=0 is satisfied, and becomes non-parabolic and expands when a′ increases),
E is energy [eV],
“n” is a free carrier concentration [cm⁻³] (equal to a free electron density [cm⁻³] in the oxide semiconductor treated herein), and [symbol]
is a Dirac constant [eVs].]

39. The calculation method for an in-grain mobility μ_{in-grain}(T) of a semiconductor according to claim 22, wherein the Debye screening parameter qₛ is selected from the group consisting of the following Expressions (Qq-1) to (Qq-5):
$${q}_{s} = \frac{q}{\sqrt{{ε}_{r} {ε}_{0} {k}_{B} T}} {( \frac{1}{n} )}^{- 1 / 2} \qquad ( Qq - 1 )$$
$${q}_{s} = \frac{q}{\sqrt{{ε}_{r} {ε}_{0} {k}_{B} T}} {( \frac{1}{n} + \frac{1}{\sqrt{8} N c} )}^{- 1 / 2} \qquad ( Qq - 2 )$$
$${q}_{s} = \frac{q}{\sqrt{{ε}_{r} {ε}_{0} {k}_{B} T}} {( \frac{1}{n} + \frac{1}{\sqrt{8} N c} + ( \frac{3}{16} - \frac{\sqrt{3}}{9} ) \frac{2}{N {c}^{2}} n )}^{- 1 / 2} \qquad ( Qq - 3 )$$
$${q}_{s} = \frac{q}{\sqrt{{ε}_{r} {ε}_{0} {k}_{B} T}} {( \frac{1}{n} + \frac{1}{\sqrt{8} N c} + ( \frac{3}{16} - \frac{\sqrt{3}}{9} ) \frac{2}{N {c}^{2}} n + 1.48386 \times 1 {0}^{- 4} \times \frac{3}{N {c}^{3}} {n}^{2} )}^{- 1 / 2} \qquad ( Qq - 4 )$$
$${q}_{s} = \frac{q}{\sqrt{{ε}_{r} {ε}_{0} {k}_{B} T}} {( \begin{matrix}\frac{1}{n} + \frac{1}{\sqrt{8} N c} + ( \frac{3}{16} - \frac{\sqrt{3}}{9} ) \frac{2}{N {c}^{2}} n + \\ 1.48386 \times 1 {0}^{- 4} \times \frac{3}{N {c}^{3}} {n}^{2} - 4.42563 \times {10}^{- 6} \times \frac{4}{{Nc}^{4}} {n}^{3}\end{matrix} )}^{- 1 / 2} , \qquad ( Qq - 5 )$$
[in Expressions (Qq-1) to (Qq-5),
ε₀ is a vacuum permittivity [F/cm],
εᵣ is a relative permittivity (static),
k_{B} is a Boltzmann constant [eV/K],
T is the temperature [K],
“n” is a free carrier concentration [cm⁻³] (equal to a free electron density [cm⁻³] in the oxide semiconductor treated herein), and
N_{C} is an effective density [cm⁻³] of states.]

40. The calculation method for an in-grain mobility μ_{in-grain}(T) of a semiconductor according to claim 23, wherein the parameters D and k′₁ is respectively expressible by the following expressions:
$$D = \frac{Q}{π {a}_{0}^{2}} = 356 exp [ - 6.2 {( {q}_{s} a o )}^{0.675} ] + 0.05 ,$$
[in the expression,
D is the empirical Q/πa₀² value at k=0 in the Quisse model,
a₀ is the Bohr radius [cm], and is expressed by the following expression:
$${a}_{0} = \frac{4 {π}^{2} {h}^{2} {ε}_{0} {ε}_{r}}{{m}^{*} {e}^{2}} ,$$
(in the expression, [symbol]
is the Dirac constant [eVs],
ε₀ is the vacuum permittivity [F/cm],
εᵣ is the relative permittivity (static),
m* is the effective mass [eV/c²] (“c” is the speed [cm/s] of light) normalized by the speed of light, and
“e” is the elementary charge [C]), and
qₛ is the modified Debye screening parameter [cm⁻¹], and is expressed by the following expression:
$${q}_{s} = \frac{e}{\sqrt{{k}_{B} T {ε}_{0} {ε}_{r}}} {( \frac{1}{n} + \frac{1}{\sqrt{8} {N}_{C}} )}^{- 1 / 2} ,$$
(in the expression,
“e” is the elementary charge [C],
k_{B} is a Boltzmann constant [eV/K],
T is the temperature [K],
ε₀ is the vacuum permittivity [F/cm],
εᵣ is the relative permittivity (static),
“n” is a free carrier concentration [cm⁻³] (equal to a free electron density [cm⁻³] in the oxide semiconductor treated herein),
N_{C} is an effective density [cm⁻³] of states)]; and
$${k}_{1}^{′} = {( \frac{D}{4} )}^{- \frac{1}{3}} ,$$
[in the expression,
k′₁ is the ka₀ value at the intersection point of Q/πa₀²-D (upper base of the right trapezoid) and Q/πa₀²=4(ka₀)⁻³ (hypotenuse of the right trapezoid) in the Q/πa₀²−ka₀ graph of the Quisse model, and
D is as described above.]

41. The calculation method for an in-grain mobility μ_{in-grain}(T) of a semiconductor according to claim 35, wherein, as the reciprocal of the in-grain mobility μ_{in-grain}(T) of the semiconductor in the following Expression (1-1), two or more terms selected from the group consisting of 1/(exp(β/T)−1), T⁰, T^{-3/2}, T^{1/2}, and T^{3/2}, and a 1/μ_{NI}(T, n) term, of which the temperature dependence is a function of a carrier concentration “n”, are used:
$$\frac{1}{{μ}_{in - grain} ( T )} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} + 1 / {μ}_{NI} ( T , n ) , \qquad ( 1 - 1 )$$
[in Expression (1-1),
μ_{in-grain} represents the in-grain mobility [cm²/Vs] of the semiconductor,
T represents the temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and a₅ [cm⁻²Vs·K^{-3/2}] each represent a coefficient.
provided that, in Expression (1-1), the coefficients a₁ to a₅ of unselected terms among the 1/(exp(β/T)−1), the T⁰, the T^{-3/2}, the T^{1/2}, and the T^{3/2} are set to 0.]

42. The calculation method for an in-grain mobility μ_{in-grain}(T) of a semiconductor according to claim 41, wherein an a₂T₀ term in Expression (1-1) is expressible by the neutral impurity scattering model.

43. The calculation method for an in-grain mobility μ_{in-grain}(T) of a semiconductor according to claim 41, wherein an a₂T₀ term in Expression (1-1) is expressible by the ionized impurity scattering (degenerate) model.

44. The calculation method for an in-grain mobility μ_{in-grain}(T) of a semiconductor according to claim 1, wherein, in Expression (1-1), an a₂T₀ term is expressible by the ionized impurity scattering (degenerate) model of claim 41, and a 1/μ_{NI}(T, n) term is expressible by a neutral impurity scattering model of claim 19.

45. The calculation method for an in-grain mobility μ_{in-grain}(T) of a semiconductor according to claim 2, wherein the reciprocal of the in-grain mobility μ_{in-grain}(T) of the semiconductor expressed by Expression (1) is expressible by the following Expression (A1-1):
$$\frac{1}{{μ}_{in - grain} ( T )} = \frac{1}{{μ}_{OP}} + \frac{1}{{μ}_{NI}} + \frac{1}{{μ}_{II}^{( Deg )}} + \frac{1}{{μ}_{II}^{( nonDeg )}} , \qquad ( A1 - 1 )$$
[in Expression (A1-1),
μ_{OP} is as defined in Expression (A2) or (A2-2),
μ_{NI} is as defined in Expression (A3E), (Q-1), or (A₃Q-app),
μ_{II}^{(Deg)} is as defined in Expression (A4D), (A₄-1), or (A₄-S), and
μ_{II}^{(nonDeg)} is as defined in Expression (A5-CW), (A₅-BH), or (A₅-S).

46. The calculation method for an in-grain mobility μ_{in-grain}(T) of a semiconductor according to claim 41, wherein Expression (1-1) is expressible by the following Expression (A1-2):
$$\frac{1}{{μ}_{in - grain} ( T )} = \frac{1}{{μ}_{OP}} + \frac{1}{{μ}_{II}^{( Deg )}} + \frac{1}{{μ}_{II}^{( nonDeg )}} + 1 / {μ}_{NI} ( T , n ) , 2 \qquad ( A1 - 2 )$$
[in Expression (A1-2),
μ_{OP} is as defined in Expression (A2) or (A2-2),
μ_{II}^{(Deg)} is as defined in Expression (A4D), (A₄-1), or (A₄-S),
μ_{II}^{(nonDeg)} is as defined in Expression (A5-CW), (A₅-BH), or (A₅-S), and
μ_{NI}(T, n) is as defined in Expression (A3E), (Q-1), or (A₃Q-app).

47. The calculation method for an in-grain mobility μ_{in-grain}(T) of a semiconductor according to claim 46, wherein, in Expression (A1-2), μ_{OP} is expressed by Expression (A2-2), un (Deg) is expressed by Expression (A4-1) or (A₄-S), μ_{II}^{(nonDeg)} is expressed by Expression (A5-BH) or (A₅-S), and μ_{NI}(T, n) is expressed by Expression (A3E), (Q-1), or (A₅Q-app).

48. The calculation method for an in-grain mobility μ_{in-grain}(T) of a semiconductor according to claim 1, wherein a mobility μ_{II}^{(Deg)} determined by an ionized impurity scattering (degenerate) model expressed by Expression (A4D) or (A₄-1) and a mobility μ_{II}^{(nonDeg)} determined by an ionized impurity scattering (non-degenerate) model expressed by Expression (A5-CW) or (A₅-BH) are linearly combined with respect to a carrier concentration “n” through a sigmoid function having an effective density Nc of states as a boundary, and each screening function Fu comprises Fu of a Pisarkiewicz type, which is expressed by Expression (F).

49. The calculation method for an in-grain mobility μ_{in-grain}(T) of a semiconductor according to claim 1, wherein the semiconductor comprises a polycrystalline semiconductor.

50. The calculation method for an in-grain mobility μ_{in-grain}(T) of a semiconductor according to claim 49, wherein the polycrystalline semiconductor comprises an oxide semiconductor containing ln as a main component.

51. The calculation method for an in-grain mobility μ_{in-grain}(T) of a semiconductor according to claim 50, wherein a content ratio of ln in all metal elements of the polycrystalline semiconductor is equal to or higher than 50 atomic %.

52. The calculation method for an in-grain mobility μ_{in-grain}(T) of a semiconductor according to claim 49, wherein the polycrystalline semiconductor is in a form of an oxide thin film.

53. The calculation method for an in-grain mobility μ_{in-grain}(T) of a semiconductor according to claim 52, wherein the polycrystalline semiconductor thin film includes a bixbyite structure.

54. A calculation method for a macro DC mobility μ(T) of a semiconductor,
wherein, assuming that a temperature T [K] is a fluctuation factor, the macro DC mobility μ(T) is expressed by the following Expression (10):
$$μ ( T ) = exp ( - γ / T ) exp ( - θ / {T}^{2} ) {μ}_{in - grain} ( T ) , \qquad ( 10 )$$
[in Expression (10),
μ is a mobility [cm²/Vs] of the semiconductor,
T is the temperature [K],
γ [K] and θ [K²] are coefficients and positive numbers including 0, and
μ_{in-grain}(T) is the in-grain mobility [cm²/Vs] of the semiconductor obtained by the calculation method for an in-grain mobility μ_{in-grain}(T) of a semiconductor of claim 1.

55. The calculation method for a macro DC mobility μ(T) of a semiconductor according to claim 54, wherein γ [K] or θ [K²] in Expression (10) is 0.

56. The calculation method for a macro DC mobility μ(T) according to claim 54, wherein the γ is expressed by the following Expression (12):
$$γ = q {V}_{B} / {k}_{B} , \qquad ( 12 )$$
[in Expression (12),
“q” represents an elementary charge of 1.602×10⁻¹⁹ [C],
V_{B} represents a potential barrier value [eV], and
k_{B} represents a Boltzmann constant (8.617×10⁻⁵ [eV/K]).

57. The calculation method for a macro DC mobility μ(T) of a semiconductor according to claim 56, wherein the potential barrier value V_{B} [eV] is a potential barrier value V_{B}(n) that varies depending on a carrier concentration “n” [cm⁻³], and the V_{B}(n) is expressed by the following Expression (13):
$${V}_{B} ( n ) = {A}_{6} * \frac{1 - {D}_{6} log n}{1 + exp ( {B}_{6} ( log ( n ) - log ( {N}_{06} ) ) )} + {C}_{6} , \qquad ( 13 )$$
[in Expression (13),
“n” is a free carrier concentration [cm⁻³] (equal to a free electron density [cm⁻³] in the oxide semiconductor treated herein),
A₆ [eV], B₆, C₆ [eV], and Do are each a coefficient, and
N₀₆ [eV] is a carrier concentration corresponding to an inflection point in Expression (13) represented by V_{B}(n).

58. The calculation method for a macro DC mobility μ(T) of a semiconductor according to claim 57, wherein the A₆ is equal to or greater than 0 eV and equal to or less than 1.0 eV, the B₆ is equal to or greater than 0.1, the C₆ is less than 2×10⁻¹, the D₆ is equal to or less than 1.0 eV, and the N₀₆ is equal to or greater than 1×10¹⁷ cm⁻³ and equal to or less than 1×10²¹ cm⁻³.

59. The calculation method for a macro DC mobility μ(T) of a semiconductor according to claim 54, wherein the macro DC mobility μ(T) is expressed by the following Expression (A10):
$$μ ( T ) = [ exp ( - \frac{{qV}_{B}}{{k}_{B} T} ) ] {µ}_{in - grain ( T )} , \qquad ( A10 )$$
[in Expression (A10),
“q” is an elementary charge [C],
V_{B} is a grain boundary barrier height [eV],
k_{B} is a Boltzmann constant [eV/K],
T is the temperature [K], and
μ_{in-grain}(T) is the in-grain mobility [cm²/Vs] of the semiconductor obtained by the calculation method for an in-grain mobility μ_{in-grain}(T) of a semiconductor of any one of claims 1 to 53.]

60. The calculation method for a macro DC mobility μ(T) of a semiconductor according to claim 59, wherein V_{B} in Expression (10A) is expressed by the following Expression (A11):
$${V}_{B} = {δ}_{{E}_{F}} [ 1 + \frac{α}{2 {δ}_{{E}_{F}}} - {( \frac{α}{{δ}_{{E}_{F}}} + \frac{{α}^{2}}{4 {{δ}_{{E}_{F}}}^{2}} )}^{1 / 2} ] , \qquad ( A11 )$$
[in Expression (A11),
α is expressed by the following expression:
$$α = \frac{8 {ε}_{0} {ε}_{r} n}{{e}^{2} {N}_{T}^{2}} ,$$
(in the expression,
ε₀ is a vacuum permittivity [F/cm],
εᵣ is a relative permittivity (static),
“n” is a free carrier concentration [cm⁻³] (equal to a free electron density [cm⁻³] in the oxide semiconductor treated herein),
“e” is an elementary charge [C], and
N_{T} is a grain boundary trap density [cm⁻² eV⁻¹]), and
δ_{EF} is a Fermi energy difference [eV] between a grain boundary and a grain interior, and is expressed by the following expression:
$${δ}_{{E}_{F}} = {E}_{F}^{GB} - {E}_{F}^{G} ,$$
(in the expression,
E_{F}^{GB} is a Fermi energy [eV] in the grain boundary, and
E_{F}^{G} is a Fermi energy [eV] in the grain interior.),
where V_{B}≥0 is satisfied.]

61. The calculation method for a macro DC mobility μ(T) of a semiconductor according to claim 59, wherein the reciprocal of the mobility μ_{in-grain}(T) in Expression (A10) is expressible by any one of Expression (1-1), (A1-1), or (A1-2).

62. The calculation method for a macro DC mobility μ(T) of a semiconductor according to claim 54, wherein the semiconductor comprises a polycrystalline semiconductor.

63. The calculation method for a macro DC mobility μ(T) of a semiconductor according to claim 62, wherein the polycrystalline semiconductor comprises an oxide semiconductor containing ln as a main component.

64. The calculation method for a macro DC mobility μ(T) of a semiconductor according to claim 63, wherein a content ratio of ln in all metal elements of the polycrystalline semiconductor is equal to or higher than 50 atomic %.

65. The calculation method for a macro DC mobility μ(T) of a semiconductor according to claim 62, wherein the polycrystalline semiconductor is in a form of an oxide thin film.

66. The calculation method for a macro DC mobility μ(T) of a semiconductor according to claim 65, wherein the polycrystalline semiconductor thin film includes a bixbyite structure.

67. A device simulation method of obtaining a macro DC mobility μ(T) of a semiconductor,
the device simulation method comprising a step of using the calculation method for a macro DC mobility μ(T) of a semiconductor of claim 54.

68. A manufacturing method for a thin film transistor, comprising the steps of:
calculating a macro DC mobility μ(T) of a semiconductor through use of the calculation method for a macro DC mobility μ(T) of a semiconductor of claim 54; and
manufacturing the thin film transistor based on the calculated macro DC mobility μ(T) of the semiconductor.

69. A manufacturing method for a thin film transistor, comprising the steps of:
calculating a macro DC mobility μ(T) of a semiconductor through use of the device simulation method of claim 67; and
performing device design based on the calculated macro DC mobility μ(T) of the semiconductor.

70. An electronic apparatus, comprising a thin film transistor manufactured through use of the manufacturing method for a thin film transistor of claim 68.

71. A program for calculating a macro DC mobility μ(T) of a semiconductor through use of the following Expressions (1) and (10):
$$\frac{1}{{µ}_{in - grain ( T )}} = {a}_{1} \frac{1}{exp ( \frac{β}{T} ) - 1} + {a}_{2} {T}^{0} + {a}_{3} {T}^{- \frac{3}{2}} + {a}_{4} {T}^{\frac{1}{2}} + {a}_{5} {T}^{\frac{3}{2}} , \qquad ( 1 )$$
[in Expression (1),
μ_{in-grain} represents an in-grain mobility [cm²/Vs] of the semiconductor,
T represents a temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and as [cm⁻²Vs·K^{-3/2}] each represent a coefficient,
provided that, in Expression (1), two or more terms selected from the group consisting of 1/(exp(β/T)−1), T⁰, T^{-3/2}, T^{1/2}, and T^{3/2} are used, and the coefficients a₁ to a₅ of unselected terms are set to 0]; and
$$μ ( T ) = exp ( - γ / T ) exp ( - θ / {T}^{2} ) {μ}_{in - grain} ( T ) , \qquad ( 10 )$$
[in Expression (10),
μ is a mobility [cm²/Vs] of the semiconductor,
T is the temperature [K],
γ [K] and θ [K²] are coefficients and positive numbers including 0, and
μ_{in-grain}(T) is the in-grain mobility [cm²/Vs] of the semiconductor obtained by the calculation method for an in-grain mobility μ_{in-grain}(T) of a semiconductor of any one of claims 1 to 53],
the program being for causing a computer to function as:
means for receiving input of the temperature T [K] and a carrier concentration “n” [cm^{-3];}
means for receiving input of a type of a material of the semiconductor;
means for selecting values of the coefficients a₁ to a₅, β, γ, and θ; and
means for calculating the macro DC mobility μ(T) of the semiconductor by Expressions (1) and (10).

72. The program according to claim 71, wherein the β [K] is expressed by the following Expression (2):
$$β = h {{ω}_{op} ( 2 π {\cdot k}_{B} )}^{- 1} , \qquad ( 2 )$$
[in Expression (2),
hωₒₚ/2π represents energy [eV] of an optical phonon that varies depending on the carrier concentration,
k_{B} represents a Boltzmann constant (8.617×10⁻⁵ [eV/K]), and
“h” represents a Planck constant (4.1357×10⁻¹⁵ [eVs]).]

73. The program according to claim 71, wherein the a₁ [cm⁻²Vs] is a coefficient a₁(n) that varies depending on a carrier concentration “n” [cm⁻³], and the a₁(n) is expressed by the following Expression (3):
$${a}_{1} ( n ) = {A}_{1} * \frac{1}{1 + exp ( - {B}_{1} * ( log ( n ) - log ( {N}_{01} ) ) )} + {C}_{1} , \qquad ( 3 )$$
[in Expression (3),
“n” is a free carrier concentration [cm⁻³] (equal to a free electron density [cm⁻³] in the oxide semiconductor treated herein),
A₁ [cm⁻²Vs], B₁, and C₁ [cm⁻²Vs] each represent a coefficient, and
N₀₁ is a carrier concentration [cm⁻³] corresponding to an inflection point in Expression (3) represented by a₁(n).]

74. The program according to claim 73, wherein the A₁ is equal to or greater than 0 cm⁻²Vs and equal to or less than 0.1 cm⁻²Vs, the B₁ is equal to or greater than 0, the C₁ is equal to or less than 1 cm⁻²Vs, and the N₀₁ is equal to or greater than 1×10¹⁸ cm⁻³ and equal to or less than 1×10²³ cm⁻³.

75. The program according to claim 71, wherein the a₂ [cm⁻²Vs] is a coefficient a₂(n) that varies depending on a carrier concentration “n” [cm⁻³], and the a₂(n) is expressed by the following Expression (4):
$${a}_{2} ( n ) = {A}_{2} * \frac{1}{1 + exp ( {B}_{2} * ( log ( n ) - log ( {N}_{02} ) ) )} + {C}_{2} , \qquad ( 4 )$$
[in Expression (4),
“n” is a free carrier concentration [cm⁻³] (equal to a free electron density [cm⁻³] in the oxide semiconductor treated herein),
A₂ [cm⁻²Vs], B₂, and C₂ [cm⁻²Vs] are each a coefficient, and
N₀₂ is a carrier concentration [cm⁻³] corresponding to an inflection point in Expression (4) represented by a₂(n).]

76. The program according to claim 75, wherein the A₂ is equal to or greater than 0.005 cm⁻²Vs and equal to or less than 0.5 cm⁻²Vs, the B₂ is equal to or less than 1,000, the C₂ is less than 1×10⁻¹ cm⁻²Vs, and the N₀₂ is equal to or greater than 1×10¹⁷ cm⁻³ and equal to or less than 1×10²² cm⁻³.

77. The program according to claim 71, wherein the a₃ [cm⁻²Vs·K^{3/2}] is a coefficient a₃(n) that varies depending on a carrier concentration “n” [cm⁻³], and the a₃(n) is expressed by Expression (5):
$${a}_{3} ( n ) = \frac{{A}_{3} {n}^{2}}{1 + exp ( - {B}_{3} ( l o g ( n ) - log ( {N}_{03} ) ) )} + \frac{{C}_{3}}{1 + exp ( {B}_{3} ( log ( n ) - log ( {N}_{03} ) ) ) 1} \frac{1}{1 + {D}_{3} n} + {F}_{3} , \qquad ( 5 )$$
[in Expression (5),
“n” is a free carrier concentration [cm⁻³] (equal to a free electron density [cm⁻³] in the oxide semiconductor treated herein),
A₃ [cm⁻⁸Vs·K^{3/2}], B₃, C₃ [cm⁻²Vs·K^{3/2}], D₃ [cm⁻³], and F₃ [cm⁻²Vs·K^{3/2}] are each a coefficient, and
N₀₃ is a carrier concentration [cm⁻³] at a maximum value in Expression (5) represented by a₃ (n).]

78. The program according to claim 77, wherein the A₃ is equal to or greater than 10⁻³⁹ cm⁻⁸Vs·K^{3/2} and equal to or less than 10⁻³³ cm⁻⁸Vs·K^{3/2}, the B₃ is equal to or greater than 1 and equal to or less than 5,000, the C₃ is less than 104 cm⁻²Vs·K^{3/2}, the D₃ is equal to or greater than 10⁻²⁰ cm⁻³, the F₃ is less than 500 cm⁻²Vs·K^{3/2}, and the Nos is equal to or greater than 1×10¹⁶ cm⁻³ and equal to or less than 1×10²⁰ cm⁻³

79. The program according to claim 71, wherein the a₃ is a coefficient a₃(n) that varies depending on a carrier concentration “n” [cm⁻³], and assuming that N₀₃ [cm⁻³] and N₁₃ [cm⁻³] are freely-selected carrier concentrations, the a₃(n) is expressed by the following Expression (5-1) when n<N₀₃ is satisfied, expressed by the following Expression (5-2) when N₀₃Sn N₁₃ is satisfied, and expressed by the following Expression (5-3) when n>N₁₃ is satisfied:
$$\begin{matrix}{a}_{3} ( n ) = {A}_{3}^{′} {n}^{2} \\ {a}_{3} ( n ) = {B}_{3}^{′} \\ {a}_{3} ( n ) = \frac{{C}_{3}^{′}}{1 + {D}_{3}^{′} n} ,\end{matrix}$$
[in Expression (5-1), Expression (5-32), and Expression (5-3),
“n” is a free carrier concentration [cm⁻³] (equal to a free electron density [cm⁻³] in the oxide semiconductor treated herein),
A′₃ [cm⁻⁸Vs·K^{3/2}], C′₃ [cm⁻²Vs·K^{3/2}], and D′₃ [cm⁻³] are each a coefficient, and
B′₃ [cm⁻²Vs·K^{3/2}] is a constant.]

80. The program according to claim 79, wherein the A′₃ is equal to or greater than 10⁻³⁹ cm⁻⁸Vs·K^{3/2} and equal to or less than 10⁻³³ cm⁻⁸Vs·K^{3/2}, the C′₃ is equal to or less than 5,000 cm⁻²Vs·K^{3/2}, and the D′₃ is equal to or greater than 10⁻²⁰ cm⁻³.

81. The program according to claim 71, wherein the a₄ [cm⁻²Vs·K^{-1/2}] is a coefficient that varies depending on a carrier concentration.

82. The program according to claim 71, wherein the as [cm⁻²Vs·K^{-3/2}] is a coefficient that varies depending on a carrier concentration.

83. The program according to claim 71, wherein the semiconductor comprises a non-degenerate semiconductor, the a₁ in Expression (1) is an optical phonon scattering constant Aₒₚ [cm⁻²Vs], the a₂ is a neutral impurity scattering coefficient Aₙₑᵤₜᵣₐₗ [cm⁻²Vs], the a₃ is an ionized impurity scattering coefficient Aᵢₒₙ [cm⁻²Vs·K^{3/2}], the a₄ is a weak localization constant [cm⁻²Vs·K^{-1/2}], and the as is an acoustic phonon scattering constant [cm⁻²Vs·K^{-3/2}].

84. The program according to claim 71, wherein y is expressed by the following Expression (12):
$$γ = q {V}_{B} / {k}_{B} , \qquad ( 12 )$$
[in Expression (12),
“q” represents an elementary charge of 1.602×10⁻¹⁹ [C],
V_{B} represents a potential barrier value [eV], and
k_{B} represents a Boltzmann constant (8.617×10⁻⁵ [eV/K]).]

85. The program according to claim 84, wherein the potential barrier value V_{B} [eV] is a potential barrier value V_{B}(n) that varies depending on a carrier concentration “n” [cm⁻³], and the V_{B}(n) is expressed by the following Expression (13):
$${V}_{B} ( n ) = {A}_{6} * \frac{1 - {D}_{6} log n}{1 + exp ( {B}_{6} ( log ( n ) - log ( {N}_{06} ) ) )} + {C}_{6} , \qquad ( 13 )$$
[in Expression (13),
“n” is a free carrier concentration [cm⁻³] (equal to a free electron density [cm⁻³] in the oxide semiconductor treated herein),
A₆ [eV], B₆, C₆ [eV], and Do are each a coefficient, and
N₀₆ [eV] is a carrier concentration [cm⁻³] corresponding to an inflection point in Expression (13) represented by V_{B}(n).]

86. The program according to claim 85, wherein the A₆ is equal to or greater than 0.005 eV and equal to or less than 1.0 eV, the B₆ is equal to or greater than 0.1, the C₆ is less than 1×10−1 eV, the Do is equal to or less than 0.1 eV, and the N₀₆ is equal to or greater than 1×10¹⁷ cm⁻³ and equal to or less than 1×10²¹ cm⁻³.

87. A program for calculating a macro DC mobility μ(T) of a semiconductor through use of Expression (1-1) of claim 41, Expression (A1-1) of claim 45, or Expression (A1-2) of claim 46, and Expression (A10) of claim 59,
the program being for causing a computer to function as:
means for receiving input of the temperature T [K] and a carrier concentration “n” [cm⁻³],
means for receiving input of a type of a material of the semiconductor,
means for selecting values of the coefficients a₁ to a₅, β, γ, and θ, and
means for calculating the macro DC mobility μ(T) of the semiconductor by Expression (1-1), (A1-1), or (A1-2), and Expression (A10).

88. The program according to claim 71, wherein the semiconductor comprises a crystalline oxide thin film containing ln as a main component.

89. A program for deriving a macro DC mobility μ(T, n) [cm²/Vs] of a semiconductor dependent on a temperature T [K] and a carrier concentration “n” [cm⁻³],
the program being for causing a computer to function as:
means for receiving data input of the μ(T, n) for the T and “n” actually measured from a semiconductor film;
means for receiving input of a type of a semiconductor material from which initial values of respective coefficients in the following Expression (1) are to be acquired; and
means for deriving the macro DC mobility μ(T, n) by performing regression through use of the program of claim 71:
$$\frac{1}{{μ}_{i n - grain} ( T )} = {a}_{1} \frac{1}{exp ( \frac{β}{T} ) - 1} + {a}_{2} {T}^{0} + {a}_{3} {T}^{\frac{3}{2}} + {a}_{4} {T}^{\frac{1}{2}} + {a}_{5} {T}^{\frac{3}{2}} , \qquad ( 1 )$$
[in Expression (1),
μ_{in-grain} represents an in-grain mobility [cm²/Vs] of the semiconductor,
T represents the temperature [K], and
β [K], a₁ [cm⁻²Vs], a₂ [cm⁻²Vs], a₃ [cm⁻²Vs·K^{3/2}], a₄ [cm⁻²Vs·K^{-1/2}], and as [cm⁻²Vs·K^{-3/2}] each represent a coefficient,
provided that, in Expression (1), two or more terms selected from the group consisting of 1/(exp(β/T)−1), T⁰, T^{-3/2}, T^{1/2}, and T^{3/2} are used, and the coefficients a₁ to a₅ of unselected terms are set to 0.]

90. A program for deriving a macro DC mobility μ(T, n) [cm²/Vs] of a semiconductor dependent on a temperature T [K] and a carrier concentration “n” [cm⁻³],
the program being for causing a computer to function as:
means for receiving data input of the μ(T, n) for the T and “n” actually measured from a semiconductor film;
means for receiving input of a type of a semiconductor material from which initial values of the respective coefficients in Expression (1-1) of claim 41 or Expression (A1-2) of claim 46 are to be acquired; and
means for deriving the macro DC mobility μ(T, n) by performing regression through use of the program for calculating a macro DC mobility μ(T) of a semiconductor of claim 87.
